(19) United States
(12) Patent Application Publication
(10) Pub. No.: US 2021/0022024 A1
(43) Pub. Date: Jan. 21, 2021

(54) APPARATUS, SYSTEM AND METHOD TO COLLECT OR GENERATE NETWORK FUNCTION PERFORMANCE MEASUREMENTS FOR A SERVICE PRODUCER OF A THIRD GENERATION PARTNERSHIP PROJECT 5G MANAGEMENT SERVICE

(71) Applicant: Intel Corporation, Santa Clara, CA (US)

(72) Inventors: Yizhi Yao, Chandler, AZ (US); Joey Chou, Scottsdale, AZ (US)

(73) Assignee: Intel Corporation, Santa Clara, CA (US)

(21) Appl. No.: 17/062,410

(22) Filed: Oct. 2, 2020

Related U.S. Application Data
(60) Provisional application No. 62/910,288, filed on Oct. 3, 2019.

(51) Int. Cl. H04W 24/08; H04W 24/10; H04W 28/02; H04W 36/00

(52) U.S. Cl. CPC H04W 24/08; H04W 36/0085; H04W 28/0268; H04W 24/10

(57) ABSTRACT

A device includes one or more processors to collect data corresponding to network function (NF) performance measurements by one or more network element, each network element including one of a NR Node B (gNB), a 5G core network (5G CN) network element or network function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and generate and cause transmission through a management service interface of one or more reports on the NF performance measurements to a service consumer to be used by the service consumer to manage the 5GS.

### CROSS REFERENCE TO RELATED APPLICATIONS

This application claims the benefit of and priority from U.S. Provisional Patent Application No. 62/910,288 entitled “PERFORMANCE MEASUREMENTS RELATED TO NON-3GPP ACCESS,” filed Oct. 3, 2019, the entire disclosure of which is incorporated herein by reference.

### FIELD

Various embodiments generally relate to the field of cellular communications, and particularly registration management in a 5G core network (5GC).

### BACKGROUND

Current Third Generation Partnership Project (3GPP) Radio (NR) specifications (or 5G specifications) do not specifically address issues related to performance measurements related to registration via trusted non-3GPP access.

### BRIEF DESCRIPTION OF THE DRAWINGS

FIG. 1 illustrates an example architecture of a system of a network, in accordance with various embodiments.

FIG. 2 illustrates an example architecture of a system including a first core network, in accordance with various embodiments.

FIG. 3 illustrates an architecture of a system including a second core network in accordance with various embodiments.

FIG. 4 illustrates an example of infrastructure equipment 400 in accordance with various embodiments.

FIG. 5 illustrates an example of a platform or device in accordance with various embodiments.

FIG. 6 illustrates example components of baseband circuitry and radio front end modules (RFEM) in accordance with various embodiments.

FIG. 7 illustrates various protocol functions that may be implemented in a wireless communication device according to various embodiments.

FIG. 8 illustrates a block diagram showing components, according to some example embodiments, able to read instructions from a machine-readable or computer-readable medium (e.g., a non-transitory machine-readable storage medium) and perform any one or more of the methodologies discussed herein.

FIG. 9 illustrates components of a core network in accordance with various embodiments.

FIG. 10 is a block diagram illustrating components, according to some example embodiments, of a system to support NFV.

FIG. 11 depicts an example management architecture of mobile networks that include virtualized network functions.

FIG. 12 depicts another example of a management services architecture.

FIG. 13 shows an example of 5G management services.

FIG. 14 shows a management service that offers management capabilities.

FIG. 15 shows an example of management service and related management service component type A, type B and type C.

FIG. 16 shows an example of when there is a Management Service A exposure without exposure governance, and Management Service A′ Consumer accessing all management capability offered by Management Service A′ Producer.

FIG. 17 shows an example of an MF playing both roles of Management Service producer and consumer.

FIG. 18 shows multiple scenarios, including: MF1 produces Management Service MnS-a; MF2 consumes Management Service MnS-a produced by MF1 and produces Management Services MnS-b and MnS-c; MF3 produces Management Service MnS-c; MF4 consumes Management Service MnS-b produced by the MF2; MF5 consumes Management Services MnS-c produced by the MF2 and MF3, and in turn produces the same Management Service MnS-c.

FIG. 19 shows a service based architecture for management data analytics.

FIG. 20 shows an example of a MDAS.

FIG. 21 shows another example of a MDAS, being provided by a Management Data Analytics Function (MDAF).

FIG. 22 illustrates an example of deployment model of the MDAS.

FIG. 23 gives a high level illustration of potential interaction and utilisation of the MDAS.

FIG. 24 and example of a 5G NF performance measurements generation architecture.

FIGS. 25A and 25B show other examples of a 5G NF performance measurements generation architecture.

FIGS. 26A and 26B show additional examples of a 5G NF performance measurements generation architecture.

FIGS. 27A and 27B show further examples of a 5G NF performance measurements generation architecture.

FIG. 28 illustrates a flow according to one method embodiment.

FIG. 29 illustrates a flow according to another method embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The 5G Core (5GC) Network supports registration and connectivity of user equipments (UEs) via 3GPP access networks and untrusted or trusted non-3GPP access networks (e.g., WLAN access networks, Wireline access networks, etc.) (see e.g., 3GPP TS 23.501 v16.2.0 (2019 June).). Registration Management (RM) is used to register or deregister UEs/users with the network (e.g., 5GC) and establish a user context in the network, and Connection Management is used to establish and release the signaling connection between the UE and the Access and Mobility Management Function (AMF) (see e.g., TS 23.501 v16.2.0 (2019 June)). The performance of registration (e.g., RM and/or the registration procedure) for each registration type may need to be monitored by the operator (e.g., MNO) since it is relevant to whether the end user can use the service of 5GS or a specific network slice. However, performance measurements related to registration via trusted non-3GPP access have not yet been defined, and therefore, the performance of registration via trusted non-3GPP access cannot be monitored.

A Service Request procedure is used by a UE in a connection management-idle (CM-IDLE) state or in the 5GC to request the establishment of a secure connection to an AMF (see e.g., 3GPP TS 23.502 v16.2.0 (2019 June). The Service Request procedure is also used both when the UE is in CM-IDLE and in CM-CONNECTED to activate a User Plane connection for an established PDU Session (see e.g., 3GPP TS 23.502 v16.2.0 (2019 June)). The service requests may be initiated by the UE via 3GPP access or via untrusted or trusted non-3GPP access. The performance related to service requests and/or the service request procedures may need to be monitored by the operator (e.g., MNO) since it is relevant to whether the end user can use the service of 5GS. However, performance measurements related to service requests via trusted non-3GPP access have not yet been defined, and therefore, the performance of service requests and/or the service request procedures via trusted non-3GPP access cannot be monitored.

The QoS flows for a PDU session may need to be setup via untrusted non-3GPP access (see e.g., TS 23.501 v16.2.0 (2019-06) and 3GPP TS 23.502 v16.2.0 (2019 June)). The success or failure of QoS flow setup directly reflects whether the UE can be allocated with resource for the service. The causes of the failures also need to be known for troubleshooting. Some embodiments seek to add the performance measurements related to QoS flow setup via untrusted non-3GPP access. The QoS flow established via untrusted non-3GPP access may need to be modified to fulfil the updated QoS requirements. Performance measurements related to QoS flow modification are needed to evaluate the performance that how the UE's updated QoS requirements can be fulfilled by the network, and to know the causes of the failures for troubleshooting. The QoS flow may need to be modified to fulfil the updated QoS requirements. The use case for monitoring of QoS flow modification is captured in annex A.20 of 3GPP TS 28.552 v16.3.0 (2019 September), however, the measurements are missing.

Additionally, handovers could occur between a 5G system (5GS) and an evolved packet system (EPS) for some purposes (e.g., EPS fallback for IP Multimedia Subsystem (IMS) voice). However, the measurements for inter-network handovers have not yet been defined. Therefore, the performance for handovers between 5GS and EPS cannot be monitored.

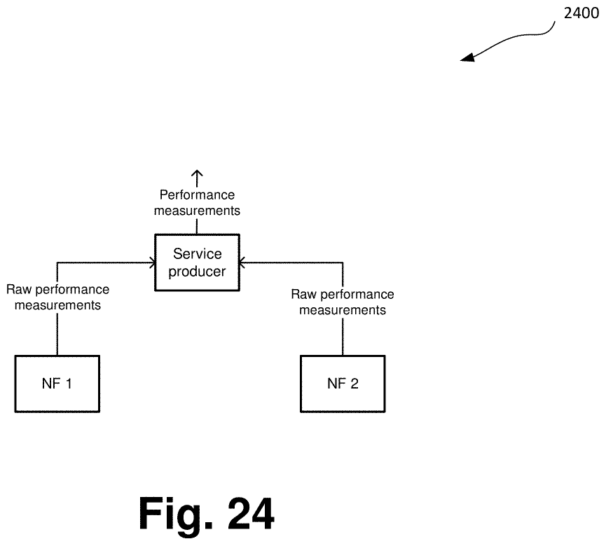

Embodiments relate to the collection or generation of network function performance management measurements. The above will be addressed in further detail below, in particular in relation to FIGS. 24-29.

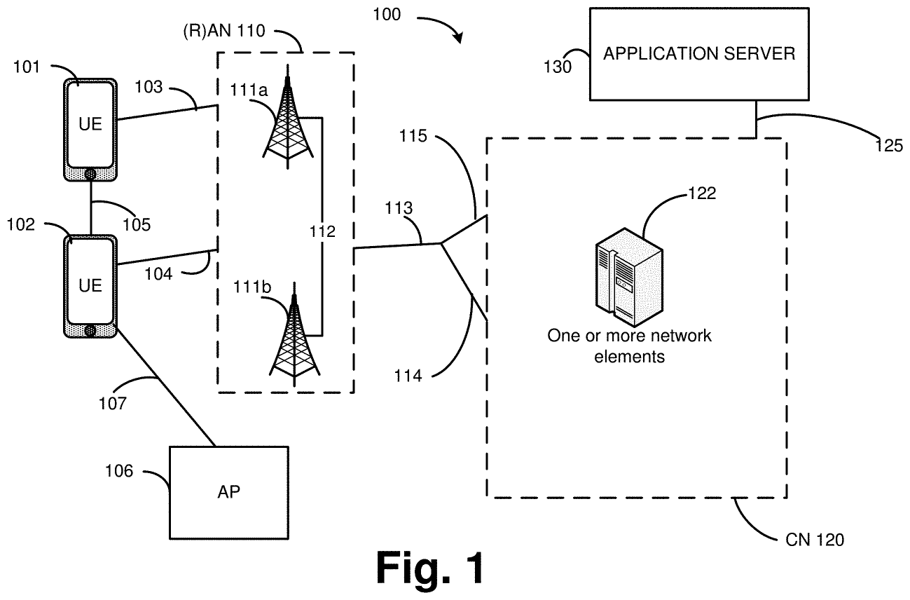

FIGS. 1 to 23 described below address networks, architectures and/or components pertaining to devices, systems and methods to carry out embodiments as will be described with more particularity in relation to FIGS. 24-29 to follow.

FIG. 1 illustrates an example architecture of a system 100 of a network, in accordance with various embodiments. The following description is provided for an example system 100 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 1, the system 100 includes UE 101a and UE 101b (collectively referred to as “UEs 101” or “UE 101”). In this example, UEs 101 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (In in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 101 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some of these embodiments, the UEs 101 may be NB-IoT UEs 101. NB-IoT provides access to network services using physical layer optimized for very low power consumption (e.g., full carrier BW is 180 kHz, subcarrier spacing can be 3.75 kHz or 15 kHz). A number of E-UTRA functions are not used for NB-IoT and need not be supported by RAN nodes 111 and UEs 101 only using NB-IoT. Examples of such E-UTRA functions may include inter-RAT mobility, handover, measurement reports, public warning functions, GBR, CSG, support of HeNBs, relaying, carrier aggregation, dual connectivity, NAICS, MBMS, real-time services, interference avoidance for in-device coexistence, RAN assisted WLAN interworking, sidelink communication/discovery, MDT, emergency call, CS fallback, self-configuration/self-optimization, among others. For NB-IoT operation, a UE 101 operates in the DL using 12 sub-carriers with a sub-carrier BW of 15 kHz, and in the UL using a single sub-carrier with a sub-carrier BW of either 3.75 kHz or 15 kHz or alternatively 3, 6 or 12 sub-carriers with a sub-carrier BW of 15 kHz.

In various embodiments, the UEs 101 may be MF UEs 101. MF UEs 101 are LTE-based UEs 101 that operate (exclusively) in unlicensed spectrum. This unlicensed spectrum is defined in MF specifications provided by the MulteFire Forum, and may include, for example, 1.9 GHz (Japan), 3.5 GHz, and 5 GHz. MulteFire is tightly aligned with 3GPP standards and builds on elements of the 3GPP specifications for LAA/eLAA, augmenting standard LTE to operate in global unlicensed spectrum. In some embodiments, LBT may be implemented to coexist with other unlicensed spectrum networks, such as WiFi, other LAA networks, or the like. In various embodiments, some or all UEs 101 may be NB-IoT UEs 101 that operate according to MF. In such embodiments, these UEs 101 may be referred to as “MF NB-IoT UEs 101,” however, the term “NB-IoT UE 101” may refer to an “MF UE 101” or an “MF and NB-IoT UE 101” unless stated otherwise. Thus, the terms “NB-IoT UE 101,” “MF UE 101,” and “MF NB-IoT UE 101” may be used interchangeably throughout the present disclosure.

The UEs 101 may be configured to connect, for example, communicatively couple, with an or RAN 110. In embodiments, the RAN 110 may be an NG RAN or a 5G RAN, an E-UTRAN, an MF RAN, or a legacy RAN, such as a UTRAN or GERAN. As used herein, the term “NG RAN” or the like may refer to a RAN 110 that operates in an NR or 5G system 100, the term “E-UTRAN” or the like may refer to a RAN 110 that operates in an LTE or 4G system 100, and the term “MF RAN” or the like refers to a RAN 110 that operates in an MF system 100. The UEs 101 utilize connections (or channels) 103 and 104, respectively, each of which comprises a physical communications interface or layer (discussed in further detail below). The connections 103 and 104 may include several different physical DL channels and several different physical UL channels. As examples, the physical DL channels include the PDSCH, PMCH, PDCCH, EPDCCH, MPDCCH, R-PDCCH, SPDCCH, PBCH, PCFICH, PHICH, NPBCH, NPDCCH, NPDSCH, and/or any other physical DL channels mentioned herein. As examples, the physical UL channels include the PRACH, PUSCH, PUCCH, SPUCCH, NPRACH, NPUSCH, and/or any other physical UL channels mentioned herein.

In this example, the connections 103 and 104 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 101 may directly exchange communication data via a ProSe interface 105. The ProSe interface 105 may alternatively be referred to as a SL interface 105 and may comprise one or more physical and/or logical channels, including but not limited to the PSCCH, PSSCH, PSDCH, and PSBCH.

The UE 101b is shown to be configured to access an AP 106 (also referred to as “WLAN node 106,” “WLAN 106,” “WLAN Termination 106,” “WT 106” or the like) via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below). In various embodiments, the UE 101b, RAN 110, and AP 106 may be configured to utilize LWA operation and/or LWIP operation. The LWA operation may involve the UE 101b in RRC_CONNECTED being configured by a RAN node 111a-b to utilize radio resources of LTE and WLAN. LWIP operation may involve the UE 101b using WLAN radio resources (e.g., connection 107) via IPsec protocol tunneling to authenticate and encrypt packets (e.g., IP packets) sent over the connection 107. IPsec tunneling may include encapsulating the entirety of original IP packets and adding a new packet header, thereby protecting the original header of the IP packets.

The RAN 110 can include one or more AN nodes or RAN nodes 111a and 111b (collectively referred to as “RAN nodes 111” or “RAN node 111”) that enable the connections 103 and 104. As used herein, the terms “access node,” “access point,” or the like may describe equipment that provides the radio baseband functions for data and/or voice connectivity between a network and one or more users. These access nodes can be referred to as BS, gNBs, gNodeBs, RAN nodes, eNBs, eNodeBs, NodeBs, RSUs, MF-APs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 111 that operates in an NR or 5G system 100 (e.g., a gNB), and the term “E-UTRAN node” or the like may refer to a RAN node 111 that operates in an LTE or 4G system 100 (e.g., an eNB). According to various embodiments, the RAN nodes 111 may be implemented as one or more of a dedicated physical device such as a macrocell base station, and/or a low power (LP) base station for providing femtocells, picocells or other like cells having smaller coverage areas, smaller user capacity, or higher BW compared to macrocells.

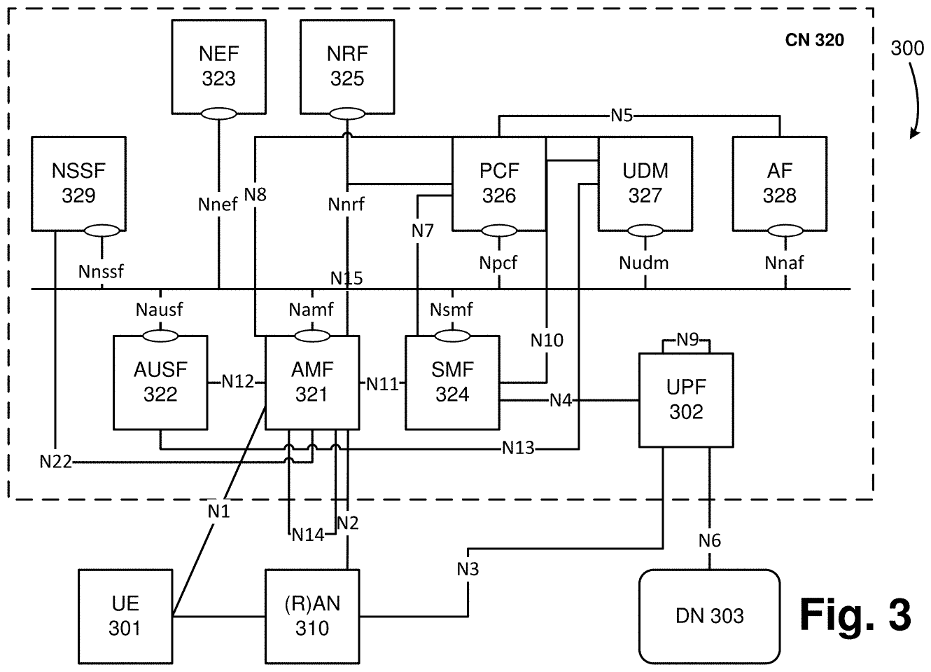

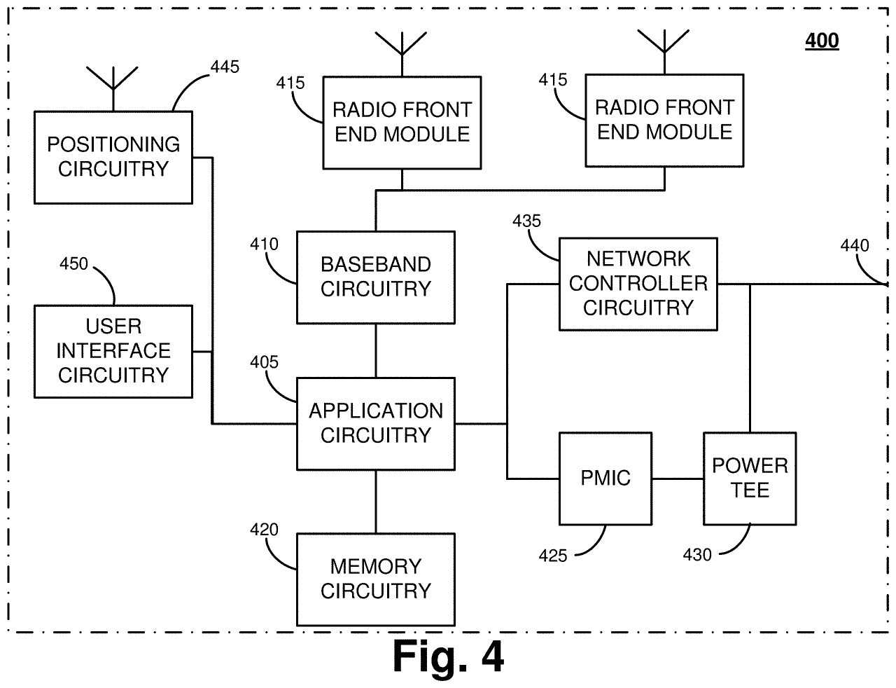

In some embodiments, all or parts of the RAN nodes 111 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 111; a MAC/PHY split wherein RRC, PDCP, RLC, and MAC layers are operated by the CRAN/vBBUP and the PHY layer is operated by individual RAN nodes 111; or a “lower PHY” split wherein RRC, PDCP, RLC, MAC layers and upper portions of the PHY layer are operated by the CRAN/vBBUP and lower portions of the PHY layer are operated by individual RAN nodes 111. This virtualized framework allows the freed-up processor cores of the RAN nodes 111 to perform other virtualized applications. In some implementations, an individual RAN node 111 may represent individual gNB-DUs that are connected to a gNB-CU via individual F1 interfaces (not shown by FIG. 1). In these implementations, the gNB-DUs may include one or more remote radio heads or RFEMs (see e.g., FIG. 4), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), which are RAN nodes that provide E-UTRA user plane and control plane protocol terminations toward the UEs 101, and are connected to a 5GC (e.g., CN 320 of FIG. 3) via an NG interface (discussed infra). In MF implementations, the MF-APs 111 are entities that provide MulteFire radio services, and may be similar to eNBs 111 in an 3GPP architecture. Each MF-AP 111 includes or provides one or more MF cells.

In V2X scenarios one or more of the RAN nodes 111 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 101 (vUEs 101). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 111 can terminate the air interface protocol and can be the first point of contact for the UEs 101. In some embodiments, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In embodiments, the UEs 101 can be configured to communicate using OFDM communication signals with each other or with any of the RAN nodes 111 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

Downlink and uplink transmissions may be organized into frames with 10 ms durations, where each frame includes ten 1 ms subframes. A slot duration is 14 symbols with Normal CP and 12 symbols with Extended CP, and scales in time as a function of the used sub-carrier spacing so that there is always an integer number of slots in a subframe. In LTE implementations, a DL resource grid can be used for DL transmissions from any of the RAN nodes 111 to the UEs 101, while UL transmissions from the UEs 101 to RAN nodes 111 can utilize a suitable UL resource grid in a similar manner. These resource grids may refer to time-frequency grids, and indicate physical resource in the DL or UL in each slot. Each column and each row of the DL resource grid corresponds to one OFDM symbol and one OFDM subcarrier, respectively, and each column and each row of the UL resource grid corresponds to one SC-FDMA symbol and one SC-FDMA subcarrier, respectively. The duration of the resource grid in the time domain corresponds to one slot in a radio frame. The resource grids comprises a number of RBs, which describe the mapping of certain physical channels to REs. In the frequency domain, this may represent the smallest quantity of resources that currently can be allocated. Each RB comprises a collection of REs. An RE is the smallest time-frequency unit in a resource grid. Each RE is uniquely identified by the index pair (k,l) in a slot where k=0, . . . , N_{RB}^{DL}N_{Sc}^{RB}−1 and l=0, . . . , N_{symb}^{DL}−1 are the indices in the frequency and time domains, respectively. RE (k,l) on antenna port p corresponds to the complex value aₖ^{(p)}. An antenna port is defined such that the channel over which a symbol on the antenna port is conveyed can be inferred from the channel over which another symbol on the same antenna port is conveyed. There is one resource grid per antenna port. The set of antenna ports supported depends on the reference signal configuration in the cell, and these aspects are discussed in more detail in 3GPP TS 36.211.

In NR/5G implementations, DL and UL transmissions are organized into frames with 10 ms durations each of which includes ten 1 ms subframes. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with a half-frame 0 comprising subframes 0-4 and a half-frame 1 comprising subframes 5-9. There is one set of frames in the UL and one set of frames in the DL on a carrier. Uplink frame number i for transmission from the UE 101 starts T_{TA}=(N_{TA}+N_{TA,offset})T_{c} before the start of the corresponding downlink frame at the UE where N_{TA,offset} is given by 3GPP TS 38.213. For subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by tables 4.3.2-1 and 4.3.2-2 of 3GPP TS 38.211. The start of slot nₛ^{μ} in a subframe is aligned in time with the start of OFDM symbol nₛ^{μ}N_{symb}^{slot} in the same subframe. OFDM symbols in a slot can be classified as ‘downlink’, ‘flexible’, or ‘uplink’, where downlink transmissions only occur in ‘downlink’ or ‘flexible’ symbols and the UEs 101 only transmit in ‘uplink’ or ‘flexible’ symbols.

For each numerology and carrier, a resource grid of N_{grid,x}^{size,μ}N_{sc}^{RB} subcarriers and N_{symb}^{subframe,μ} OFDM symbols is defined, starting at common RB N_{grid}^{start,μ} indicated by higher-layer signaling. There is one set of resource grids per transmission direction (i.e., uplink or downlink) with the subscript x set to DL for downlink and x set to UL for uplink. There is one resource grid for a given antenna port p, subcarrier spacing configuration μ, and transmission direction (i.e., downlink or uplink).

An RB is defined as N_{sc}^{RB}=12 consecutive subcarriers in the frequency domain. Common RBs are numbered from 0 and upwards in the frequency domain for subcarrier spacing configuration μ. The center of subcarrier 0 of common resource block 0 for subcarrier spacing configuration μ coincides with ‘point A’. The relation between the common resource block number n_{CRB}^{μ} in the frequency domain and resource elements (k,l) for subcarrier spacing configuration μ is given by

$${n}_{CRB}^{μ} = ⌊ \frac{k}{{N}_{sc}^{RB}} ⌋$$

where k is defined relative to point A such that k=0 corresponds to the subcarrier centered around point A. Point A serves as a common reference point for resource block grids and is obtained from offsetToPointA for a PCell downlink where offsetToPointA represents the frequency offset between point A and the lowest subcarrier of the lowest resource block, which has the subcarrier spacing provided by the higher-layer parameter subCarrierSpacingCommon and overlaps with the SS/PBCH block used by the UE for initial cell selection, expressed in units of resource blocks assuming 15 kHz subcarrier spacing for FR1 and 60 kHz subcarrier spacing for FR2; and absoluteFrequencyPointA for all other cases where absoluteFrequencyPointA represents the frequency-location of point A expressed as in ARFCN.

A PRB for subcarrier configuration μ are defined within a BWP and numbered from 0 to N_{BWP,i}^{size,μ}−1 where i is the number of the BWP. The relation between the physical resource block n_{PRB}^{μ} in BWPi and the common RB n_{CRB}^{μ} is given by n_{CRB}^{μ}=n_{PRB}^{μ}+N_{BWP,i}^{start,μ} where N_{BWP,i}^{start,μ} is the common RB where BWP starts relative to common RB 0. VRBs are defined within a BWP and numbered from 0 to N_{BWP,i}^{size}−1 where i is the number of the BWP.

Each element in the resource grid for antenna port p and subcarrier spacing configuration μ is called an RE and is uniquely identified by (k,l)_{p,μ} where k is the index in the frequency domain and I refers to the symbol position in the time domain relative to some reference point. Resource element (k,l)_{p,μ} corresponds to a physical resource and the complex value a_{k,l}^{(p,μ)}. An antenna port is defined such that the channel over which a symbol on the antenna port is conveyed can be inferred from the channel over which another symbol on the same antenna port is conveyed. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

A BWP is a subset of contiguous common resource blocks defined in subclause 4.4.4.3 of 3GPP TS 38.211 for a given numerology μᵢ in BWP i on a given carrier. The starting position N_{BWP,i}^{start,μ} and the number of resource blocks N_{BWP,i}^{size,μ} in a BWP shall fulfil N_{grid,x}^{start,μ}≤N_{BWP,i}^{start,μ}<N_{grid,x}^{start,μ}+N_{grid,x}^{size,μ} and N_{grid,x}^{start,μ}<N_{BWP,i}^{start,μ}+N_{BWP,i}^{size,μ}≤N_{grid,x}^{start,μ}+N_{grid,x}^{size,μ} respectively. Configuration of a BWP is described in clause 12 of 3GPP TS 38.213. The UEs 101 can be configured with up to four BWPs in the DL with a single DL BWP being active at a given time. The UEs 101 are not expected to receive PDSCH, PDCCH, or CSI-RS (except for RRM) outside an active BWP. The UEs 101 can be configured with up to four BWPs in the UL with a single UL BWP being active at a given time. If a UE 101 is configured with a supplementary UL, the UE 101 can be configured with up to four additional BWPs in the supplementary UL with a single supplementary UL BWP being active at a given time. The UEs 101 do not transmit PUSCH or PUCCH outside an active BWP, and for an active cell, the UEs do not transmit SRS outside an active BWP.

An NB is defined as six non-overlapping consecutive PRBs in the frequency domain. The total number of DL NBs in the DL transmission BW configured in the cell is given by

$${N}_{NB}^{DL} = ⌊ \frac{{N}_{RB}^{DL}}{6} ⌋ .$$

The NBs are numbered n_{NB}=0, . . . , N_{NB}^{DL}−1 in order of increasing PRB number where narrowband n_{NB} is comprises PRB indices:

$$\{ \begin{matrix}6 {n}_{NB} + {i}_{0} + i & if {N}_{RB}^{UL} mod 2 = 0 \\ 6 {n}_{NB} + {i}_{0} + i & if {N}_{RB}^{UL} mod 2 = 1 and {n}_{NB} < {N}_{NB}^{UL} \text{/} 2 \\ 6 {n}_{NB} + {i}_{0} + i + 1 & if {N}_{RB}^{UL} mod 2 = 1 and {n}_{NB} \geq {N}_{NB}^{UL} \text{/} 2\end{matrix} , \\ i = 0 , 1 , … , 5 \\ where {i}_{0} = ⌊ \frac{{N}_{RB}^{UL}}{2} ⌋ - \frac{6 {N}_{NB}^{UL}}{2} .$$

If N_{NB}^{UL}≥4, a wideband is defined as four non-overlapping narrowbands in the frequency domain. The total number of uplink widebands in the uplink transmission bandwidth configured in the cell is given by

$${N}_{WB}^{UL} = ⌊ \frac{{N}_{NB}^{UL}}{4} ⌋$$

and the widebands are numbered n_{WB}=0, . . . , N_{WB}^{UL}−1 in order of increasing narrowband number where wideband n_{WB} is composed of narrowband indices 4n_{WB}+i where i=0, 1, . . . , 3. If N_{NB}^{UL}<4, then N_{WB}^{UL}=1 and the single wideband is composed of the N_{NB}^{UL} non-overlapping narrowband(s).

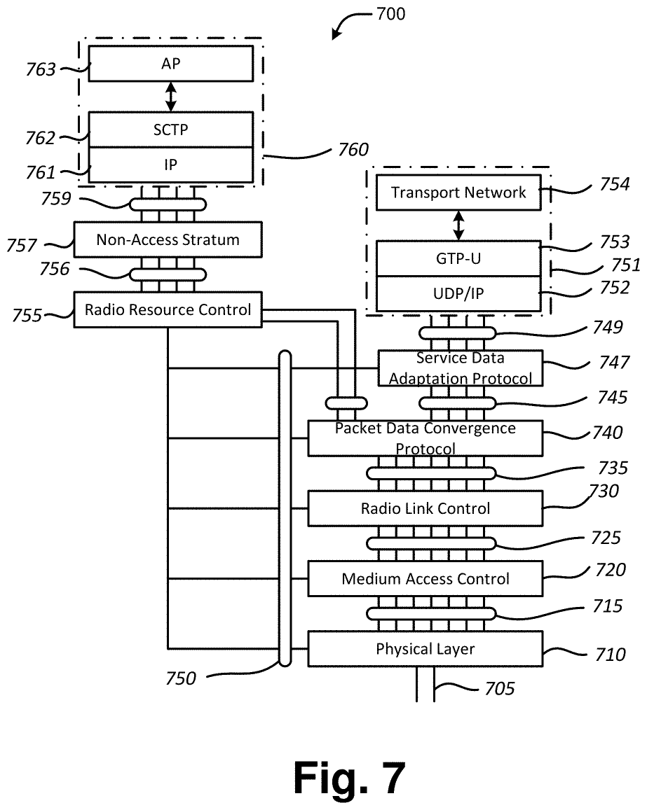

There are several different physical channels and physical signals that are conveyed using RBs and/or individual REs. A physical channel corresponds to a set of REs carrying information originating from higher layers. Physical UL channels may include PUSCH, PUCCH, PRACH, and/or any other physical UL channel(s) discussed herein, and physical DL channels may include PDSCH, PBCH, PDCCH, and/or any other physical DL channel(s) discussed herein. A physical signal is used by the physical layer (e.g., PHY 710 of FIG. 7) but does not carry information originating from higher layers. Physical UL signals may include DMRS, PTRS, SRS, and/or any other physical UL signal(s) discussed herein, and physical DL signals may include DMRS, PTRS, CSI-RS, PSS, SSS, and/or any other physical DL signal(s) discussed herein.

The PDSCH carries user data and higher-layer signaling to the UEs 101. Typically, DL scheduling (assigning control and shared channel resource blocks to the UE 101 within a cell) may be performed at any of the RAN nodes 111 based on channel quality information fed back from any of the UEs 101. The downlink resource assignment information may be sent on the PDCCH used for (e.g., assigned to) each of the UEs 101. The PDCCH uses CCEs to convey control information (e.g., DCI), and a set of CCEs may be referred to a “control region.” Control channels are formed by aggregation of one or more CCEs, where different code rates for the control channels are realized by aggregating different numbers of CCEs. The CCEs are numbered from 0 to N_{CCE,k}−1, where N_{CCE,k}−1 is the number of CCEs in the control region of subframe k. Before being mapped to REs, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical REs known as REGs. Four QPSK symbols may be mapped to each REG. The PDCCH can be transmitted using one or more CCEs, depending on the size of the DCI and the channel condition. There can be four or more different PDCCH formats defined with different numbers of CCEs (e.g., aggregation level, L=1, 2, 4, or 8 in LTE and L=1, 2, 4, 8, or 16 in NR). The UE 101 monitors a set of PDCCH candidates on one or more activated serving cells as configured by higher layer signaling for control information (e.g., DCI), where monitoring implies attempting to decode each of the PDCCHs (or PDCCH candidates) in the set according to all the monitored DCI formats (e.g., DCI formats 0 through 6-2 as discussed in section 5.3.3 of 3GPP TS 38.212, DCI formats 0_0 through 2_3 as discussed in section 7.3 of 3GPP TS 38.212, or the like). The UEs 101 monitor (or attempt to decode) respective sets of PDCCH candidates in one or more configured monitoring occasions according to the corresponding search space configurations. A DCI transports DL, UL, or SL scheduling information, requests for aperiodic CQI reports, LAA common information, notifications of MCCH change, UL power control commands for one cell and/or one RNTI, notification of a group of UEs 101 of a slot format, notification of a group of UEs of the PRB(s) and OFDM symbol(s) where UE may assume no transmission is intended for the UE, TPC commands for PUCCH and PUSCH, and/or TPC commands for PUCCH and PUSCH. The DCI coding steps are discussed in 3GPP TS 38.212.

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

As alluded to previously, the PDCCH can be used to schedule DL transmissions on PDSCH and UL transmissions on PUSCH, wherein the DCI on PDCCH includes, inter alia, downlink assignments containing at least modulation and coding format, resource allocation, and HARQ information related to DL-SCH; and/or uplink scheduling grants containing at least modulation and coding format, resource allocation, and HARQ information related to UL-SCH. In addition to scheduling, the PDCCH can be used to for activation and deactivation of configured PUSCH transmission(s) with configured grant; activation and deactivation of PDSCH semi-persistent transmission; notifying one or more UEs 101 of a slot format; notifying one or more UEs 101 of the PRB(s) and OFDM symbol(s) where a UE 101 may assume no transmission is intended for the UE; transmission of TPC commands for PUCCH and PUSCH; transmission of one or more TPC commands for SRS transmissions by one or more UEs 101; switching an active BWP for a UE 101; and initiating a random access procedure.

In NR implementations, the UEs 101 monitor (or attempt to decode) respective sets of PDCCH candidates in one or more configured monitoring occasions in one or more configured CORESETs according to the corresponding search space configurations. A CORESET may include a set of PRBs with a time duration of 1 to 3 OFDM symbols. A CORESET may additionally or alternatively include N_{RB}^{CORESET} RBs in the frequency domain and N_{symb}^{CORESET}∈{1,2,3} symbols in the time domain. A CORESET includes six REGs numbered in increasing order in a time-first manner, wherein an REG equals one RB during one OFDM symbol. The UEs 101 can be configured with multiple CORESETS where each CORESET is associated with one CCE-to-REG mapping only. Interleaved and non-interleaved CCE-to-REG mapping are supported in a CORESET. Each REG carrying a PDCCH carries its own DMRS.

According to various embodiments, the UEs 101 and the RAN nodes 111 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 101 and the RAN nodes 111 may operate using LAA, eLAA, and/or feLAA mechanisms. In these implementations, the UEs 101 and the RAN nodes 111 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 101 RAN nodes 111, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 101, AP 106, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the BWs of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 101 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

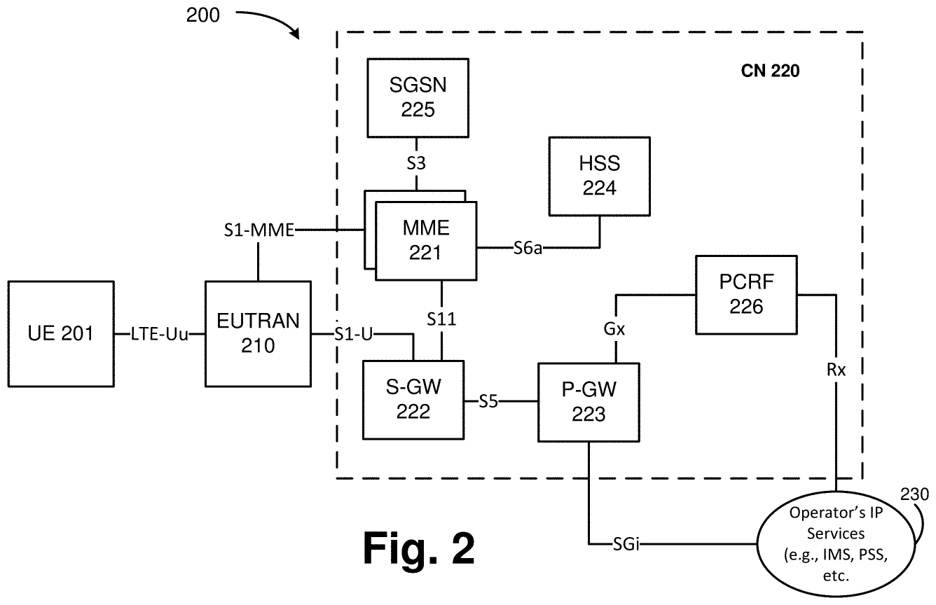

The RAN nodes 111 may be configured to communicate with one another via interface 112. In embodiments where the system 100 is an LTE system (e.g., when CN 120 is an EPC 220 as in FIG. 2), the interface 112 may be an X2 interface 112. The X2 interface may be defined between two or more RAN nodes 111 (e.g., two or more eNBs and the like) that connect to EPC 120, and/or between two eNBs connecting to EPC 120. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 101 from an SeNB for user data; information of PDCP PDUs that were not delivered to a UE 101; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality. In embodiments where the system 100 is an MF system (e.g., when CN 120 is an NHCN 120), the interface 112 may be an X2 interface 112. The X2 interface may be defined between two or more RAN nodes 111 (e.g., two or more MF-APs and the like) that connect to NHCN 120, and/or between two MF-APs connecting to NHCN 120. In these embodiments, the X2 interface may operate in a same or similar manner as discussed previously.

In embodiments where the system 100 is a 5G or NR system (e.g., when CN 120 is an 5GC 320 as in FIG. 3), the interface 112 may be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM-CONNECTED) including functionality to manage the UE mobility for connected mode between one or more RAN nodes 111. The mobility support may include context transfer from an old (source) serving RAN node 111 to new (target) serving RAN node 111; and control of user plane tunnels between old (source) serving RAN node 111 to new (target) serving RAN node 111. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 110 is shown to be communicatively coupled to a core network—in this embodiment, CN 120. The CN 120 may comprise a plurality of network elements 122, which are configured to offer various data and telecommunications services to customers/subscribers (e.g., users of UEs 101) who are connected to the CN 120 via the RAN 110. The components of the CN 120 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 130 may be an element offering applications that use IP bearer resources with the core network (e.g., UMTS PS domain, LTE PS data services, etc.). The application server 130 can also be configured to support one or more communication services (e.g., VoIP sessions, PTT sessions, group communication sessions, social networking services, etc.) for the UEs 101 via the EPC 120.

In embodiments, the CN 120 may be a 5GC (referred to as “5GC 120” or the like), and the RAN 110 may be connected with the CN 120 via an NG interface 113. In embodiments, the NG interface 113 may be split into two parts, an NG user plane (NG-U) interface 114, which carries traffic data between the RAN nodes 111 and a UPF (e.g., the N3 and/or N9 reference points), and the S1 control plane (NG-C) interface 115, which is a signaling interface between the RAN nodes 111 and AMFs 120 (e.g., the N2 reference point). Embodiments where the CN 120 is a 5GC 120 are discussed in more detail with regard to FIG. 3.

In embodiments, the CN 120 may be a 5G CN (referred to as “5GC 120” or the like), while in other embodiments, the CN 120 may be an EPC). Where CN 120 is an EPC (referred to as “EPC 120” or the like), the RAN 110 may be connected with the CN 120 via an S1 interface 113. In embodiments, the S1 interface 113 may be split into two parts, an S1 user plane (S1-U) interface 114, which carries traffic data between the RAN nodes 111 and the S-GW, and the S1-MME interface 115, which is a signaling interface between the RAN nodes 111 and MMEs.

In embodiments where the CN 120 is an MF NHCN 120, the one or more network elements 122 may include or operate one or more NH-MMEs, local AAA proxies, NH-GWs, and/or other like MF NHCN elements. The NH-MME provides similar functionality as an MME in EPC 120. A local AAA proxy is an AAA proxy that is part of an NHN that provides AAA functionalities required for interworking with PSP AAA and 3GPP AAAs. A PSP AAA is an AAA server (or pool of servers) using non-USIM credentials that is associated with a PSP, and may be either internal or external to the NHN, and the 3GPP AAA is discussed in more detail in 3GPP TS 23.402. The NH-GW provides similar functionality as a combined S-GW/P-GW for non-EPC routed PDN connections. For EPC Routed PDN connections, the NHN-GW provides similar functionality as the S-GW discussed previously in interactions with the MF-APs over the S1 interface 113 and is similar to the TWAG in interactions with the PLMN PDN-GWs over the S2a interface. In some embodiments, the MF APs 111 may connect with the EPC 120 discussed previously. Additionally, the RAN 110 (referred to as an “MF RAN 110” or the like) may be connected with the NHCN 120 via an S1 interface 113. In these embodiments, the S1 interface 113 may be split into two parts, the S1-U interface 114 that carries traffic data between the RAN nodes 111 (e.g., the “MF-APs 111”) and the NH-GW, and the S1-MME-N interface 115, which is a signaling interface between the RAN nodes 111 and NH-MMEs. The S1-U interface 114 and the S1-MME-N interface 115 have the same or similar functionality as the S1-U interface 114 and the S1-MME interface 115 of the EPC 120 discussed herein.

FIG. 2 illustrates an example architecture of a system 200 including a first CN 220, in accordance with various embodiments. In this example, system 200 may implement the LTE standard wherein the CN 220 is an EPC 220 that corresponds with CN 120 of FIG. 1. Additionally, the UE 201 may be the same or similar as the UEs 101 of FIG. 1, and the E-UTRAN 210 may be a RAN that is the same or similar to the RAN 110 of FIG. 1, and which may include RAN nodes 111 discussed previously. The CN 220 may comprise MMEs 221, an S-GW 222, a P-GW 223, a HSS 224, and a SGSN 225.

The MMEs 221 may be similar in function to the control plane of legacy SGSN, and may implement MM functions to keep track of the current location of a UE 201. The MMEs 221 may perform various MM procedures to manage mobility aspects in access such as gateway selection and tracking area list management. MM (also referred to as “EPS MM” or “EMM” in E-UTRAN systems) may refer to all applicable procedures, methods, data storage, etc. that are used to maintain knowledge about a present location of the UE 201, provide user identity confidentiality, and/or perform other like services to users/subscribers. Each UE 201 and the MME 221 may include an MM or EMM sublayer, and an MM context may be established in the UE 201 and the MME 221 when an attach procedure is successfully completed. The MM context may be a data structure or database object that stores MM-related information of the UE 201. The MMEs 221 may be coupled with the HSS 224 via an S6a reference point, coupled with the SGSN 225 via an S3 reference point, and coupled with the S-GW 222 via an S11 reference point.

The SGSN 225 may be a node that serves the UE 201 by tracking the location of an individual UE 201 and performing security functions. In addition, the SGSN 225 may perform Inter-EPC node signaling for mobility between 2G/3G and E-UTRAN 3GPP access networks; PDN and S-GW selection as specified by the MMEs 221; handling of UE 201 time zone functions as specified by the MMEs 221; and MME selection for handovers to E-UTRAN 3GPP access network. The S3 reference point between the MMEs 221 and the SGSN 225 may enable user and bearer information exchange for inter-3GPP access network mobility in idle and/or active states.

The HSS 224 may comprise a database for network users, including subscription-related information to support the network entities' handling of communication sessions. The EPC 220 may comprise one or several HSSs 224, depending on the number of mobile subscribers, on the capacity of the equipment, on the organization of the network, etc. For example, the HSS 224 can provide support for routing/roaming, authentication, authorization, naming/addressing resolution, location dependencies, etc. An S6a reference point between the HSS 224 and the MMEs 221 may enable transfer of subscription and authentication data for authenticating/authorizing user access to the EPC 220 between HSS 224 and the MMEs 221.

The S-GW 222 may terminate the S1 interface 113 (“S1-U” in FIG. 2) toward the RAN 210, and routes data packets between the RAN 210 and the EPC 220. In addition, the S-GW 222 may be a local mobility anchor point for inter-RAN node handovers and also may provide an anchor for inter-3GPP mobility. Other responsibilities may include lawful intercept, charging, and some policy enforcement. The S11 reference point between the S-GW 222 and the MMEs 221 may provide a control plane between the MMEs 221 and the S-GW 222. The S-GW 222 may be coupled with the P-GW 223 via an S5 reference point.

The P-GW 223 may terminate an SGi interface toward a PDN 230. The P-GW 223 may route data packets between the EPC 220 and external networks such as a network including the application server 130 (alternatively referred to as an “AF”) via an IP interface 125 (see e.g., FIG. 1). In embodiments, the P-GW 223 may be communicatively coupled to an application server (application server 130 of FIG. 1 or PDN 230 in FIG. 2) via an IP communications interface 125 (see, e.g., FIG. 1). The S5 reference point between the P-GW 223 and the S-GW 222 may provide user plane tunneling and tunnel management between the P-GW 223 and the S-GW 222. The S5 reference point may also be used for S-GW 222 relocation due to UE 201 mobility and if the S-GW 222 needs to connect to a non-collocated P-GW 223 for the required PDN connectivity. The P-GW 223 may further include a node for policy enforcement and charging data collection (e.g., PCEF (not shown)). Additionally, the SGi reference point between the P-GW 223 and the packet data network (PDN) 230 may be an operator external public, a private PDN, or an intra operator packet data network, for example, for provision of IMS services. The P-GW 223 may be coupled with a PCRF 226 via a Gx reference point.

PCRF 226 is the policy and charging control element of the EPC 220. In a non-roaming scenario, there may be a single PCRF 226 in the Home Public Land Mobile Network (HPLMN) associated with a UE 201's Internet Protocol Connectivity Access Network (IP-CAN) session. In a roaming scenario with local breakout of traffic, there may be two PCRFs associated with a UE 201's IP-CAN session, a Home PCRF (H-PCRF) within an HPLMN and a Visited PCRF (V-PCRF) within a Visited Public Land Mobile Network (VPLMN). The PCRF 226 may be communicatively coupled to the application server 230 via the P-GW 223. The application server 230 may signal the PCRF 226 to indicate a new service flow and select the appropriate QoS and charging parameters. The PCRF 226 may provision this rule into a PCEF (not shown) with the appropriate TFT and QCI, which commences the QoS and charging as specified by the application server 230. The Gx reference point between the PCRF 226 and the P-GW 223 may allow for the transfer of QoS policy and charging rules from the PCRF 226 to PCEF in the P-GW 223. An Rx reference point may reside between the PDN 230 (or “AF 230”) and the PCRF 226.

FIG. 3 illustrates an architecture of a system 300 including a second CN 320 in accordance with various embodiments. The system 300 is shown to include a UE 301, which may be the same or similar to the UEs 101 and UE 201 discussed previously; a (R)AN 310, which may be the same or similar to the RAN 110 and RAN 210 discussed previously, and which may include RAN nodes 111 discussed previously; and a DN 303, which may be, for example, operator services, Internet access or 3rd party services; and a 5GC 320. The 5GC 320 may include an AUSF 322; an AMF 321; a SMF 324; a NEF 323; a PCF 326; a NRF 325; a UDM 327; an AF 328; a UPF 302; and a NSSF 329.

The UPF 302 may act as an anchor point for intra-RAT and inter-RAT mobility, an external PDU session point of interconnect to DN 303, and a branching point to support multi-homed PDU session. The UPF 302 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 302 may include an uplink classifier to support routing traffic flows to a data network. The DN 303 may represent various network operator services, Internet access, or third party services. DN 303 may include, or be similar to, application server 130 discussed previously. The UPF 302 may interact with the SMF 324 via an N4 reference point between the SMF 324 and the UPF 302.

The AUSF 322 may store data for authentication of UE 301 and handle authentication-related functionality. The AUSF 322 may facilitate a common authentication framework for various access types. The AUSF 322 may communicate with the AMF 321 via an N12 reference point between the AMF 321 and the AUSF 322; and may communicate with the UDM 327 via an N13 reference point between the UDM 327 and the AUSF 322. Additionally, the AUSF 322 may exhibit an Nausf service-based interface.

The AMF 321 may be responsible for registration management (e.g., for registering UE 301, etc.), connection management, reachability management, mobility management, and lawful interception of AMF-related events, and access authentication and authorization. The AMF 321 may be a termination point for the N11 reference point between the AMF 321 and the SMF 324. The AMF 321 may provide transport for SM messages between the UE 301 and the SMF 324, and act as a transparent proxy for routing SM messages. AMF 321 may also provide transport for SMS messages between UE 301 and an SMSF (not shown by FIG. 3). AMF 321 may act as SEAF, which may include interaction with the AUSF 322 and the UE 301, receipt of an intermediate key that was established as a result of the UE 301 authentication process. Where USIM based authentication is used, the AMF 321 may retrieve the security material from the AUSF 322. AMF 321 may also include a SCM function, which receives a key from the SEA that it uses to derive access-network specific keys. Furthermore, AMF 321 may be a termination point of a RAN CP interface, which may include or be an N2 reference point between the (R)AN 310 and the AMF 321; and the AMF 321 may be a termination point of NAS (N1) signaling, and perform NAS ciphering and integrity protection.

AMF 321 may also support NAS signaling with a UE 301 over an N3 IWF interface. The N3IWF may be used to provide access to untrusted entities. N3IWF may be a termination point for the N2 interface between the (R)AN 310 and the AMF 321 for the control plane, and may be a termination point for the N3 reference point between the (R)AN 310 and the UPF 302 for the user plane. As such, the AMF 321 may handle N2 signaling from the SMF 324 and the AMF 321 for PDU sessions and QoS, encapsulate/de-encapsulate packets for IPSec and N3 tunneling, mark N3 user-plane packets in the uplink, and enforce QoS corresponding to N3 packet marking taking into account QoS requirements associated with such marking received over N2. N3IWF may also relay uplink and downlink control-plane NAS signaling between the UE 301 and AMF 321 via an N1 reference point between the UE 301 and the AMF 321, and relay uplink and downlink user-plane packets between the UE 301 and UPF 302. The N3IWF also provides mechanisms for IPsec tunnel establishment with the UE 301. The AMF 321 may exhibit an Namf service-based interface, and may be a termination point for an N14 reference point between two AMFs 321 and an N17 reference point between the AMF 321 and a 5G-EIR (not shown by FIG. 3).

The UE 301 may need to register with the AMF 321 in order to receive network services. RM is used to register or deregister the UE 301 with the network (e.g., AMF 321), and establish a UE context in the network (e.g., AMF 321). The UE 301 may operate in an RM-REGISTERED state or an RM-DEREGISTERED state. In the RM-DEREGISTERED state, the UE 301 is not registered with the network, and the UE context in AMF 321 holds no valid location or routing information for the UE 301 so the UE 301 is not reachable by the AMF 321. In the RM-REGISTERED state, the UE 301 is registered with the network, and the UE context in AMF 321 may hold a valid location or routing information for the UE 301 so the UE 301 is reachable by the AMF 321. In the RM-REGISTERED state, the UE 301 may perform mobility Registration Update procedures, perform periodic Registration Update procedures triggered by expiration of the periodic update timer (e.g., to notify the network that the UE 301 is still active), and perform a Registration Update procedure to update UE capability information or to re-negotiate protocol parameters with the network, among others.

The AMF 321 may store one or more RM contexts for the UE 301, where each RM context is associated with a specific access to the network. The RM context may be a data structure, database object, etc. that indicates or stores, inter alia, a registration state per access type and the periodic update timer. The AMF 321 may also store a 5GC MM context that may be the same or similar to the (E)MM context discussed previously. In various embodiments, the AMF 321 may store a CE mode B Restriction parameter of the UE 301 in an associated MM context or RM context. The AMF 321 may also derive the value, when needed, from the UE's usage setting parameter already stored in the UE context (and/or MM/RM context).

CM may be used to establish and release a signaling connection between the UE 301 and the AMF 321 over the N1 interface. The signaling connection is used to enable NAS signaling exchange between the UE 301 and the CN 320, and comprises both the signaling connection between the UE and the AN (e.g., RRC connection or UE-N31WF connection for non-3GPP access) and the N2 connection for the UE 301 between the AN (e.g., RAN 310) and the AMF 321. The UE 301 may operate in one of two CM states, CM-IDLE mode, or CM-CONNECTED mode. When the UE 301 is operating in the CM-IDLE state/mode, the UE 301 may have no NAS signaling connection established with the AMF 321 over the N1 interface, and there may be (R)AN 310 signaling connection (e.g., N2 and/or N3 connections) for the UE 301. When the UE 301 is operating in the CM-CONNECTED state/mode, the UE 301 may have an established NAS signaling connection with the AMF 321 over the N1 interface, and there may be a (R)AN 310 signaling connection (e.g., N2 and/or N3 connections) for the UE 301. Establishment of an N2 connection between the (R)AN 310 and the AMF 321 may cause the UE 301 to transition from CM-IDLE mode to CM-CONNECTED mode, and the UE 301 may transition from the CM-CONNECTED mode to the CM-IDLE mode when N2 signaling between the (R)AN 310 and the AMF 321 is released.

The SMF 324 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 301 and a data network (DN) 303 identified by a Data Network Name (DNN). PDU sessions may be established upon UE 301 request, modified upon UE 301 and 5GC 320 request, and released upon UE 301 and 5GC 320 request using NAS SM signaling exchanged over the N1 reference point between the UE 301 and the SMF 324. Upon request from an application server, the 5GC 320 may trigger a specific application in the UE 301. In response to receipt of the trigger message, the UE 301 may pass the trigger message (or relevant parts/information of the trigger message) to one or more identified applications in the UE 301. The identified application(s) in the UE 301 may establish a PDU session to a specific DNN. The SMF 324 may check whether the UE 301 requests are compliant with user subscription information associated with the UE 301. In this regard, the SMF 324 may retrieve and/or request to receive update notifications on SMF 324 level subscription data from the UDM 327.

The SMF 324 may include the following roaming functionality: handling local enforcement to apply QoS SLAB (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 324 may be included in the system 300, which may be between another SMF 324 in a visited network and the SMF 324 in the home network in roaming scenarios. Additionally, the SMF 324 may exhibit the Nsmf service-based interface.

The NEF 323 may provide means for securely exposing the services and capabilities provided by 3GPP network functions for third party, internal exposure/re-exposure, Application Functions (e.g., AF 328), edge computing or fog computing systems, etc. In such embodiments, the NEF 323 may authenticate, authorize, and/or throttle the AFs. NEF 323 may also translate information exchanged with the AF 328 and information exchanged with internal network functions. For example, the NEF 323 may translate between an AF-Service-Identifier and an internal 5GC information. NEF 323 may also receive information from other network functions (NFs) based on exposed capabilities of other network functions. This information may be stored at the NEF 323 as structured data, or at a data storage NF using standardized interfaces. The stored information can then be re-exposed by the NEF 323 to other NFs and AFs, and/or used for other purposes such as analytics. Additionally, the NEF 323 may exhibit an Nnef service-based interface.

The NRF 325 may support service discovery functions, receive NF discovery requests from NF instances, and provide the information of the discovered NF instances to the NF instances. NRF 325 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 325 may exhibit the Nnrf service-based interface.

The PCF 326 may provide policy rules to control plane function(s) to enforce them, and may also support unified policy framework to govern network behaviour. The PCF 326 may also implement an FE to access subscription information relevant for policy decisions in a UDR of the UDM 327. The PCF 326 may communicate with the AMF 321 via an N15 reference point between the PCF 326 and the AMF 321, which may include a PCF 326 in a visited network and the AMF 321 in case of roaming scenarios. The PCF 326 may communicate with the AF 328 via an N5 reference point between the PCF 326 and the AF 328; and with the SMF 324 via an N7 reference point between the PCF 326 and the SMF 324. The system 300 and/or CN 320 may also include an N24 reference point between the PCF 326 (in the home network) and a PCF 326 in a visited network. Additionally, the PCF 326 may exhibit an Npcf service-based interface.

The UDM 327 may handle subscription-related information to support the network entities' handling of communication sessions, and may store subscription data of UE 301. For example, subscription data may be communicated between the UDM 327 and the AMF 321 via an N8 reference point between the UDM 327 and the AMF. The UDM 327 may include two parts, an application FE and a UDR (the FE and UDR are not shown by FIG. 3). The UDR may store subscription data and policy data for the UDM 327 and the PCF 326, and/or structured data for exposure and application data (including PFDs for application detection, application request information for multiple UEs 301) for the NEF 323. The Nudr service-based interface may be exhibited by the UDR 321 to allow the UDM 327, PCF 326, and NEF 323 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 324 via an N10 reference point between the UDM 327 and the SMF 324. UDM 327 may also support SMS management, wherein an SMS-FE implements the similar application logic as discussed previously. Additionally, the UDM 327 may exhibit the Nudm service-based interface.

The AF 328 may provide application influence on traffic routing, provide access to the NCE, and interact with the policy framework for policy control. The NCE may be a mechanism that allows the 5GC 320 and AF 328 to provide information to each other via NEF 323, which may be used for edge computing implementations. In such implementations, the network operator and third party services may be hosted close to the UE 301 access point of attachment to achieve an efficient service delivery through the reduced end-to-end latency and load on the transport network. For edge computing implementations, the 5GC may select a UPF 302 close to the UE 301 and execute traffic steering from the UPF 302 to DN 303 via the N6 interface. This may be based on the UE subscription data, UE location, and information provided by the AF 328. In this way, the AF 328 may influence UPF (re)selection and traffic routing. Based on operator deployment, when AF 328 is considered to be a trusted entity, the network operator may permit AF 328 to interact directly with relevant NFs. Additionally, the AF 328 may exhibit an Naf service-based interface.

The NSSF 329 may select a set of network slice instances serving the UE 301. The NSSF 329 may also determine allowed NSSAI and the mapping to the subscribed S-NSSAIs, if needed. The NSSF 329 may also determine the AMF set to be used to serve the UE 301, or a list of candidate AMF(s) 321 based on a suitable configuration and possibly by querying the NRF 325. The selection of a set of network slice instances for the UE 301 may be triggered by the AMF 321 with which the UE 301 is registered by interacting with the NSSF 329, which may lead to a change of AMF 321. The NSSF 329 may interact with the AMF 321 via an N22 reference point between AMF 321 and NSSF 329; and may communicate with another NSSF 329 in a visited network via an N31 reference point (not shown by FIG. 3). Additionally, the NSSF 329 may exhibit an Nnssf service-based interface.

As discussed previously, the CN 320 may include an SMSF, which may be responsible for SMS subscription checking and verification, and relaying SM messages to/from the UE 301 to/from other entities, such as an SMS-GMSC/IWMSC/SMS-router. The SMS may also interact with AMF 321 and UDM 327 for a notification procedure that the UE 301 is available for SMS transfer (e.g., set a UE not reachable flag, and notifying UDM 327 when UE 301 is available for SMS).

The CN 120 may also include other elements that are not shown by FIG. 3, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 3). Individual NFs may share a UDSF for storing their respective unstructured data or individual NFs may each have their own UDSF located at or near the individual NFs. Additionally, the UDSF may exhibit an Nudsf service-based interface (not shown by FIG. 3). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 3 for clarity. In one example, the CN 320 may include an Nx interface, which is an inter-CN interface between the MME (e.g., MME 221) and the AMF 321 in order to enable interworking between CN 320 and CN 220. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

FIG. 4 illustrates an example of infrastructure equipment 400 in accordance with various embodiments. The infrastructure equipment 400 (or “system 400”) may be implemented as a base station, radio head, RAN node such as the RAN nodes 111 and/or AP 106 shown and described previously, application server(s) 130, and/or any other element/device discussed herein. In other examples, the system 400 could be implemented in or by a UE.

The system 400 includes application circuitry 405, baseband circuitry 410, one or more radio front end modules (RFEMs) 415, memory circuitry 420, power management integrated circuitry (PMIC) 425, power tee circuitry 430, network controller circuitry 435, network interface connector 440, satellite positioning circuitry 445, and user interface 450. In some embodiments, the device 400 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 405 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 405 may be coupled with or may include memory/storage elements and may be configured to execute instructions stored in the memory/storage to enable various applications or operating systems to run on the system 400. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 405 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 405 may comprise, or may be, a special-purpose processor/controller to operate according to the various embodiments herein. As examples, the processor(s) of application circuitry 405 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 400 may not utilize application circuitry 405, and instead may include a special-purpose processor/controller to process IP data received from an EPC or 5GC, for example.

In some implementations, the application circuitry 405 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 405 may comprise logic blocks or logic fabric, and other interconnected resources that may be programmed to perform various functions, such as the procedures, methods, functions, etc. of the various embodiments discussed herein. In such embodiments, the circuitry of application circuitry 405 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

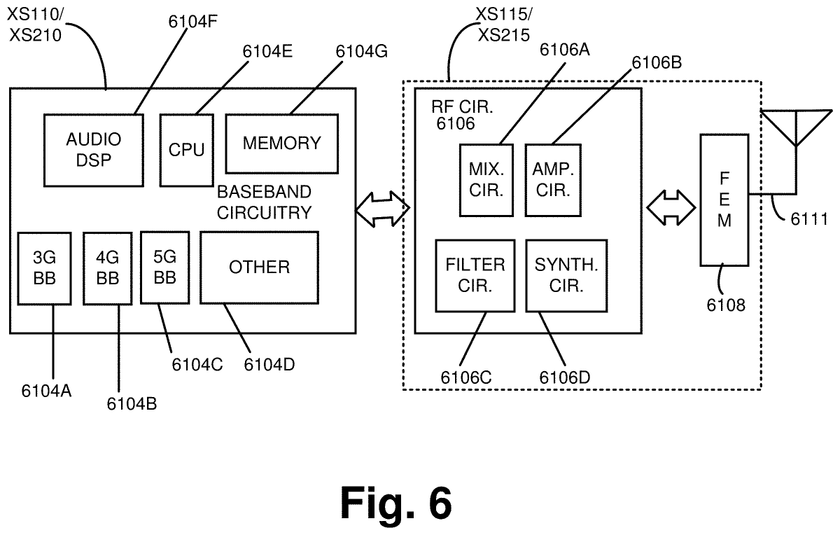

The baseband circuitry 410 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 410 are discussed infra with regard to FIG. 6.

User interface circuitry 450 may include one or more user interfaces designed to enable user interaction with the system 400 or peripheral component interfaces designed to enable peripheral component interaction with the system 400. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 415 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 6111 of FIG. 6 infra), and the RFEM may be connected to multiple antennas. In alternative implementations, both mmWave and sub-mmWave radio functions may be implemented in the same physical RFEM 415, which incorporates both mmWave antennas and sub-mmWave.

The memory circuitry 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 420 may be implemented as one or more of solder down packaged integrated circuits, socketed memory modules and plug-in memory cards.

The PMIC 425 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 430 may provide for electrical power drawn from a network cable to provide both power supply and data connectivity to the infrastructure equipment 400 using a single cable.

The network controller circuitry 435 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 400 via network interface connector 440 using a physical connection, which may be electrical (commonly referred to as a “copper interconnect”), optical, or wireless. The network controller circuitry 435 may include one or more dedicated processors and/or FPGAs to communicate using one or more of the aforementioned protocols. In some implementations, the network controller circuitry 435 may include multiple controllers to provide connectivity to other networks using the same or different protocols.

The positioning circuitry 445 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 445 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 445 may include a Micro-Technology for Positioning, Navigation, and Timing (Micro-PNT) IC that uses a master timing clock to perform position tracking/estimation without GNSS assistance. The positioning circuitry 445 may also be part of, or interact with, the baseband circuitry 410 and/or RFEMs 415 to communicate with the nodes and components of the positioning network. The positioning circuitry 445 may also provide position data and/or time data to the application circuitry 405, which may use the data to synchronize operations with various infrastructure (e.g., RAN nodes 111, etc.), or the like.

The components shown by FIG. 4 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

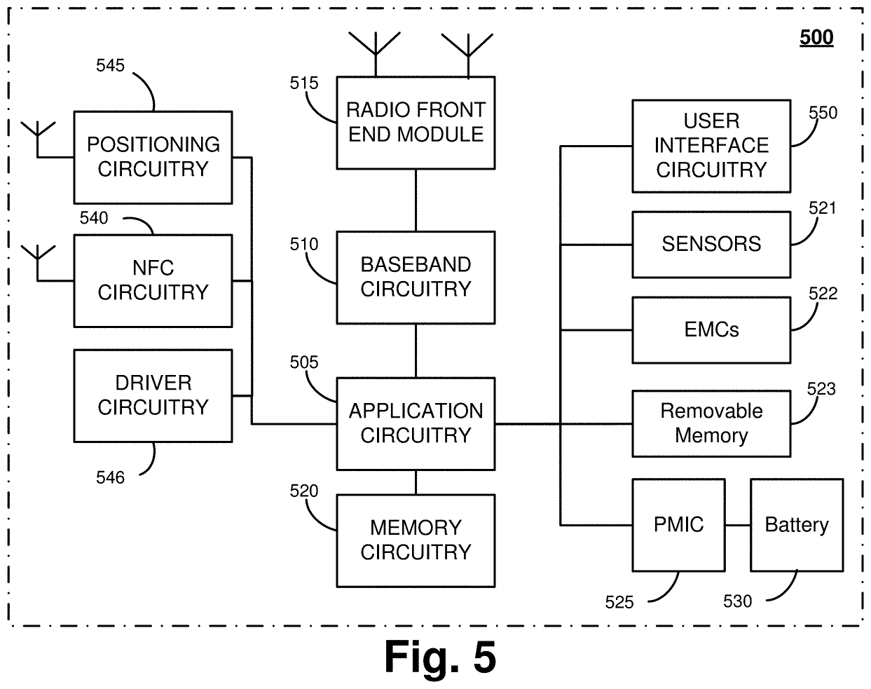

FIG. 5 illustrates an example of a platform 500 (or “device 500”) in accordance with various embodiments. In embodiments, the computer platform 500 may be suitable for use as UEs 101, 201, 301, application servers 130, and/or any other element/device discussed herein. The platform 500 may include any combinations of the components shown in the example. The components of platform 500 may be implemented as integrated circuits (ICs), portions thereof, discrete electronic devices, or other modules, logic, hardware, software, firmware, or a combination thereof adapted in the computer platform 500, or as components otherwise incorporated within a chassis of a larger system. The block diagram of FIG. 5 is intended to show a high level view of components of the computer platform 500. However, some of the components shown may be omitted, additional components may be present, and different arrangement of the components shown may occur in other implementations.

Application circuitry 505 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 505 may be coupled with or may include memory/storage elements and may be configured to execute instructions stored in the memory/storage to enable various applications or operating systems to run on the system 500. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 405 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 405 may comprise, or may be, a special-purpose processor/controller to operate according to the various embodiments herein.

As examples, the processor(s) of application circuitry 505 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 505 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.° Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 505 may be a part of a system on a chip (SoC) in which the application circuitry 505 and other components are formed into a single integrated circuit, or a single package, such as the Edison™ or Galileo™ SoC boards from Intel® Corporation.

Additionally or alternatively, application circuitry 505 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 505 may comprise logic blocks or logic fabric, and other interconnected resources that may be programmed to perform various functions, such as the procedures, methods, functions, etc. of the various embodiments discussed herein. In such embodiments, the circuitry of application circuitry 505 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 510 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 510 are discussed infra with regard to FIG. 6.

The RFEMs 515 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 6111 of FIG. 6 infra), and the RFEM may be connected to multiple antennas. In alternative implementations, both mmWave and sub-mmWave radio functions may be implemented in the same physical RFEM 515, which incorporates both mmWave antennas and sub-mmWave.

The memory circuitry 520 may include any number and type of memory devices used to provide for a given amount of system memory. As examples, the memory circuitry 520 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 520 may be developed in accordance with a Joint Electron Devices Engineering Council (JEDEC) low power double data rate (LPDDR)-based design, such as LPDDR2, LPDDR3, LPDDR4, or the like. Memory circuitry 520 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 520 may be on-die memory or registers associated with the application circuitry 505. To provide for persistent storage of information such as data, applications, operating systems and so forth, memory circuitry 520 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 500 may incorporate the three-dimensional (3D) cross-point (XPOINT) memories from Intel® and Micron®.

Removable memory circuitry 523 may include devices, circuitry, enclosures/housings, ports, or receptacles, etc. used to couple portable data storage devices with the platform 500. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 500 may also include interface circuitry (not shown) that is used to connect external devices with the platform 500. The external devices connected to the platform 500 via the interface circuitry include sensor circuitry 521 and electro-mechanical components (EMCs) 522, as well as removable memory devices coupled to removable memory circuitry 523.

The sensor circuitry 521 include devices, modules, or subsystems whose purpose is to detect events or changes in its environment and send the information (sensor data) about the detected events to some other a device, module, subsystem, etc. Examples of such sensors include, inter alia, inertia measurement units (IMUS) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 522 include devices, modules, or subsystems whose purpose is to enable platform 500 to change its state, position, and/or orientation, or move or control a mechanism or (sub)system. Additionally, EMCs 522 may be configured to generate and send messages/signaling to other components of the platform 500 to indicate a current state of the EMCs 522. Examples of the EMCs 522 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 500 is configured to operate one or more EMCs 522 based on one or more captured events and/or instructions or control signals received from a service provider and/or various clients.

In some implementations, the interface circuitry may connect the platform 500 with positioning circuitry 545. The positioning circuitry 545 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 545 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 545 may include a Micro-PNT IC that uses a master timing clock to perform position tracking/estimation without GNSS assistance. The positioning circuitry 545 may also be part of, or interact with, the baseband circuitry 410 and/or RFEMs 515 to communicate with the nodes and components of the positioning network. The positioning circuitry 545 may also provide position data and/or time data to the application circuitry 505, which may use the data to synchronize operations with various infrastructure (e.g., radio base stations), for turn-by-turn navigation applications, or the like

In some implementations, the interface circuitry may connect the platform 500 with Near-Field Communication (NFC) circuitry 540. NFC circuitry 540 is configured to provide contactless, short-range communications based on radio frequency identification (RFID) standards, wherein magnetic field induction is used to enable communication between NFC circuitry 540 and NFC-enabled devices external to the platform 500 (e.g., an “NFC touchpoint”). NFC circuitry 540 comprises an NFC controller coupled with an antenna element and a processor coupled with the NFC controller. The NFC controller may be a chip/IC providing NFC functionalities to the NFC circuitry 540 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 540, or initiate data transfer between the NFC circuitry 540 and another active NFC device (e.g., a smartphone or an NFC-enabled POS terminal) that is proximate to the platform 500.

The driver circuitry 546 may include software and hardware elements that operate to control particular devices that are embedded in the platform 500, attached to the platform 500, or otherwise communicatively coupled with the platform 500. The driver circuitry 546 may include individual drivers allowing other components of the platform 500 to interact with or control various input/output (I/O) devices that may be present within, or connected to, the platform 500. For example, driver circuitry 546 may include a display driver to control and allow access to a display device, a touchscreen driver to control and allow access to a touchscreen interface of the platform 500, sensor drivers to obtain sensor readings of sensor circuitry 521 and control and allow access to sensor circuitry 521, EMC drivers to obtain actuator positions of the EMCs 522 and/or control and allow access to the EMCs 522, a camera driver to control and allow access to an embedded image capture device, audio drivers to control and allow access to one or more audio devices.

The power management integrated circuitry (PMIC) 525 (also referred to as “power management circuitry 525”) may manage power provided to various components of the platform 500. In particular, with respect to the baseband circuitry 510, the PMIC 525 may control power-source selection, voltage scaling, battery charging, or DC-to-DC conversion. The PMIC 525 may often be included when the platform 500 is capable of being powered by a battery 530, for example, when the device is included in a UE 101, 201, 301.

In some embodiments, the PMIC 525 may control, or otherwise be part of, various power saving mechanisms of the platform 500. For example, if the platform 500 is in an RRC_Connected state, where it is still connected to the RAN node as it expects to receive traffic shortly, then it may enter a state known as Discontinuous Reception Mode (DRX) after a period of inactivity. During this state, the platform 500 may power down for brief intervals of time and thus save power. If there is no data traffic activity for an extended period of time, then the platform 500 may transition off to an RRC_Idle state, where it disconnects from the network and does not perform operations such as channel quality feedback, handover, etc. The platform 500 goes into a very low power state and it performs paging where again it periodically wakes up to listen to the network and then powers down again. The platform 500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 530 may power the platform 500, although in some examples the platform 500 may be mounted deployed in a fixed location, and may have a power supply coupled to an electrical grid. The battery 530 may be a lithium ion battery, a metal-air battery, such as a zinc-air battery, an aluminum-air battery, a lithium-air battery, and the like. In some implementations, such as in V2X applications, the battery 530 may be a typical lead-acid automotive battery.

In some implementations, the battery 530 may be a “smart battery,” which includes or is coupled with a Battery Management System (BMS) or battery monitoring integrated circuitry. The BMS may be included in the platform 500 to track the state of charge (SoCh) of the battery 530. The BMS may be used to monitor other parameters of the battery 530 to provide failure predictions, such as the state of health (SoH) and the state of function (SoF) of the battery 530. The BMS may communicate the information of the battery 530 to the application circuitry 505 or other components of the platform 500. The BMS may also include an analog-to-digital (ADC) convertor that allows the application circuitry 505 to directly monitor the voltage of the battery 530 or the current flow from the battery 530. The battery parameters may be used to determine actions that the platform 500 may perform, such as transmission frequency, network operation, sensing frequency, and the like.

A power block, or other power supply coupled to an electrical grid may be coupled with the BMS to charge the battery 530. In some examples, the power block XS30 may be replaced with a wireless power receiver to obtain the power wirelessly, for example, through a loop antenna in the computer platform 500. In these examples, a wireless battery charging circuit may be included in the BMS. The specific charging circuits chosen may depend on the size of the battery 530, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 550 includes various input/output (I/O) devices present within, or connected to, the platform 500, and includes one or more user interfaces designed to enable user interaction with the platform 500 and/or peripheral component interfaces designed to enable peripheral component interaction with the platform 500. The user interface circuitry 550 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 500. The output device circuitry may also include speakers or other audio emitting devices, printer(s), and/or the like. In some embodiments, the sensor circuitry 521 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 500 may communicate with one another using a suitable bus or interconnect (IX) technology, which may include any number of technologies, including ISA, EISA, PCI, PCIx, PCIe, a Time-Trigger Protocol (UP) system, a FlexRay system, or any number of other technologies. The bus/IX may be a proprietary bus/IX, for example, used in a SoC based system. Other bus/IX systems may be included, such as an I2C interface, an SPI interface, point-to-point interfaces, and a power bus, among others.

FIG. 6 illustrates example components of baseband circuitry 6110 and radio front end modules (RFEM) 6115 in accordance with various embodiments. The baseband circuitry 6110 corresponds to the baseband circuitry 410 and 510 of FIGS. 4 and 5, respectively. The RFEM 6115 corresponds to the RFEM 415 and 515 of FIGS. 4 and 5, respectively. As shown, the RFEMs 6115 may include Radio Frequency (RF) circuitry 6106, front-end module (FEM) circuitry 6108, antenna array 6111 coupled together at least as shown.

The baseband circuitry 6110 includes circuitry and/or control logic configured to carry out various radio/network protocol and radio control functions that enable communication with one or more radio networks via the RF circuitry 6106. The radio control functions may include, but are not limited to, signal modulation/demodulation, encoding/decoding, radio frequency shifting, etc. In some embodiments, modulation/demodulation circuitry of the baseband circuitry 6110 may include Fast-Fourier Transform (FFT), precoding, or constellation mapping/demapping functionality. In some embodiments, encoding/decoding circuitry of the baseband circuitry 6110 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 6110 is configured to process baseband signals received from a receive signal path of the RF circuitry 6106 and to generate baseband signals for a transmit signal path of the RF circuitry 6106. The baseband circuitry 6110 is configured to interface with application circuitry 405/505 (see FIGS. 4 and 5) for generation and processing of the baseband signals and for controlling operations of the RF circuitry 6106. The baseband circuitry 6110 may handle various radio control functions.

The aforementioned circuitry and/or control logic of the baseband circuitry 6110 may include one or more single or multi-core processors. For example, the one or more processors may include a 3G baseband processor 6104A, a 4G/LTE baseband processor 6104B, a 5G/NR baseband processor 6104C, or some other baseband processor(s) 6104D for other existing generations, generations in development or to be developed in the future (e.g., sixth generation (6G), etc.). In other embodiments, some or all of the functionality of baseband processors 6104A-D may be included in modules stored in the memory 6104G and executed via a Central Processing Unit (CPU) 6104E. In other embodiments, some or all of the functionality of baseband processors 6104A-D may be provided as hardware accelerators (e.g., FPGAs, ASICs, etc.) loaded with the appropriate bit streams or logic blocks stored in respective memory cells. In various embodiments, the memory 6104G may store program code of a real-time OS (RTOS), which when executed by the CPU 6104E (or other baseband processor), is to cause the CPU 6104E (or other baseband processor) to manage resources of the baseband circuitry 6110, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 6110 includes one or more audio digital signal processor(s) (DSP) 6104F. The audio DSP(s) 6104F include elements for compression/decompression and echo cancellation and may include other suitable processing elements in other embodiments.

In some embodiments, each of the processors 6104A-6104E include respective memory interfaces to send/receive data to/from the memory 6104G. The baseband circuitry 6110 may further include one or more interfaces to communicatively couple to other circuitries/devices, such as an interface to send/receive data to/from memory external to the baseband circuitry 6110; an application circuitry interface to send/receive data to/from the application circuitry 405/505 of FIGS. 4-5); an RF circuitry interface to send/receive data to/from RF circuitry 6106 of FIG. 6; a wireless hardware connectivity interface to send/receive data to/from one or more wireless hardware elements (e.g., Near Field Communication (NFC) components, Bluetooth®/Bluetooth®Low Energy components, Wi-Fi® components, and/or the like); and a power management interface to send/receive power or control signals to/from the PMIC 525.

In alternate embodiments (which may be combined with the above described embodiments), baseband circuitry 6110 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 6110 may include protocol processing circuitry with one or more instances of control circuitry (not shown) to provide control functions for the digital baseband circuitry and/or radio frequency circuitry (e.g., the radio front end modules 6115).

Although not shown by FIG. 6, in some embodiments, the baseband circuitry 6110 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 6110 and/or RF circuitry 6106 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 6110 and/or RF circuitry 6106 are part of a Wi-Fi communication system. In the second example, the protocol processing circuitry would operate Wi-Fi MAC and logical link control (LLC) functions. The protocol processing circuitry may include one or more memory structures (e.g., 6104G) to store program code and data for operating the protocol functions, as well as one or more processing cores to execute the program code and perform various operations using the data. The baseband circuitry 6110 may also support radio communications for more than one wireless protocol.

The various hardware elements of the baseband circuitry 6110 discussed herein may be implemented, for example, as a solder-down substrate including one or more integrated circuits (ICs), a single packaged IC soldered to a main circuit board or a multi-chip module containing two or more ICs. In one example, the components of the baseband circuitry 6110 may be suitably combined in a single chip or chipset, or disposed on a same circuit board. In another example, some or all of the constituent components of the baseband circuitry 6110 and RF circuitry 6106 may be implemented together such as, for example, a system on a chip (SoC) or System-in-Package (SiP). In another example, some or all of the constituent components of the baseband circuitry 6110 may be implemented as a separate SoC that is communicatively coupled with and RF circuitry 6106 (or multiple instances of RF circuitry 6106). In yet another example, some or all of the constituent components of the baseband circuitry 6110 and the application circuitry 405/505 may be implemented together as individual SoCs mounted to a same circuit board (e.g., a “multi-chip package”).

In some embodiments, the baseband circuitry 6110 may provide for communication compatible with one or more radio technologies. For example, in some embodiments, the baseband circuitry 6110 may support communication with an E-UTRAN or other WMAN, a WLAN, a WPAN. Embodiments in which the baseband circuitry 6110 is configured to support radio communications of more than one wireless protocol may be referred to as multi-mode baseband circuitry.

RF circuitry 6106 may enable communication with wireless networks using modulated electromagnetic radiation through a non-solid medium. In various embodiments, the RF circuitry 6106 may include switches, filters, amplifiers, etc. to facilitate the communication with the wireless network. RF circuitry 6106 may include a receive signal path, which may include circuitry to down-convert RF signals received from the FEM circuitry 6108 and provide baseband signals to the baseband circuitry 6110. RF circuitry 6106 may also include a transmit signal path, which may include circuitry to up-convert baseband signals provided by the baseband circuitry 6110 and provide RF output signals to the FEM circuitry 6108 for transmission.

In some embodiments, the receive signal path of the RF circuitry 6106 may include mixer circuitry 6106a, amplifier circuitry 6106b and filter circuitry 6106c. In some embodiments, the transmit signal path of the RF circuitry 6106 may include filter circuitry 6106c and mixer circuitry 6106a. RF circuitry 6106 may also include synthesizer circuitry 6106d for synthesizing a frequency for use by the mixer circuitry 6106a of the receive signal path and the transmit signal path. In some embodiments, the mixer circuitry 6106a of the receive signal path may be configured to down-convert RF signals received from the FEM circuitry 6108 based on the synthesized frequency provided by synthesizer circuitry 6106d. The amplifier circuitry 6106b may be configured to amplify the down-converted signals and the filter circuitry 6106c may be a low-pass filter (LPF) or band-pass filter (BPF) configured to remove unwanted signals from the down-converted signals to generate output baseband signals. Output baseband signals may be provided to the baseband circuitry 6110 for further processing. In some embodiments, the output baseband signals may be zero-frequency baseband signals, although this is not a requirement. In some embodiments, mixer circuitry 6106a of the receive signal path may comprise passive mixers, although the scope of the embodiments is not limited in this respect.

In some embodiments, the mixer circuitry 6106a of the transmit signal path may be configured to up-convert input baseband signals based on the synthesized frequency provided by the synthesizer circuitry 6106d to generate RF output signals for the FEM circuitry 6108. The baseband signals may be provided by the baseband circuitry 6110 and may be filtered by filter circuitry 6106c.

In some embodiments, the mixer circuitry 6106a of the receive signal path and the mixer circuitry 6106a of the transmit signal path may include two or more mixers and may be arranged for quadrature downconversion and upconversion, respectively. In some embodiments, the mixer circuitry 6106a of the receive signal path and the mixer circuitry 6106a of the transmit signal path may include two or more mixers and may be arranged for image rejection (e.g., Hartley image rejection). In some embodiments, the mixer circuitry 6106a of the receive signal path and the mixer circuitry 6106a of the transmit signal path may be arranged for direct downconversion and direct upconversion, respectively. In some embodiments, the mixer circuitry 6106a of the receive signal path and the mixer circuitry 6106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 6106 may include analog-to-digital converter (ADC) and digital-to-analog converter (DAC) circuitry and the baseband circuitry 6110 may include a digital baseband interface to communicate with the RF circuitry 6106.

In some dual-mode embodiments, a separate radio IC circuitry may be provided for processing signals for each spectrum, although the scope of the embodiments is not limited in this respect.

In some embodiments, the synthesizer circuitry 6106d may be a fractional-N synthesizer or a fractional N/N+1 synthesizer, although the scope of the embodiments is not limited in this respect as other types of frequency synthesizers may be suitable. For example, synthesizer circuitry 6106d may be a delta-sigma synthesizer, a frequency multiplier, or a synthesizer comprising a phase-locked loop with a frequency divider.

The synthesizer circuitry 6106d may be configured to synthesize an output frequency for use by the mixer circuitry 6106a of the RF circuitry 6106 based on a frequency input and a divider control input. In some embodiments, the synthesizer circuitry 6106d may be a fractional N/N+1 synthesizer.

In some embodiments, frequency input may be provided by a voltage controlled oscillator (VCO), although that is not a requirement. Divider control input may be provided by either the baseband circuitry 6110 or the application circuitry 405/505 depending on the desired output frequency. In some embodiments, a divider control input (e.g., N) may be determined from a look-up table based on a channel indicated by the application circuitry 405/505.

Synthesizer circuitry 6106d of the RF circuitry 6106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 6106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 6106 may include an IQ/polar converter.

FEM circuitry 6108 may include a receive signal path, which may include circuitry configured to operate on RF signals received from antenna array 6111, amplify the received signals and provide the amplified versions of the received signals to the RF circuitry 6106 for further processing. FEM circuitry 6108 may also include a transmit signal path, which may include circuitry configured to amplify signals for transmission provided by the RF circuitry 6106 for transmission by one or more of antenna elements of antenna array 6111. In various embodiments, the amplification through the transmit or receive signal paths may be done solely in the RF circuitry 6106, solely in the FEM circuitry 6108, or in both the RF circuitry 6106 and the FEM circuitry 6108.

In some embodiments, the FEM circuitry 6108 may include a TX/RX switch to switch between transmit mode and receive mode operation. The FEM circuitry 6108 may include a receive signal path and a transmit signal path. The receive signal path of the FEM circuitry 6108 may include an LNA to amplify received RF signals and provide the amplified received RF signals as an output (e.g., to the RF circuitry 6106). The transmit signal path of the FEM circuitry 6108 may include a power amplifier (PA) to amplify input RF signals (e.g., provided by RF circuitry 6106), and one or more filters to generate RF signals for subsequent transmission by one or more antenna elements of the antenna array 6111.

The antenna array 6111 comprises one or more antenna elements, each of which is configured convert electrical signals into radio waves to travel through the air and to convert received radio waves into electrical signals. For example, digital baseband signals provided by the baseband circuitry 6110 is converted into analog RF signals (e.g., modulated waveform) that will be amplified and transmitted via the antenna elements of the antenna array 6111 including one or more antenna elements (not shown). The antenna elements may be omnidirectional, direction, or a combination thereof. The antenna elements may be formed in a multitude of arranges as are known and/or discussed herein. The antenna array 6111 may comprise microstrip antennas or printed antennas that are fabricated on the surface of one or more printed circuit boards. The antenna array 6111 may be formed in as a patch of metal foil (e.g., a patch antenna) in a variety of shapes, and may be coupled with the RF circuitry 6106 and/or FEM circuitry 6108 using metal transmission lines or the like.

Processors of the application circuitry 405/505 and processors of the baseband circuitry 6110 may be used to execute elements of one or more instances of a protocol stack. For example, processors of the baseband circuitry 6110, alone or in combination, may be used execute Layer 3, Layer 2, or Layer 1 functionality, while processors of the application circuitry 405/505 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

FIG. 7 illustrates various protocol functions that may be implemented in a wireless communication device according to various embodiments. In particular, FIG. 7 includes an arrangement 700 showing interconnections between various protocol layers/entities. The following description of FIG. 7 is provided for various protocol layers/entities that operate in conjunction with the 5G/NR system standards and LTE system standards, but some or all of the aspects of FIG. 7 may be applicable to other wireless communication network systems as well.

The protocol layers of arrangement 700 may include one or more of PHY 710, MAC 720, RLC 730, PDCP 740, SDAP 747, RRC 755, and NAS layer 757, in addition to other higher layer functions not illustrated. The protocol layers may include one or more service access points (e.g., items 759, 756, 750, 749, 745, 735, 725, and 715 in FIG. 7) that may provide communication between two or more protocol layers.

The PHY 710 may transmit and receive physical layer signals 705 that may be received from or transmitted to one or more other communication devices. The physical layer signals 705 may comprise one or more physical channels, such as those discussed herein. The PHY 710 may further perform link adaptation or adaptive modulation and coding (AMC), power control, cell search (e.g., for initial synchronization and handover purposes), and other measurements used by higher layers, such as the RRC 755. The PHY 710 may still further perform error detection on the transport channels, forward error correction (FEC) coding/decoding of the transport channels, modulation/demodulation of physical channels, interleaving, rate matching, mapping onto physical channels, and MIMO antenna processing. In embodiments, an instance of PHY 710 may process requests from and provide indications to an instance of MAC 720 via one or more PHY-SAP 715. According to some embodiments, requests and indications communicated via PHY-SAP 715 may comprise one or more transport channels.

Instance(s) of MAC 720 may process requests from, and provide indications to, an instance of RLC 730 via one or more MAC-SAPS 725. These requests and indications communicated via the MAC-SAP 725 may comprise one or more logical channels. The MAC 720 may perform mapping between the logical channels and transport channels, multiplexing of MAC SDUs from one or more logical channels onto TBs to be delivered to PHY 710 via the transport channels, de-multiplexing MAC SDUs to one or more logical channels from TBs delivered from the PHY 710 via transport channels, multiplexing MAC SDUs onto TBs, scheduling information reporting, error correction through HARQ, and logical channel prioritization.

Instance(s) of RLC 730 may process requests from and provide indications to an instance of PDCP 740 via one or more radio link control service access points (RLC-SAP) 735. These requests and indications communicated via RLC-SAP 735 may comprise one or more RLC channels. The RLC 730 may operate in a plurality of modes of operation, including: Transparent Mode™, Unacknowledged Mode (UM), and Acknowledged Mode (AM). The RLC 730 may execute transfer of upper layer protocol data units (PDUs), error correction through automatic repeat request (ARQ) for AM data transfers, and concatenation, segmentation and reassembly of RLC SDUs for UM and AM data transfers. The RLC 730 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 740 may process requests from and provide indications to instance(s) of RRC 755 and/or instance(s) of SDAP 747 via one or more packet data convergence protocol service access points (PDCP-SAP) 745. These requests and indications communicated via PDCP-SAP 745 may comprise one or more radio bearers. The PDCP 740 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

Instance(s) of SDAP 747 may process requests from and provide indications to one or more higher layer protocol entities via one or more SDAP-SAP 749. These requests and indications communicated via SDAP-SAP 749 may comprise one or more QoS flows. The SDAP 747 may map QoS flows to DRBs, and vice versa, and may also mark QFIs in DL and UL packets. A single SDAP entity 747 may be configured for an individual PDU session. In the UL direction, the NG-RAN 110 may control the mapping of QoS Flows to DRB(s) in two different ways, reflective mapping or explicit mapping. For reflective mapping, the SDAP 747 of a UE 101 may monitor the QFIs of the DL packets for each DRB, and may apply the same mapping for packets flowing in the UL direction. For a DRB, the SDAP 747 of the UE 101 may map the UL packets belonging to the QoS flows(s) corresponding to the QoS flow ID(s) and PDU session observed in the DL packets for that DRB. To enable reflective mapping, the NG-RAN 310 may mark DL packets over the Uu interface with a QoS flow ID. The explicit mapping may involve the RRC 755 configuring the SDAP 747 with an explicit QoS flow to DRB mapping rule, which may be stored and followed by the SDAP 747. In embodiments, the SDAP 747 may only be used in NR implementations and may not be used in LTE implementations.

The RRC 755 may configure, via one or more management service access points (M-SAP), aspects of one or more protocol layers, which may include one or more instances of PHY 710, MAC 720, RLC 730, PDCP 740 and SDAP 747. In embodiments, an instance of RRC 755 may process requests from and provide indications to one or more NAS entities 757 via one or more RRC-SAPS 756. The main services and functions of the RRC 755 may include broadcast of system information (e.g., included in MIBs or SIBs related to the NAS), broadcast of system information related to the access stratum (AS), paging, establishment, maintenance and release of an RRC connection between the UE 101 and RAN 110 (e.g., RRC connection paging, RRC connection establishment, RRC connection modification, and RRC connection release), establishment, configuration, maintenance and release of point to point Radio Bearers, security functions including key management, inter-RAT mobility, and measurement configuration for UE measurement reporting. The MIBs and SIBs may comprise one or more IEs, which may each comprise individual data fields or data structures.

The NAS 757 may form the highest stratum of the control plane between the UE 101 and the AMF 321. The NAS 757 may support the mobility of the UEs 101 and the session management procedures to establish and maintain IP connectivity between the UE 101 and a P-GW in LTE systems.

According to various embodiments, one or more protocol entities of arrangement 700 may be implemented in UEs 101, RAN nodes 111, AMF 321 in NR implementations or MME 221 in LTE implementations, UPF 302 in NR implementations or S-GW 222 and P-GW 223 in LTE implementations, or the like to be used for control plane or user plane communications protocol stack between the aforementioned devices. In such embodiments, one or more protocol entities that may be implemented in one or more of UE 101, gNB 111, AMF 321, etc. may communicate with a respective peer protocol entity that may be implemented in or on another device using the services of respective lower layer protocol entities to perform such communication. In some embodiments, a gNB-CU of the gNB 111 may host the RRC 755, SDAP 747, and PDCP 740 of the gNB that controls the operation of one or more gNB-DUs, and the gNB-DUs of the gNB 111 may each host the RLC 730, MAC 720, and PHY 710 of the gNB 111.

In a first example, a control plane protocol stack may comprise, in order from highest layer to lowest layer, NAS 757, RRC 755, PDCP 740, RLC 730, MAC 720, and PHY 710. In this example, upper layers 760 may be built on top of the NAS 757, which includes an IP layer 761, an SCTP 762, and an application layer signaling protocol (AP) 763.

In NR implementations, the AP 763 may be an NG application protocol layer (NGAP or NG-AP) 763 for the NG interface 113 defined between the NG-RAN node 111 and the AMF 321, or the AP 763 may be an Xn application protocol layer (XnAP or Xn-AP) 763 for the Xn interface 112 that is defined between two or more RAN nodes 111.

The NG-AP 763 may support the functions of the NG interface 113 and may comprise Elementary Procedures (EPs). An NG-AP EP may be a unit of interaction between the NG-RAN node 111 and the AMF 321. The NG-AP 763 services may comprise two groups: UE-associated services (e.g., services related to a UE 101) and non-UE-associated services (e.g., services related to the whole NG interface instance between the NG-RAN node 111 and AMF 321). These services may include functions including, but not limited to: a paging function for the sending of paging requests to NG-RAN nodes 111 involved in a particular paging area; a UE context management function for allowing the AMF 321 to establish, modify, and/or release a UE context in the AMF 321 and the NG-RAN node 111; a mobility function for UEs 101 in ECM-CONNECTED mode for intra-system HOs to support mobility within NG-RAN and inter-system HOs to support mobility from/to EPS systems; a NAS Signaling Transport function for transporting or rerouting NAS messages between UE 101 and AMF 321; a NAS node selection function for determining an association between the AMF 321 and the UE 101; NG interface management function(s) for setting up the NG interface and monitoring for errors over the NG interface; a warning message transmission function for providing means to transfer warning messages via NG interface or cancel ongoing broadcast of warning messages; a Configuration Transfer function for requesting and transferring of RAN configuration information (e.g., SON information, performance measurement (PM) data, etc.) between two RAN nodes 111 via CN 120; and/or other like functions.

The XnAP 763 may support the functions of the Xn interface 112 and may comprise XnAP basic mobility procedures and XnAP global procedures. The XnAP basic mobility procedures may comprise procedures used to handle UE mobility within the NG RAN 111 (or E-UTRAN 210), such as handover preparation and cancellation procedures, SN Status Transfer procedures, UE context retrieval and UE context release procedures, RAN paging procedures, dual connectivity related procedures, and the like. The XnAP global procedures may comprise procedures that are not related to a specific UE 101, such as Xn interface setup and reset procedures, NG-RAN update procedures, cell activation procedures, and the like.

In LTE implementations, the AP 763 may be an S1 Application Protocol layer (S1-AP) 763 for the S1 interface 113 defined between an E-UTRAN node 111 and an MME, or the AP 763 may be an X2 application protocol layer (X2AP or X2-AP) 763 for the X2 interface 112 that is defined between two or more E-UTRAN nodes 111.

The S1 Application Protocol layer (S1-AP) 763 may support the functions of the S1 interface, and similar to the NG-AP discussed previously, the S1-AP may comprise S1-AP EPs. An S1-AP EP may be a unit of interaction between the E-UTRAN node 111 and an MME 221 within an LTE CN 120. The S1-AP 763 services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The X2AP 763 may support the functions of the X2 interface 112 and may comprise X2AP basic mobility procedures and X2AP global procedures. The X2AP basic mobility procedures may comprise procedures used to handle UE mobility within the E-UTRAN 120, such as handover preparation and cancellation procedures, SN Status Transfer procedures, UE context retrieval and UE context release procedures, RAN paging procedures, dual connectivity related procedures, and the like. The X2AP global procedures may comprise procedures that are not related to a specific UE 101, such as X2 interface setup and reset procedures, load indication procedures, error indication procedures, cell activation procedures, and the like.

The SCTP layer (alternatively referred to as the SCTP/IP layer) 762 may provide guaranteed delivery of application layer messages (e.g., NGAP or XnAP messages in NR implementations, or S1-AP or X2AP messages in LTE implementations). The SCTP 762 may ensure reliable delivery of signaling messages between the RAN node 111 and the AMF 321/MME 221 based, in part, on the IP protocol, supported by the IP 761. The Internet Protocol layer (IP) 761 may be used to perform packet addressing and routing functionality. In some implementations the IP layer 761 may use point-to-point transmission to deliver and convey PDUs. In this regard, the RAN node 111 may comprise L2 and L1 layer communication links (e.g., wired or wireless) with the MME/AMF to exchange information.

In a second example, a user plane protocol stack may comprise, in order from highest layer to lowest layer, SDAP 747, PDCP 740, RLC 730, MAC 720, and PHY 710. The user plane protocol stack may be used for communication between the UE 101, the RAN node 111, and UPF 302 in NR implementations or an S-GW 222 and P-GW 223 in LTE implementations. In this example, upper layers 751 may be built on top of the SDAP 747, and may include a user datagram protocol (UDP) and IP security layer (UDP/IP) 752, a General Packet Radio Service (GPRS) Tunneling Protocol for the user plane layer (GTP-U) 753, and a User Plane PDU layer (UP PDU) 763.

The transport network layer 754 (also referred to as a “transport layer”) may be built on IP transport, and the GTP-U 753 may be used on top of the UDP/IP layer 752 (comprising a UDP layer and IP layer) to carry user plane PDUs (UP-PDUs). The IP layer (also referred to as the “Internet layer”) may be used to perform packet addressing and routing functionality. The IP layer may assign IP addresses to user data packets in any of IPv4, IPv6, or PPP formats, for example.

The GTP-U 753 may be used for carrying user data within the GPRS core network and between the radio access network and the core network. The user data transported can be packets in any of IPv4, IPv6, or PPP formats, for example. The UDP/IP 752 may provide checksums for data integrity, port numbers for addressing different functions at the source and destination, and encryption and authentication on the selected data flows. The RAN node 111 and the S-GW 222 may utilize an S1-U interface to exchange user plane data via a protocol stack comprising an L1 layer (e.g., PHY 710), an L2 layer (e.g., MAC 720, RLC 730, PDCP 740, and/or SDAP 747), the UDP/IP layer 752, and the GTP-U 753. The S-GW 222 and the P-GW 223 may utilize an S5/S8a interface to exchange user plane data via a protocol stack comprising an L1 layer, an L2 layer, the UDP/IP layer 752, and the GTP-U 753. As discussed previously, NAS protocols may support the mobility of the UE 101 and the session management procedures to establish and maintain IP connectivity between the UE 101 and the P-GW 223.

Moreover, although not shown by FIG. 7, an application layer may be present above the AP 763 and/or the transport network layer 754. The application layer may be a layer in which a user of the UE 101, RAN node 111, or other network element interacts with software applications being executed, for example, by application circuitry 405 or application circuitry 505, respectively. The application layer may also provide one or more interfaces for software applications to interact with communications systems of the UE 101 or RAN node 111, such as the baseband circuitry 6110. In some implementations the IP layer and/or the application layer may provide the same or similar functionality as layers 5-7, or portions thereof, of the Open Systems Interconnection (OSI) model (e.g., OSI Layer 7—the application layer, OSI Layer 6—the presentation layer, and OSI Layer 5—the session layer).

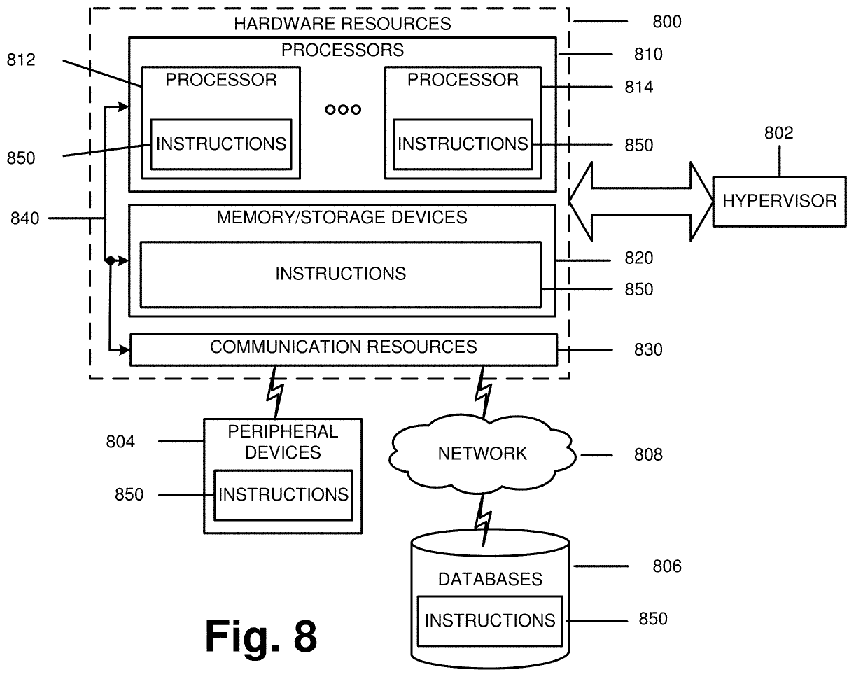

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processor(s) 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via USB), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

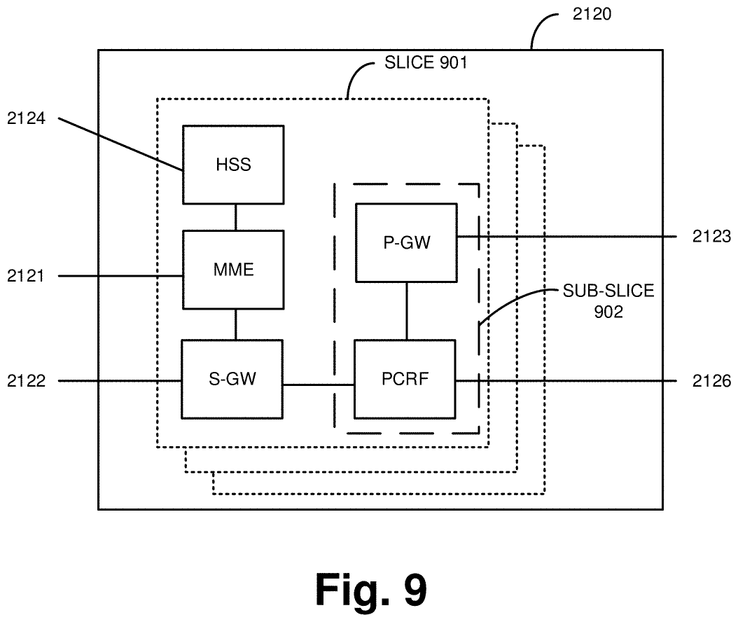

FIG. 9 illustrates components of a core network in accordance with various embodiments. The components of the CN XR120 may be implemented in one physical node or separate physical nodes including components to read and execute instructions from a machine-readable or computer-readable medium (e.g., a non-transitory machine-readable storage medium). In embodiments, the components of CN XR220 may be implemented in a same or similar manner as discussed herein with regard to the components of CN XR120. In some embodiments, NFV is utilized to virtualize any or all of the above-described network node functions via executable instructions stored in one or more computer-readable storage mediums (described in further detail below). A logical instantiation of the CN XR120 may be referred to as a network slice 901, and individual logical instantiations of the CN XR120 may provide specific network capabilities and network characteristics. A logical instantiation of a portion of the CN XR120 may be referred to as a network sub-slice 902 (e.g., the network sub-slice 902 is shown to include the P-GW XR123 and the PCRF XR126).

As used herein, the terms “instantiate,” “instantiation,” and the like may refer to the creation of an instance, and an “instance” may refer to a concrete occurrence of an object, which may occur, for example, during execution of program code. A network instance may refer to information identifying a domain, which may be used for traffic detection and routing in case of different IP domains or overlapping IP addresses. A network slice instance may refer to a set of network functions (NFs) instances and the resources (e.g., compute, storage, and networking resources) required to deploy the network slice.

With respect to 5G systems (see, e.g., FIG. 3), a network slice always comprises a RAN part and a CN part. The support of network slicing relies on the principle that traffic for different slices is handled by different PDU sessions. The network can realize the different network slices by scheduling and also by providing different L1/L2 configurations. The UE 2201 provides assistance information for network slice selection in an appropriate RRC message, if it has been provided by NAS. While the network can support large number of slices, the UE need not support more than 8 slices simultaneously.

A network slice may include the CN 2220 control plane and user plane NFs, NG-RANs 2210 in a serving PLMN, and a N3IWF functions in the serving PLMN. Individual network slices may have different S-NSSAI and/or may have different SSTs. NSSAI includes one or more S-NSSAIs, and each network slice is uniquely identified by an S-NSSAI. Network slices may differ for supported features and network functions optimizations, and/or multiple network slice instances may deliver the same service/features but for different groups of UEs 2201 (e.g., enterprise users). For example, individual network slices may deliver different committed service(s) and/or may be dedicated to a particular customer or enterprise. In this example, each network slice may have different S-NSSAIs with the same SST but with different slice differentiators. Additionally, a single UE may be served with one or more network slice instances simultaneously via a 5G AN and associated with eight different S-NSSAIs. Moreover, an AMF 2221 instance serving an individual UE 2201 may belong to each of the network slice instances serving that UE.

Network Slicing in the NG-RAN 2210 involves RAN slice awareness. RAN slice awareness includes differentiated handling of traffic for different network slices, which have been pre-configured. Slice awareness in the NG-RAN 2210 is introduced at the PDU session level by indicating the S-NSSAI corresponding to a PDU session in all signaling that includes PDU session resource information. How the NG-RAN 2210 supports the slice enabling in terms of NG-RAN functions (e.g., the set of network functions that comprise each slice) is implementation dependent. The NG-RAN 2210 selects the RAN part of the network slice using assistance information provided by the UE 2201 or the 5GC 2220, which unambiguously identifies one or more of the pre-configured network slices in the PLMN. The NG-RAN 2210 also supports resource management and policy enforcement between slices as per SLAs. A single NG-RAN node may support multiple slices, and the NG-RAN 2210 may also apply an appropriate RRM policy for the SLA in place to each supported slice. The NG-RAN 2210 may also support QoS differentiation within a slice.

The NG-RAN 2210 may also use the UE assistance information for the selection of an AMF 2221 during an initial attach, if available. The NG-RAN 2210 uses the assistance information for routing the initial NAS to an AMF 2221. If the NG-RAN 2210 is unable to select an AMF 2221 using the assistance information, or the UE 2201 does not provide any such information, the NG-RAN 2210 sends the NAS signaling to a default AMF 2221, which may be among a pool of AMFs 2221. For subsequent accesses, the UE 2201 provides a temp ID, which is assigned to the UE 2201 by the 5GC 2220, to enable the NG-RAN 2210 to route the NAS message to the appropriate AMF 2221 as long as the temp ID is valid. The NG-RAN 2210 is aware of, and can reach, the AMF 2221 that is associated with the temp ID. Otherwise, the method for initial attach applies.

The NG-RAN 2210 supports resource isolation between slices. NG-RAN 2210 resource isolation may be achieved by means of RRM policies and protection mechanisms that should avoid that shortage of shared resources if one slice breaks the service level agreement for another slice. In some implementations, it is possible to fully dedicate NG-RAN 2210 resources to a certain slice. How NG-RAN 2210 supports resource isolation is implementation dependent.

Some slices may be available only in part of the network. Awareness in the NG-RAN 2210 of the slices supported in the cells of its neighbors may be beneficial for inter-frequency mobility in connected mode. The slice availability may not change within the UE's registration area. The NG-RAN 2210 and the 5GC 2220 are responsible to handle a service request for a slice that may or may not be available in a given area. Admission or rejection of access to a slice may depend on factors such as support for the slice, availability of resources, support of the requested service by NG-RAN 2210.

The UE 2201 may be associated with multiple network slices simultaneously. In case the UE 2201 is associated with multiple slices simultaneously, only one signaling connection is maintained, and for intra-frequency cell reselection, the UE 2201 tries to camp on the best cell. For inter-frequency cell reselection, dedicated priorities can be used to control the frequency on which the UE 2201 camps. The 5GC 2220 is to validate that the UE 2201 has the rights to access a network slice. Prior to receiving an Initial Context Setup Request message, the NG-RAN 2210 may be allowed to apply some provisional/local policies, based on awareness of a particular slice that the UE 2201 is requesting to access. During the initial context setup, the NG-RAN 2210 is informed of the slice for which resources are being requested.

NFV architectures and infrastructures may be used to virtualize one or more NFs, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding Figures may be configured to operate in accordance with one or more of the examples set forth below. For another example, circuitry associated with a UE, base station, network element, etc. as described above in connection with one or more of the preceding Figures may be configured to operate in accordance with one or more of the examples set forth below in the example section.

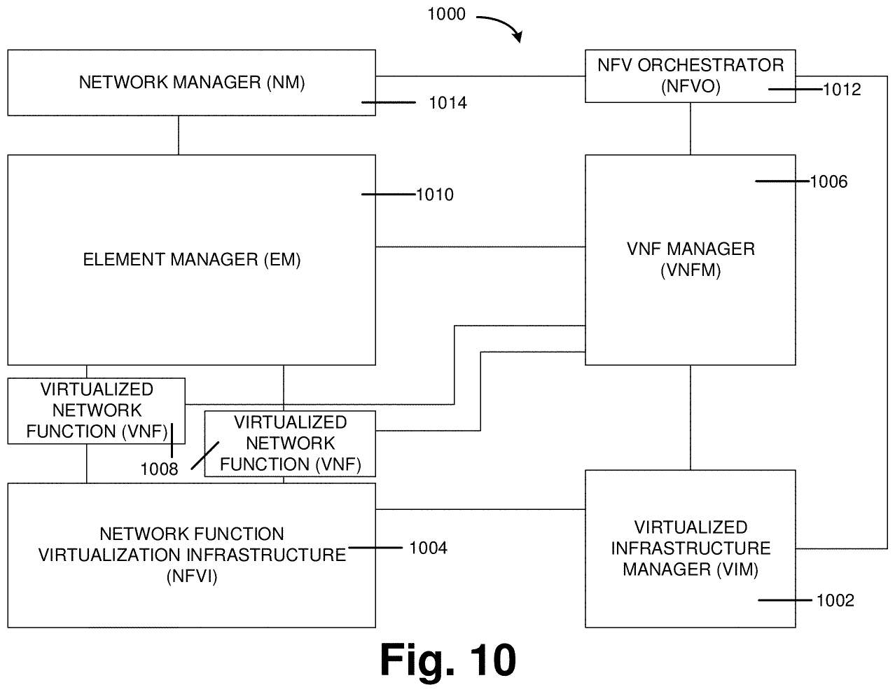

FIG. 10 is a block diagram illustrating components, according to some example embodiments, of a system 1000 to support NFV. The system 1000 is illustrated as including a VIM 1002, an NFVI 1004, an VNFM 1006, VNFs 1008, an EM 1010, an NFVO 1012, and a NM 1014.

The VIM 1002 manages the resources of the NFVI 1004. The NFVI 1004 can include physical or virtual resources and applications (including hypervisors) used to execute the system 1000. The VIM 1002 may manage the life cycle of virtual resources with the NFVI 1004 (e.g., creation, maintenance, and tear down of VMs associated with one or more physical resources), track VM instances, track performance, fault and security of VM instances and associated physical resources, and expose VM instances and associated physical resources to other management systems.

The VNFM 1006 may manage the VNFs 1008. The VNFs 1008 may be used to execute EPC components/functions. The VNFM 1006 may manage the life cycle of the VNFs 1008 and track performance, fault and security of the virtual aspects of VNFs 1008. The EM 1010 may track the performance, fault and security of the functional aspects of VNFs 1008. The tracking data from the VNFM 1006 and the EM 1010 may comprise, for example, PM data used by the VIM 1002 or the NFVI 1004. Both the VNFM 1006 and the EM 1010 can scale up/down the quantity of VNFs of the system 1000.

The NFVO 1012 may coordinate, authorize, release and engage resources of the NFVI 1004 in order to provide the requested service (e.g., to execute an EPC function, component, or slice). The NM 1014 may provide a package of end-user functions with the responsibility for the management of a network, which may include network elements with VNFs, non-virtualized network functions, or both (management of the VNFs may occur via the EM 1010).

NFV Management and Orchestration (MANO) Architecture

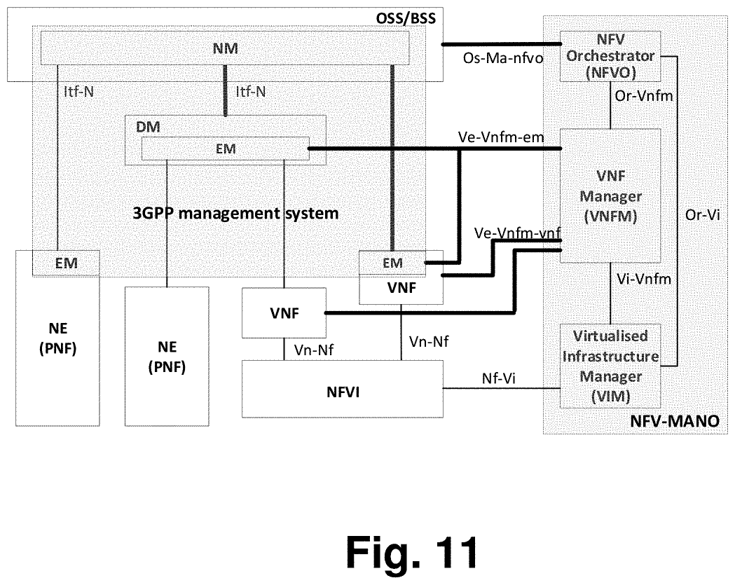

FIG. 11 depicts an example management architecture of mobile networks that include virtualized network functions. The management architecture of FIG. 11 is a 3GPP management and ETSI NFV Management and Orchestration (MANO) architecture. The 3GPP management system of FIG. 11 is based on 4G networks, but aspects of the management system may be applicable to 5G networks.

The mobile network comprises physical and virtualized network elements. Application-specific aspects of both VNFs and PNFs, corresponding to physical NEs, are managed by the 3GPP management system.

In FIG. 11, the Itf-N is an interface between the NM and the DM/EM, the Os-Ma-nfvo is the reference point between the OSS/BSS (e.g., the NM) and the NFVO, the Ve-Vnfm-em is the reference point between the EM and the VNFM, and the Ve-Vnfm-vnf is the reference point between the VNF and the VNFM.

The NFVI comprises hardware and software components that together provide the infrastructure resources where VNFs are deployed. The infrastructure resources contain the hardware resources, virtualization layer software and the virtualized resources which the VNF relies on. NFVI resources under consideration are both virtualised and non-virtualised resources, supporting virtualised network functions and partially virtualised network functions.

Virtualised resources in-scope are those that can be associated with virtualisation containers, and have been catalogued and offered for consumption through appropriately abstracted services, for example, compute including machines (e.g. hosts or bare metal), and virtual machines, as resources that comprise both CPU and memory; storage, including: volumes of storage at either block or file-system level; and network, including: networks, subnets, ports, addresses, links and forwarding rules, for the purpose of ensuring intra- and inter-VNF connectivity.

The NM plays one of the roles of OSS/BSS and is the consumer of reference point Os-Ma-nfvo. The NM provides the functions for the management of mobile network which includes virtualized network functions. The NM supports FCAPS management functions of the mobile network (e.g. IMS, EPC, 5GS, etc.) and 3GPP service (e.g. data service, voice service) and supports the management of mobile network lifecycle. NM initiates the lifecycle management of ETSI-defined NS and VNF, which are related to mobile network, through interaction with NFV-MANO. The NM provides a package of end-user functions with the responsibility for the management of a network, which may include network elements with VNFs, non-virtualized network functions, or both (management of the VNFs may occur via the EM).

The EM and/or DM is responsible for FCAPS management functionality for VNFs on an application level and physical NE on a domain and element level. This mainly includes: fault management for VNFs and physical NEs; configuration management for VNF and physical NE; accounting management for VNFs and physical NEs; performance measurement and collection for VNF and physical NE; and security management for VNF and physical NEs. The EM/DM participates in lifecycle management functionality for a VNF, such as by requesting a lifecycle management operation for a VNF to VNFM, and exchanging information regarding the VNF and Virtualized Resources associated with the VNF. The DM/EM (including EM extended functionality) can manage both PNF(s) and VNF(s). The tracking of data from the VNFM and the EM may comprise, for example, PM data used by the VIM or the NFVI. Both the VNFM and the EM The tracking data from the VNFM XY06 and the EM XY10 may comprise, for example, PM data used by the VIM XY02 or the NFVI XY04. Both the VNFM XY06 and the EM XY10 can scale up/down the quantity of VNFs of the system XY00. can scale up/down the quantity of VNFs of the system.

The NFV-MANO comprises an NFV Orchestrator (NFVO), VNF Manager (VNFM), and VIM. The NFVO and VNFM share interfaces with the NM, DM/EM and VNF. The NFVO is responsible for the orchestration of NFVI resources across multiple VIMs, fulfilling the Resource Orchestration functions, and the lifecycle management of Network Services, fulfilling the Network Service Orchestration functions. The NFVO coordinates, authorizes, releases, and engages resources of the NFVI in order to provide the requested service(s) (e.g., to execute an NF, AF, component, and/or slice).

The management and orchestration of virtualised resources including handing NFVI resources (e.g. in NFVI Nodes), in NFVI Points of Presence (NFVI-PoPs). Management of non-virtualised resources is restricted to provisioning connectivity to PNFs, necessary when a NS instance includes a PNF that needs to connect to a VNF, or when the NS instance is distributed across multiple NFVI-PoPs or N-PoPs.

The virtualised resources are leveraged for providing VNFs with the resources they need. Resource allocation in the NFVI is a potentially complex task because a lot of requirements and constraints may need to be met at the same time. Particularly requirements for network allocation add new complexity compared to known resource allocation strategies for computing resources in virtualised environments. For example, some VNFs require low latency or high bandwidth links to other communication endpoints.

Allocation and release of resources is a dynamic process, in response to consumption of those services by other functions. While the management and orchestrations function for virtualised infrastructure are VNF-unaware, resource allocations and releases may be needed throughout the VNF lifetime. An advantage of NFV is that with increasing load VNFs can dynamically consume services that allocate additional resource when scaling-out is triggered.

Services exposing virtualised resources include (non-exhaustive list): discovery of available services; management of virtualised resources availability/allocation/release; and virtualised resource fault/performance management.

In the case of virtualised resources distributed across multiple NFVI-PoPs, those services could either be exposed directly by the management and orchestration functions for each individual NFVI-PoP, or via a higher-level service abstraction presenting the virtualised resources across multiple NFVI-PoPs. Both types of services could be exposed to the consuming functions. In the case of the higher level service abstraction previously mentioned, the management and orchestration of virtualised resources and non-virtualised networking resources across those NFVI-PoPs falls under the responsibility of the management and orchestration of the virtualised infrastructure that may in turn use the services exposed directly by the management and orchestration functions of a single or across multiple NFVI-PoPs. In order to provide those services, the management and orchestration of the virtualised infrastructure consumes services provided by the NFVI.

The NFV management and orchestration functions that coordinate virtualised resources in a single NFVI-PoP and/or across multiple NFVI-PoPs need to ensure exposure of services that support accessing these resources in an open, well known abstracted manner. These services can be consumed by other authenticated and properly authorized NFV management and orchestration functions (e.g. functions that manage and orchestrate virtualised network functions).

Network Service Lifecycle management includes, inter alia, on-boarding Network Service, e.g. register a Network Service in the catalogue and ensure that all the templates describing the NS are on-boarded; instantiating Network Service, e.g. create a Network Service using the NS on-boarding artefacts; scaling Network Service, e.g. grow or reduce the capacity of the Network Service; updating Network Service by supporting Network Service configuration changes of various complexity such as changing inter-VNF connectivity or the constituent VNF instances. Performing create, delete, query, and update procedures for VNFFGs associated to a Network Service; and terminating Network Services, e.g. request the termination of constituent VNF instances, request the release of NFVI resources associated to NSs, and return them to NFVI resource pool if applicable.

The deployment and operational behaviour requirements of each Network Service is captured in a deployment template, and stored during the Network Service on-boarding process in a catalogue, for future selection for instantiation. The deployment template fully describes the attributes and requirements necessary to realize such a Network Service. Network Service Orchestration coordinates the lifecycle of VNFs that jointly realize a Network Service. This includes (not limited to) managing the associations between different VNFs, and when applicable between VNFs and PNFs, the topology of the Network Service, and the VNFFGs associated with the Network Service.

During the Network Service lifecycle, the Network Service Orchestration functions may monitor KPIs of a Network Service if such requirements were captured in the deployment template, and may report this information to support explicit request for such operations from other functions.

The Network Service Orchestration performs its services by using the VNF Management services and by orchestrating the NFV Infrastructure that supports the interconnection between VNFs functionality, and its functions are exposed in an open, well known abstracted manner as services to other functions. In order to fulfil its responsibilities, the Network Service Orchestration functions consume services exposed by other functions (e.g. Virtualised Infrastructure Management functions).

The services provided by Network Service Orchestration can be consumed by authenticated and properly authorized other functions (e.g. OSS, BSS).

The VNFM is responsible for the lifecycle management of VNF instances. Each VNF instance is assumed to have an associated VNF Manager. The VNF manager may be assigned the management of a single VNF instance, or the management of multiple VNF instances of the same type or of different types.

Most of the VNFM functions are assumed to be generic common functions applicable to any type of VNF. However, the NFV-MANO architectural framework needs to also support cases where VNF instances need specific functionality for their lifecycle management, and such functionality may be specified in the VNF Package.

The VNFs are used to execute EPC/5GC components/functions. The VNFs are configured to perform VNF instantiation, including VNF configuration if required by the VNF deployment template (e.g. VNF initial configuration with IP addresses before completion of the VNF instantiation operation); VNF instantiation feasibility checking; VNF instance software update/upgrade; VNF instance modification; VNF instance scaling out/in and up/down; VNF instance-related collection of NFVI performance measurement results and faults/events information, and correlation to VNF instance-related events/faults; VNF instance assisted or automated healing; VNF instance termination; VNF lifecycle management change notification; management of the integrity of the VNF instance through its lifecycle; and overall coordination and adaptation role for configuration and event reporting between the VIM and the EM. The aforementioned functionalities may be exposed by means of interfaces and consumed by other NFV-MANO functional blocks or by authorised external entities:

The deployment and operational behaviour of each VNF is captured in a template called Virtualised Network Function Descriptor (VNFD) that is stored in the VNF catalogue. NFV-MANO uses a VNFD to create instances of the VNF it represents, and to manage the lifecycle of those instances. A VNFD has a one-to-one correspondence with a VNF Package, and it fully describes the attributes and requirements necessary to realize such a VNF. NFVI resources are assigned to a VNF based on the requirements captured in the VNFD (containing resource allocation criteria, among others), but also taking into consideration specific requirements, constraints, and policies that have been pre-provisioned or are accompanying the request for instantiation and may override certain requirements in the VNFD (e.g. operator policies, geo-location placement, affinity/anti-affinity rules, local regulations).

The information elements to be handled by the NFV-MANO, including the VNFD among others, need to guarantee the flexible deployment and portability of VNF instances on multi-vendor and diverse NFVI environments, e.g. with diverse computing resource generations, diverse virtual network technologies, etc. To achieve this, hardware resources need to be properly abstracted and the VNF requirements be described in terms of such abstraction.

The VNFM has access to a repository of available VNF Packages and different versions of them, all represented via their associated VNFDs. Different versions of a VNF Package may correspond to different implementations of the same function, different versions to run in different execution environments (e.g. on different hypervisors, dependent on NFVI resources availability information, etc.), or different release versions of the same software. The repository may be maintained by the NFVO or another external entity.

The Virtualised Infrastructure Manager (VIM) is responsible for controlling and managing the NFVI resources (e.g., compute, storage and network resources) usually within one operator's Infrastructure Domain (e.g. all resources within an NFVI-PoP, resources across multiple NFVI-POPS, or a subset of resources within an NFVI-PoP) as discussed previously. The VIM manages the life cycle of virtual resources with the NFVI (e.g., creation, maintenance, and tear down of VMs associated with one or more physical resources), tracks VM instances, tracks performance, fault, and security of VM instances and associated physical resources, and exposes VM instances and associated physical resources to other management systems. The VIM may be specialized in handling a certain type of NFVI resources (e.g. compute-only, storage-only, networking-only), or may be capable of managing multiple types of NFVI resources (e.g. in NFVI-Nodes).

The southbound interfaces interface with a variety of hypervisors and Network Controllers in order to perform the functionality exposed through its northbound interfaces. Other VIM implementations may directly expose the interfaces exposed by such compute, storage, Network Controllers as specialized VIMs. A particular example of a specialized VIM is a WAN Infrastructure Manager (WIM), typically used to establish connectivity between PNF endpoints in different NFVI-PoPs. The VIM implementation is out of scope for NFV-MANO; however the interfaces exposed by VIMs are in-scope.

The VIM is configured to:
orchestrate the allocation/upgrade/release/reclamation of NFVI resources (including the optimization of such resources usage), and manage the association of the virtualised resources to the physical compute, storage, networking resources, wherein the VIM keeps an inventory of the allocation of virtual resources to physical resources, e.g. to a server pool and/or the like;
support the management of VNF Forwarding Graphs (create, query, update, delete), e.g. by creating and maintaining Virtual Links, virtual networks, sub-nets, and ports, as well as the management of security group policies to ensure network/traffic access control;
manage, in a repository, inventory related information of NFVI hardware resources (e.g., compute, storage, networking) and software resources (e.g. hypervisors), and discovery of the capabilities and features (e.g. related to usage optimization) of such resources; manage the virtualised resource capacity (e.g. density of virtualised resources to physical resources), and forwarding of information related to NFVI resources capacity and usage reporting; manage software images (add, delete, update, query, copy) as requested by other NFV-MANO functional blocks (e.g. NFVO)—the VIM maintains repositories for software images, in order to streamline the allocation of virtualised computing resources, and a validation step, performed by VIM, is required for software images before storing the image (e.g. VNF package on-boarding and update). Image validation operations during run-time, e.g. during instantiation or scaling, are outside the scope of the current version of the present document;
collect performance and fault information (e.g. via notifications) of hardware resources (compute, storage, and networking) software resources (e.g. hypervisors), and virtualised resources (e.g. VMs); and forwarding of performance measurement results and faults/events information relative to virtualised resources; and
manage catalogues of virtualised resources that can be consumed from the NFVI. The elements in the catalogue may be in the form of virtualised resource configurations (virtual CPU configurations, types of network connectivity (e.g. L2, L3), etc.), and/or templates (e.g. a virtual machine with 2 virtual CPUs and 2 GB of virtual memory).

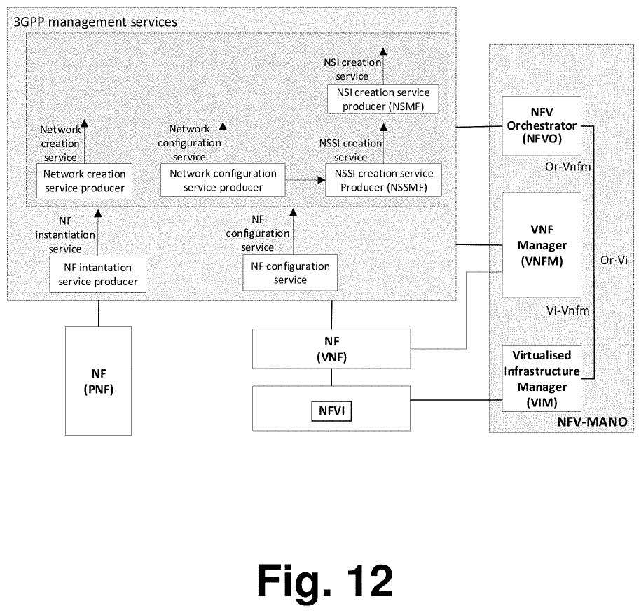

FIG. 12 depicts another example of a management services architecture. Note: the management services (e.g., NF instantiation services) may be named differently than as shown by FIGS. 11 and 12, the name of the management services are not the focus of the present embodiments; the present disclosure is related to the functionality of the management services.

In the examples of FIGS. 11 and/or 12, the NF instantiation service producer may provide a management service to a consumer, by receiving a request from a consumer to instantiate a 3GPP NF; checking whether the VNF package(s) of the VNF(s) realizing the virtualized part of the 3GPP NF have been on-boarded to the NFV MANO system, and on-boarding the VNF package(s) that have not been on-boarded yet; interacting with the NFV MANO system to instantiate the VNF(s) that are realizing the virtualized part of subject 3GPP NF; informing the consumer that the 3GPP NF has been instantiated; and creating the Managed Object Instances (MOIs) for the subject 3GPP NF.

The NF configuration service producer may provide management services to a consumer, by receiving a request from a consumer to configure a 3GPP NF instance; configuring the 3GPP NF instance; and informing the consumer that the 3GPP NF instance has been configured. The request from the consumer to configure a 3GPP NF instance may include a request to create the MOI(s) for the 3GPP NF. The request from the consumer to configure the 3GPP NF instance may be a MOI attribute modification request. Configuring the 3GPP NF instance may include interaction with the ETSI NFV MANO system to update the corresponding VNF instance(s) realizing the virtualized part of the 3GPP NF.

The network creation service producer may provide management services to a consumer, by receiving a request from a consumer to create a 3GPP network; preparing the NSD(s) for the NS(s) that are to realize the requested 3GPP network, and on-boarding the NSD(s) to ETSI NFV MANO system; on-boarding the VNF package(s) of the constituent VNFs to ETSI NFV MANO system, if the VNF package has not yet been on-boarded; interacting with ETSI NFV MANO system to instantiate the NS(s); consuming a management service to configure the 3GPP NF instance(s) that are constituting the subject 3GPP network; and creating the MOI(s) for the created network. The interaction with the ETSI NFV MANO system to instantiate the NS(s) may include the instantiation of constitute (constituent VNFs). The ETSI NFV MANO system may inform the management service producer about the instantiation of VNFs. The management service producer may create the MOI(s) for the newly instantiated VNFs, and may provide the NF configuration service. Additionally, the management service being consumed to configure the 3GPP NF instance(s) may be the NF configuration service.

The network configuration service producer may provide management services to a consumer, by receiving a request from a consumer to configure a 3GPP network; configuring the 3GPP network; and informing the consumer that the 3GPP network has been configured. The request from the consumer to configure a 3GPP network includes a request to create the MOI(s) for the 3GPP network, and the request from the consumer to configure a 3GPP network is a MOI attribute modification request. Configuring the 3GPP network further may include interaction with the ETSI NFV MANO system to update the corresponding NS instance(s) realizing (fully or partially) the 3GPP network. The interaction with the ETSI NFV MANO system to update the NS(s) may include the instantiation of new VNFs. The ETSI NFV MANO system may inform a management service producer about the instantiation of VNFs. The management service producer may create the MOI(s) for the newly instantiated VNFs, and the management service producer may provide the NF configuration service. In addition, configuring the 3GPP network further includes configuring the 3GPP NFs, and configuring the 3GPP NFs may be via consuming the management service for NF configuration.

The NSSI creation service producer (NSSMF) may create a NSSI for a consumer, by consuming a management service to configure the 3GPP network; and/or consuming a management service to configure the 3GPP NF(s). The management service consumed to configure the 3GPP network may be a network configuration service, and the management service consumed to configure the 3GPP NF(s) may be an NF configuration service.

Management Services

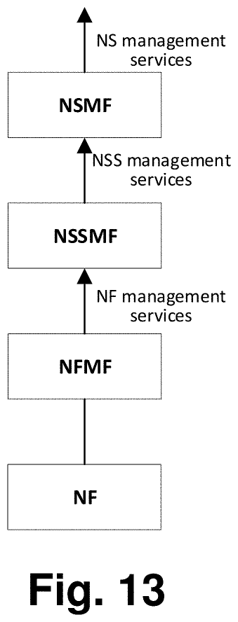

5G management is based on Service Based Architecture (SBA) where each management function is a producer that produces management services to be consumed by other management functions. FIG. 13 shows an example of 5G management services. A management service offers management capabilities. These management capabilities are accessed by management service consumers via a standardized service interface composed of individually specified management service components.

In FIG. 13, the NFMF provides NF management services to the NSSMF; the NSSMF consumes NF management services to provide NSS management services to NSMF; and the NSMF consumes NSSMF management services to provide NS management services to other management entity.

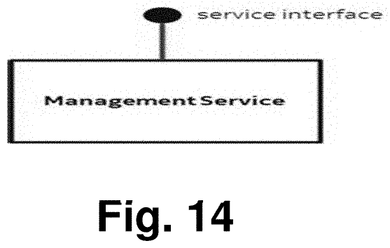

A management service offers management capabilities. These management capabilities are accessed by management service consumers via standardized service interface composed of individually specified management service components. An example is shown by FIG. 14.

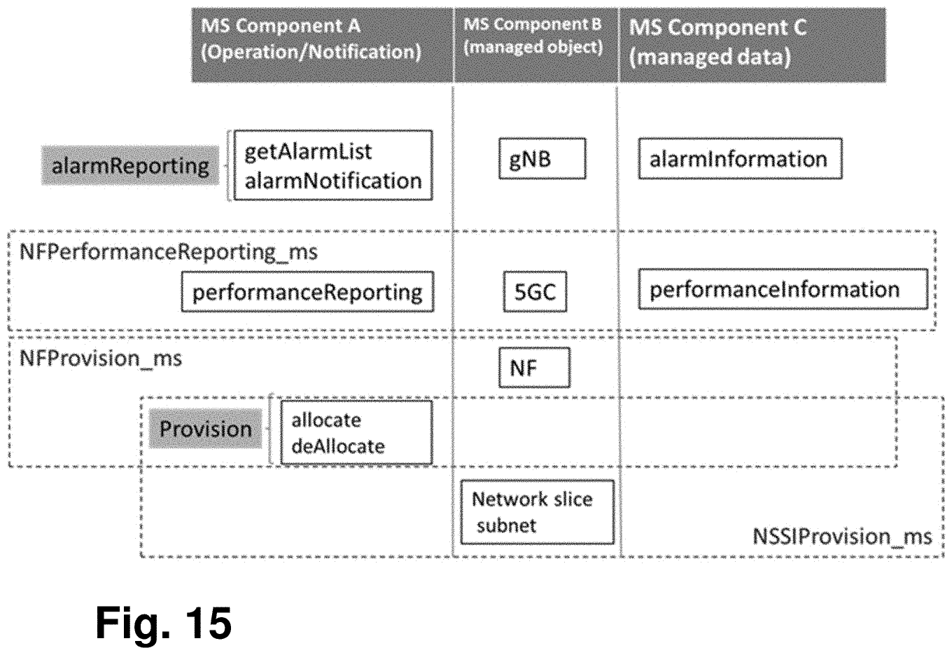

A management service may include a management service component type A and management service component type B; a management service component type A, management service component type B, and management service component type C; or any combination of management component types A, B, and/or C. An example of management service and related management service component type A, type B and type C is shown by FIG. 15.

MS-3. Management Service Components

A management service combines elements of management service component type A, B and C. The management service components are combined to allow a management service consumer to interact with a management service producer via a specified service interface.

MS-3.1. Management Service Component Type A

Management service component type A is a group of management operations and/or notifications agnostic of managed entities.

MS-3.2. Management Information

MS-3.2.1. Management Service Component Type B:

Management service component type B is the management information represented by information model of managed entities.

Management service component type B includes the following models:
1) Network resource model for NG-RAN and NR as defined in TS 28.541.
2) Network resource model for 5GC as defined in TS 28.543.
3) Network slice information model as defined in TS 28.532.
4) Network slice subnet information model as defined in TS 28.532.

In embodiments, additional other models belong to type B is to be added later.

MS-3.2.2. Management Service Component Type C:

Management service component type C is performance information of the managed entity and fault information of the managed entity.

Management service component type C includes the following information:
1. Alarm information as defined in TS 28.546.
2. Performance data as defined in TS 28.552, 28.553, 28.554, and 32.425.

In embodiments, management service component type C could be merged with Management service component type B. Mechanisms for collecting Minimization Drive Test (MDT) data may also be included. Additionally, more management information belonging to type C is to be added later.

MS-3.3. Management Capability Exposure Governance

Management capability exposure governance provides exposure governance on basic elements of management function service based interface:
1) Management service component type A
2) Management service component type B
3) Management service component type C

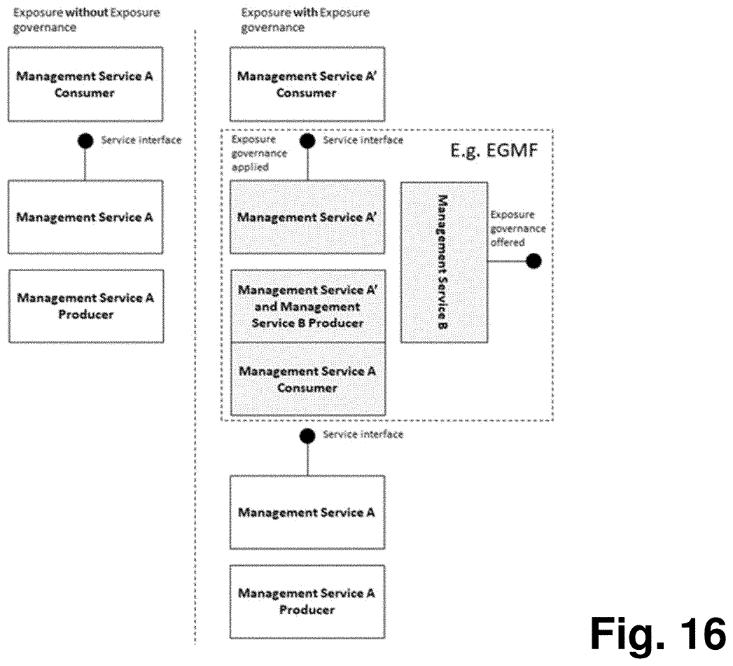

As shown by FIG. 16, when there is a Management Service A exposure without exposure governance, Management Service A′ Consumer can access all management capability offered by Management Service A′ Producer. When Management Service A is exposed with applied exposure governance it becomes Management Service A′. Management Service A′ Consumer can access Management Service A′ after following steps:
Management Service A, exposed by Management Service A′ Producer, is consumed by Management Service A′ Consumer;
Management Service B, exposed by Management Service B Producer, is consumed by Operator who applies exposure governance on exposed Management Service A
Management Service A′ Producer produces Management Service A

The Management Service A′ Consumer, that consumes Management Service A, the Management Service B and Management Service A′ Producer, that produces Management Service B (with management capability exposure governance) and Management Service A, can be represented as one management function entity (e.g., EGMF).

MS-3.4. Management Function (MF) Concept

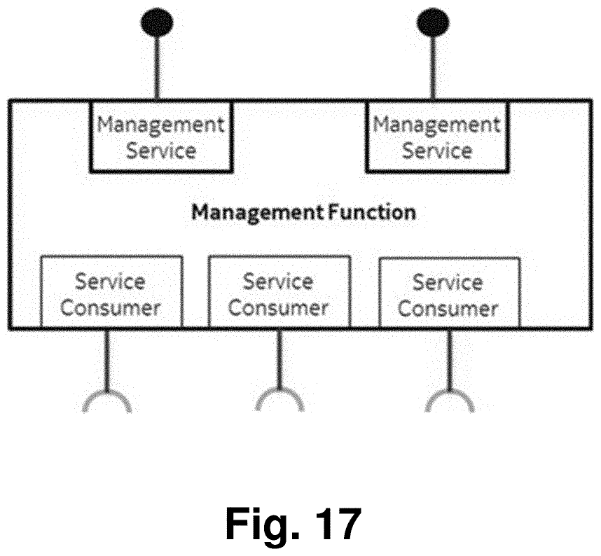

The Management Function (MF) is a management entity whose externally-observable behaviour and interfaces are specified by 3GPP. In the service-based management architecture, MF plays the role of either Management Service producer or Management Service consumer. A Management Service produced by MF may have multiple consumers. The MF may consume multiple Management Services from one or multiple Management Service producers. An example of an MF playing both roles (Management Service producer and consumer) is illustrated by FIG. 17.

Management Functions may interact by consuming Management Services produced by other Management Functions. FIG. 17 illustrates multiple scenarios, including: MF1 produces Management Service MnS-a; MF2 consumes Management Service MnS-a produced by MF1 and produces Management Services MnS-b and MnS-c; MF3 produces Management Service MnS-c; MF4 consumes Management Service MnS-b produced by the MF2; and MF5 consumes Management Services MnS-c produced by the MF2 and MF3, and in turn produces the same Management Service MnS-c. The behaviour of MF5 may be seen as aggregation of Management Services MnS-c.

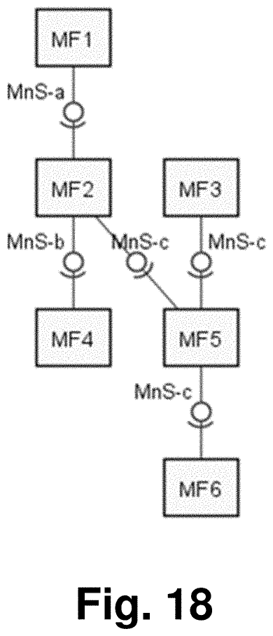

FIG. 18 illustrates multiple scenarios, including: MF1 produces Management Service MnS-a; MF2 consumes Management Service MnS-a produced by MF1 and produces Management Services MnS-b and MnS-c; MF3 produces Management Service MnS-c; MF4 consumes Management Service MnS-b produced by the MF2; MF5 consumes Management Services MnS-c produced by the MF2 and MF3, and in turn produces the same Management Service MnS-c. The behaviour of MF5 may be seen as aggregation of Management Services MnS-c.

MS-3.5 Management Data Analytics Capability

Mobile networks have the capability to support a variety of services, increasing flexibility of the network may cause management challenges.

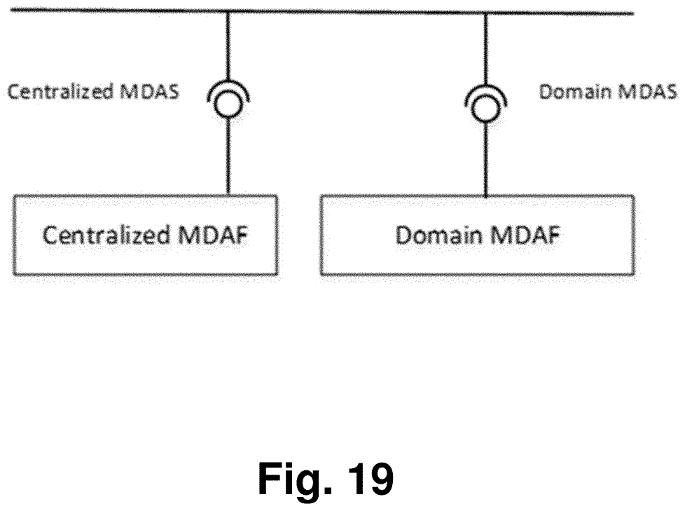

FIG. 19 shows a service based architecture for management data analytics. The raw performance data of NFs of the mobile network can be analysed, together with other management data (e.g., alarm information, configuration data), and formed into one or more MDA for NFs, sub-networks, NSSIs or NSIs. The MDA can be used to diagnose ongoing issues impacting the performance of the mobile network and predict any potential issues (e.g., potential failure and/or performance degradation). For example, the analysis of NSI/NSSI resource usage can form a management analytical data indicating whether a certain resource is deteriorating. The analysis and correlation of the overall performance data of mobile network may indicate overload situation and potential failure(s). SON Capacity and Coverage Optimization (CCO) is one typical case that may consume the management analytical data. CCO provides optimal coverage and capacity for the E-UTRAN (see e.g., clause 4.5 of 3GPP TS 28.628), which may also be applicable for 5G radio networks. The management analytical data related to coverage and capacity help the SON CCO to realise the situation of coverage and capacity or interference, and to trigger corresponding optimization if needed.

The management system can benefit from MDAS to make the mobile network more efficient in responding to various requests. The MDA utilize the network management data collected from the network and make the corresponding analytics based on the collected information. For example, the information provided by PM data analytics services can be used to optimize network performance, and the information provided by FM data analytics services can be used to predict and prevent failures of the network. For mobile networks with slicing, a network slice data analytics service can consume performance measurements and fault measurements data for its constituent network slice subnets.

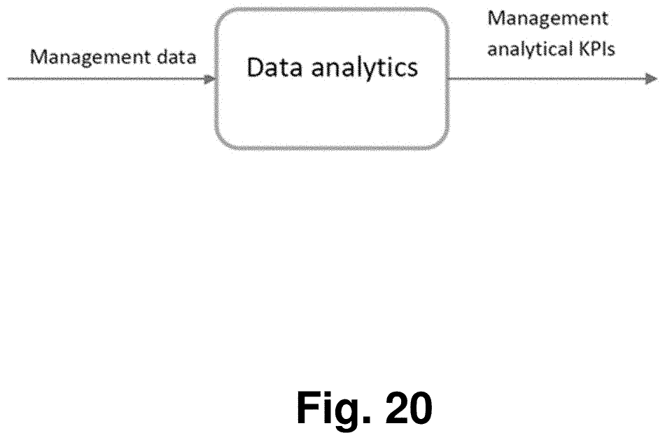

The MDAS can be used for NF(s), NSSI(s), NSI(s) and Subnetwork(s)/network(s). The MDAS comprises an MDAS producer that analyzes management data (e.g., performance measurements, alarm information, and configuration information, etc.) of the NF(s), NSSI(s), NSI(s) and Subnetwork(s)/network(s) and provides management data analytical KPIs. An example of such an MDAS is shown by FIG. 20.

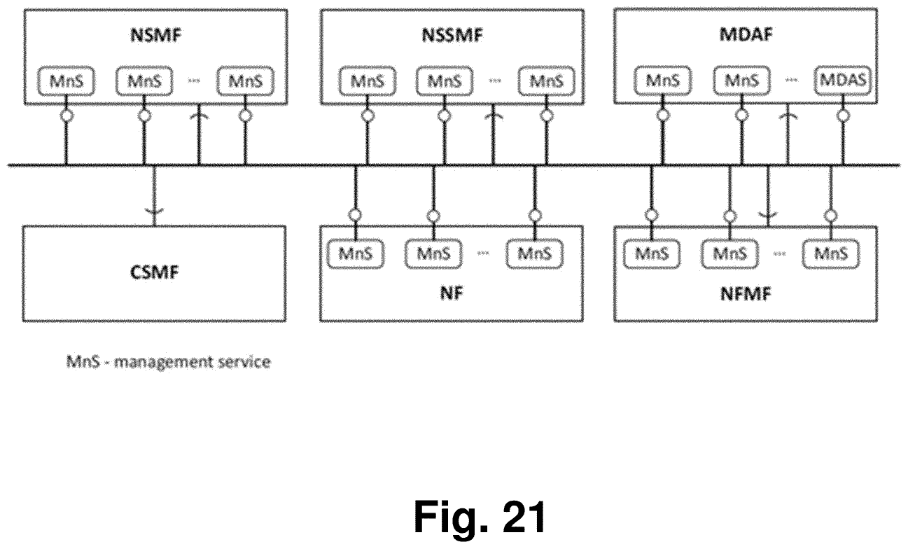

FIG. 21 shows an example of an MDAS being provided by a Management Data Analytics Function (MDAF), which is/are consumed by other management functions. The management services for a mobile network including network slicing may be produced by a set of functional blocks. This annex shows an example of such deployment scenario where functional blocks (e.g., NSMF, NSSMF, NFMF and CSMF) are producing and consuming various management services.

In this deployment example of FIG. 21, the NFMF provides the management services for one or more NF and may consume some management services produced by other functional blocks. The NF provides some management services, for example the NF performance management services, NF configuration management services and NF fault supervision services. NSSMF provides the management services for one or more NSSI and may consume some management services produced by other functional blocks. NSMF provides the management services for one or more NSI and may consume some management services produced by other functional blocks. The MDAF provides the MDAS for one or more NF, NSSI and/or NSI, and may consume some management services produced by other functional blocks, and the CSMF consumes the management service(s) provided by the other functional blocks. This deployment example does not illustrate what management services the CSMF consumes. In this example, one functional block may consume the management service(s) provided by another functional block, depending on the management scope of the functional block(s). The scope may be expressed in the terms of Management Service Components (see e.g., section 13 supra).

However, the concrete MDA KPIs have not been defined yet. Embodiments herein define the MDA KPIs for prediction of traffic volume, resource utilization tendency, and indication of the RAN condition(s). The MDAS is relied on big data technologies and is one essential step of adopting AI (Artificial Intelligence) in telecommunications.

MS-3.6. Utilization of Management Data Analytics Services

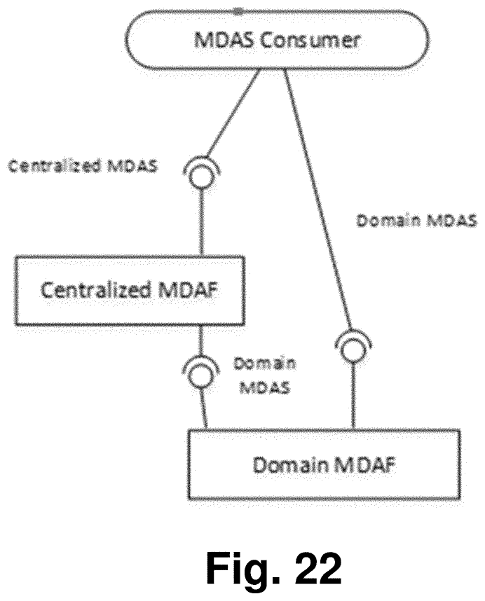

MDAS can be deployed at different levels, for example, at domain level (e.g., RAN, CN, NSSI) or in a centralized manner (e.g., in a PLMN level). A domain-level MDAS provides domain specific analytics, e.g., resource usage prediction in a CN or failure prediction in a NSSI, etc. A centralized MDAS can provide end-to-end or cross-domain analytics service, e.g., resource usage or failure prediction in an NSI, optimal CN node placement for ensuring lowest latency in the connected RAN, etc. FIG. 22 illustrates an example of deployment model of the MDAS.

In the example of FIG. 22, the Domain MDAF produces domain MDAS. The domain MDAS is consumed by the Centralized MDAF and other authorized MDAS Consumers (for example, infrastructure manager, network manager, slice manager, slice subnet manger, other 3rd party OSS, etc.). The Centralized MDAF produces centralized MDAS, which is consumed by different authorized MDAS Consumers.

MS-3.7. Management Data Analytics Service and SON Functions

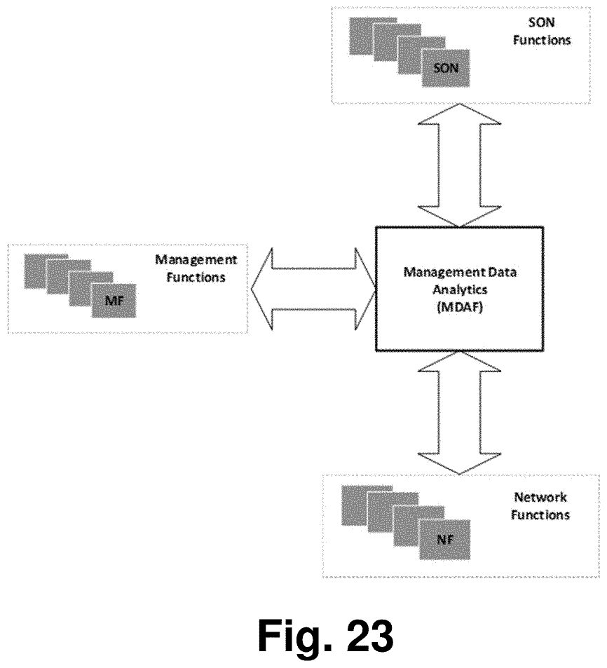

MDA for 5G networks has been defined in [ms1] and is also discussed in [ms2] and [ms3]. It utilizes both management and network data collected through management services and from network functions (including e.g. service, slicing and/or network functions related data) and makes the corresponding analytics based on the collected information. These analytics services (e.g., MDAS) can be made available and consumed by other management and SON functions. FIG. 23 gives a high level illustration of potential interaction and utilisation of the MDAS.

Therefore, it may be important that the following concept is observed and considered for the development of use cases and requirements: SON functions may utilise the services provided by the management data analytics (e.g., MDAS) to conduct their functionalities and control actions. Other potential interactions between the entities are not shown in the diagram in FIG. 23.

The components of FIGS. 1-23 may be used in any of the embodiments described herein, as will be explained in further detail in relation to FIGS. 24-29 below.

5G NF Performance Measurements Generation Method

FIG. 24 shows an example of 5G NF performance measurements generation architecture 2400 according to various embodiments. In FIG. 24, a service producer collects the raw performance measurements from various NFs, NF1 and NF2, and then generates performance measurements based one the raw performance measurements for its consumers.

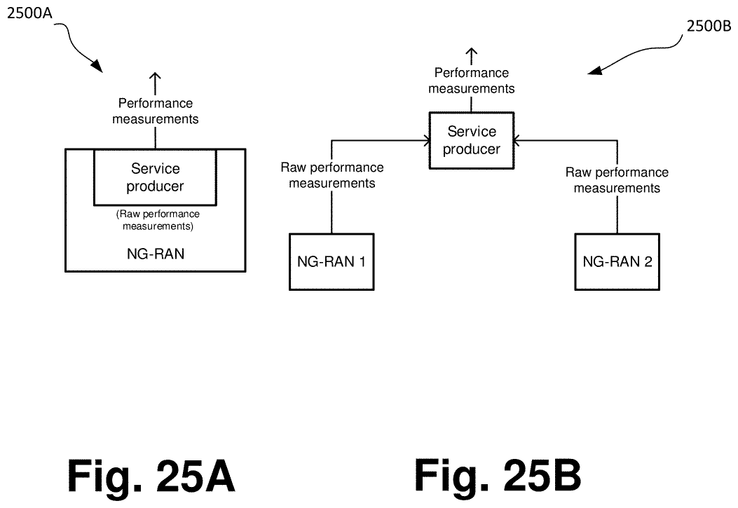

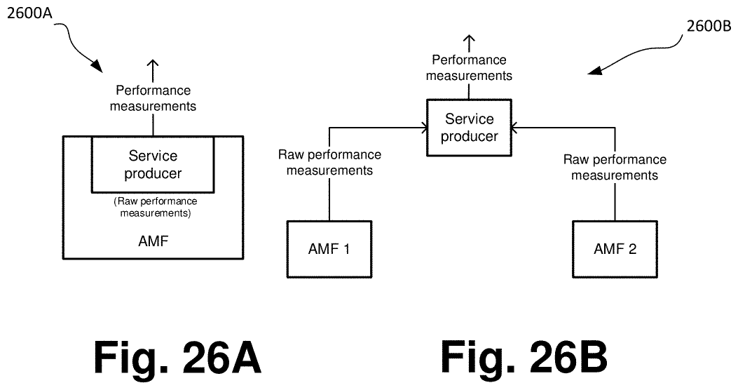

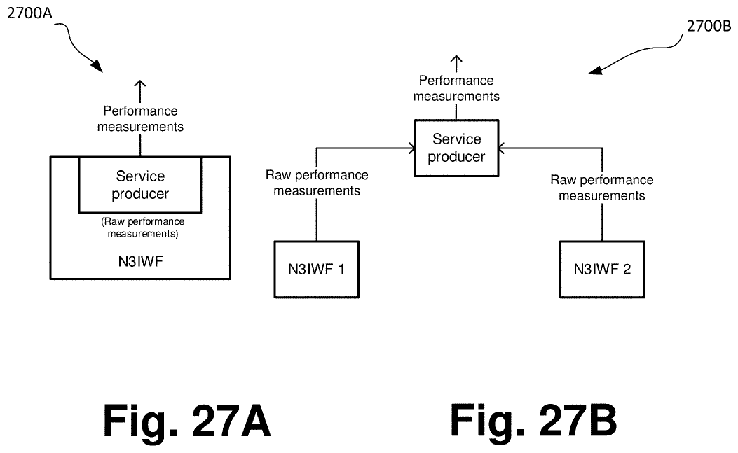

According to various embodiments, one or more of the NFs may be NG-RANs (e.g., gNB-CU-UPs) as shown by way of the architectures 2500A and 2500B of FIGS. 25A and 25B, one or more of the NFs may be AMFs as shown by way of the architectures 2600A and 2600B of FIGS. 26A and 26B, and/or N3IWFs as shown by way of the architectures 2700A and 2700B of FIGS. 27A and 27B. Additionally, the service producer may be implemented within at least one NF or in a separate management system as is shown by FIGS. 25A-27B.

Please note that, in the below, TNGF refers to a Trusted Non-3GPP Access Network Gateway Function, and CC refers to a cumulative counter for counting a measurement event, and a collection period refers to a window of time to count measurement event.

Performance Measurements (to be Added to 3GPP TS 28.552 v16.3.0 (2019 September))

5.2.x Measurements Related to Registration Via Trusted Non-3GPP Access

5.2.x.1 Number of Initial Registration Requests Via Trusted Non-3GPP Access

a) This measurement provides the number of initial registration requests via trusted non-3GPP access received by the AMF.

b) CC.

c) Receipt by the AMF from TNGF of an N2 message that contains Registration Request with the registration type indicating an initial registration (see clause 4.12.2.2 of 3GPP TS 23.502). Each initial registration request is added to the relevant subcounter per network slice identifier (S-NSSAI).

d) Each subcounter is an integer value.

e) RM.RegInitReqTrustNon3GPP.SNSSAL

Where SNSSAI identifies the network slice;

f) AMFFunction.

g) Valid for packet switched traffic.

h) 5GS.

5.2.x.2 Number of Successful Initial Registrations Via Trusted Non-3GPP Access

a) This measurement provides the number of successful initial registrations via trusted non-3GPP access at the AMF.

b) CC.

c) Transmission by the AMF to TNGF of an N2 message that contains Registration Accept corresponding to an initial registration request (see clause 4.12.2.2 of 3GPP TS 23.502). Each accepted initial registration is added to the relevant subcounter per network slice identifier (S-NSSAI).

d) Each subcounter is an integer value.

e) RM.RegInitSuccTrustNon3GPP.SNSSAL

Where SNSSAI identifies the network slice;

f) AMFFunction.

g) Valid for packet switched traffic.

h) 5GS.

5.2.x.3 Number of Mobility Registration Update Requests Via Trusted Non-3GPP Access

a) This measurement provides the number of mobility registration update requests via trusted non-3GPP access received by the AMF.

b) CC.

c) Receipt by the AMF from TNGF of an N2 message that contains Registration Request with the registration type indicating a Mobility Registration Update (see clause 4.12.2.2 of 3GPP TS 23.502 [7]). Each mobility registration update request is added to the relevant subcounter per network slice identifier (S-NSSAI).

d) Each subcounter is an integer value.

e) RM.RegMobReqTrustNon3GPP.SNSSAL

Where SNSSAI identifies the network slice;

f) AMFFunction.

g) Valid for packet switched traffic.

h) 5GS.

5.2.x.4 Number of Successful Mobility Registration Updates Via Trusted Non-3GPP Access

a) This measurement provides the number of successful mobility registration updates via trusted non-3GPP access at the AMF.

b) CC.

c) Transmission by the AMF to TNGF of an N2 message that contains Registration Accept corresponding to a mobility registration update request (see clause 4.12.2.2 of 3GPP TS 23.502). Each accepted mobility registration update is added to the relevant subcounter per network slice identifier (S-NSSAI).

d) Each subcounter is an integer value.

e) RM.RegMobSuccTrustNon3GPP.SNSSAI.

Where SNSSAI identifies the network slice;

f) AMFFunction.

g) Valid for packet switched traffic.

h) 5GS.

5.2.x.5 Number of Periodic Registration Update Requests Via Trusted Non-3GPP Access

a) This measurement provides the number of periodic registration update requests via trusted non-3GPP access received by the AMF.

b) CC.

c) Receipt by the AMF from TNGF of an N2 message that contains Registration Request with the registration type indicating a Periodic Registration Update (see clause 4.12.2.2 of 3GPP TS 23.502 [7]). Each periodic registration update request is added to the relevant subcounter per network slice identifier (S-NSSAI).

d) Each subcounter is an integer value.

e) RM.RegPeriodReqTrustNon3GPP.SNSSAL

Where SNSSAI identifies the network slice;

f) AMFFunction.

g) Valid for packet switched traffic.

h) 5GS.

5.2.x.6 Number of Successful Periodic Registration Updates Via Trusted Non-3GPP Access

a) This measurement provides the number of successful mobility registration updates via trusted non-3GPP access at the AMF.

b) CC.

c) Transmission by the AMF to TNGF of an N2 message that contains Registration Accept corresponding to a periodic registration update request (see clause 4.12.2.2 of 3GPP TS 23.502 [7]). Each accepted periodic registration update is added to the relevant subcounter per network slice identifier (S-NSSAI).

d) Each subcounter is an integer value.

e) RM.RegPeriodSuccTrustNon3GPP.SNSSAI.

Where SNSSAI identifies the network slice;

f) AMFFunction.

g) Valid for packet switched traffic.

h) 5GS.

5.2.x.7 Number of Emergency Registration Requests Via Trusted Non-3GPP Access

a) This measurement provides the number of emergency registration requests via trusted non-3GPP access received by the AMF.

b) CC.

c) Receipt by the AMF from TNGF of an N2 message that contains Registration Request with the registration type indicating an Emergency Registration (see clause 4.2.2.2.2 of 3GPP TS 23.502 [7]). Each emergency registration request is added to the relevant subcounter per network slice identifier (S-NSSAI).

d) Each subcounter is an integer value.

e) RM.RegEmergReqTrustNon3GPP.SNSSAL

Where SNSSAI identifies the network slice;

f) AMFFunction.

g) Valid for packet switched traffic.

h) 5GS.

5.2.x.8 Number of Successful Emergency Registrations Via Trusted Non-3GPP Access

a) This measurement provides the number of successful emergency registrations via trusted non-3GPP access at the AMF.

b) CC.

c) Transmission by the AMF to TNGF of an N2 message that contains Registration Accept corresponding to an emergency registration request (see clause 4.12.2.2 of 3GPP TS 23.502 [7]). Each accepted emergency registration is added to the relevant subcounter per network slice identifier (S-NSSAI).

d) Each subcounter is an integer value.

e) RM.RegEmergSuccTrustNon3GPP.SNSSAI.

Where SNSSAI identifies the network slice;

f) AMFFunction.

g) Valid for packet switched traffic.

h) 5GS.

5.2.y Measurements Related to Service Requests Via Trusted Non-3GPP Access

5.2.y.1 Number of Attempted Service Requests Via Trusted Non-3GPP Access

a) This measurement provides the number of attempted service requests via trusted non-3GPP Access.

b) CC.

c) Receipt of an N2 Message indicating the Service Request by the AMF from TNGF (see 3GPP TS 23.502 [7]).

d) An integer value.

e) MM.ServiceReqTrustNon3GPPAtt.

f) AMFFunction.

g) Valid for packet switched traffic.

h) 5GS.

5.2.y.2 Number of Successful Service Requests Via Trusted Non-3GPP Access

a) This measurement provides the number of successful service requests via trusted non-3GPP Access.

b) CC

c) Transmission of N2 request that contains “MM NAS Service Accept” by the AMF to TNGF (see 3GPP TS 23.502 [7]).

d) An integer value.

e) MM.ServiceReqTrustNon3GPPSucc.

f) AMFFunction.

g) Valid for packet switched traffic.

h) 5GS.

5.8.x QoS Flow Management

5.8.x.1 QoS Flow Setup Via Untrusted Non-3GPP Access

5.8.x.1.1 Number of QoS Flows Attempted to Setup Via Untrusted Non-3GPP Access

a) This measurement provides the number of QoS flows attempted to setup via untrusted non-3GPP access. The measurement is split into subcounters per 5QI and subcounters per network slice identifier (S-NSSAI).

b) CC.

c) Receipt by the N3IWF of a PDU SESSION RESOURCE SETUP REQUEST message, an INITIAL CONTEXT SETUP REQUEST message, or a PDU SESSION RESOURCE MODIFY REQUEST message (see 3GPP TS 29.413 [22]). Each QoS flow requested to setup in the message is added to the relevant measurement per 5QI and relevant subcounter per per S-NSSAI.

d) Each measurement is an integer value.

e) QF.EstabNbrUntrustNon3gppAtt.5QI, where 5QI identifies the 5QI, and

QF.EstabNbrUntrustNon3gppAtt.SNSSAI, where SNSSAI identifies the S-NSSAI.

f) N3IWFFunction.

g) Valid for packet switched traffic.

h) 5GS.

5.8.x.1.2 Number of QoS Flows Successfully Setup Via Untrusted Non-3GPP Access

a) This measurement provides the number of QoS flows successfully setup via untrusted non-3GPP access. The measurement is split into subcounters per 5QI and subcounters per network slice identifier (S-NSSAI).

b) CC.

c) Transmission by the N3IWF of a PDU SESSION RESOURCE SETUP RESPONSE message, an INITIAL CONTEXT SETUP RESPONSE message, or a PDU SESSION RESOURCE MODIFY RESPONSE message (see 3GPP TS 29.413 [22]). Each QoS flow successfully setup in the message is added to the relevant measurement per 5QI and per S-NSSAI.

d) Each measurement is an integer value.

e) The measurement name has the form:

e) QF.EstabNbrUntrustNon3gppSucc.5QI, where 5QI identifies the 5QI, and

QF.EstabNbrUntrustNon3gppSucc.SNSSAI, where SNSSAI identifies the S-NSSAI.

f) N3IWFFunction.

g) Valid for packet switched traffic.

h) 5GS.

5.8.x.1.3 Number of QoS Flows Failed to Setup Via Untrusted Non-3GPP Access

a) This measurement provides the number of QoS flows failed to setup via untrusted non-3GPP access. The measurement is split into subcounters per failure cause.

b) CC.

c) Transmission by the N3IWF of a PDU SESSION RESOURCE SETUP RESPONSE message, or an INITIAL CONTEXT SETUP RESPONSE message, or a PDU SESSION RESOURCE MODIFY RESPONSE message (see 3GPP TS 29.413 [22]). Each QoS flow failed to setup in the message is added to the relevant measurement per cause, the possible causes are specified in TS 38.413 [11].

d) Each measurement is an integer value.

e) QF.EstabNbrUntrustNon3gppFail.cause, where cause identifies the cause (see TS 38.413 [11]).

f) N3IWFFunction.

g) Valid for packet switched traffic.

h) 5GS.

5.8.x.y QoS Flow Modification Via Untrusted Non-3GPP Access

5.8.x.y.1 Number of QoS Flows Attempted to Modify Via Untrusted Non-3GPP Access

a) This measurement provides the number of QoS flows attempted to modify via untrusted non-3GPP access. The measurement is split into subcounters per QoS level (5QI) and subcounters per network slice identifier (S-NSSAI).

b) CC.

c) On receipt by the N3IWF of a PDU SESSION RESOURCE MODIFY REQUEST message (see 3GPP TS 38.413 [11]), each QoS flow requested to modify in this message is added to the relevant subcounter per QoS level (5QI) and relevant subcounter per S-NSSAI.

d) Each measurement is an integer value.

e) QF.ModNbrUntrustNon3gppAtt.5QI, where 5QI identifies the 5QI, and

QF.ModNbrUntrustNon3gppAtt.SNSSAI, where SNSSAI identifies the S-NSSAI.

f) N3IWFFunction.

g) Valid for packet switched traffic.

h) 5GS.

5.8.x.y.2 Number of QoS Flows Successfully Modified Via Untrusted Non-3GPP Access

a) This measurement provides the number of QoS flows successfully modified via untrusted non-3GPP access. The measurement is split into subcounters per QoS level (5QI) and subcounters per network slice identifier (S-NSSAI).

b) CC.

c) On transmission by the N3IWF of a PDU SESSION RESOURCE MODIFY RESPONSE message (see 3GPP TS 38.413 [11]), each QoS flow successfully modified is added to the relevant subcounter per QoS level (5QI) and relevant subcounter per S-NSSAI.

d) Each measurement is an integer value.

e) QF.ModNbrUntrustNon3gppSucc.5QI, where 5QI identifies the 5QI, and

QF.ModNbrUntrustNon3gppSucc.SNSSAI, where SNSSAI identifies the S-NSSAI.

f) N3IWFFunction.

g) Valid for packet switched traffic.

h) 5GS.

5.8.x.y.3 Number of QoS Flows Failed to Modify Via Untrusted Non-3GPP Access

a) This measurement provides the number of QoS flows failed to modify via untrusted non-3GPP access. The measurement is split into subcounters per failure cause.

b) CC.

c) On transmission by the N3IWF of a PDU SESSION RESOURCE MODIFY RESPONSE message (see 3GPP TS 38.413 [11]), each QoS flow failed to modify is added to the relevant subcounter per cause.

d) Each measurement is an integer value.

e) QF.ModNbrUntrustNon3gppFail.cause, where cause identifies the cause (see 3GPP TS 38.413 [11]).

f) N3IWFFunction.

g) Valid for packet switched traffic.

h) 5GS.

5.1.1.13.x QoS Flow Modification in NG-RAN

5.1.1.13.x.1 Number of QoS Flows Attempted to Modify

a) This measurement provides the number of QoS flows attempted to modify. The measurement is split into subcounters per QoS level (5QI) and subcounters per network slice identifier (S-NSSAI).

b) CC.

c) On receipt by the gNB of a PDU SESSION RESOURCE MODIFY REQUEST message (see 3GPP TS 38.413 [11]), each QoS flow requested to modify in this message is added to the relevant subcounter per QoS level (5QI) and relevant subcounter per S-NSSAI.

d) Each measurement is an integer value.

e) QF.ModNbrAtt.5QI, where 5QI identifies the 5QI, and

QF.ModNbrAtt.SNSSAI, where SNSSAI identifies the S-NSSAI.

f) NRCellCU.

g) Valid for packet switched traffic.

h) 5GS.

5.1.1.13.x.2 Number of QoS Flows Successfully Modified

a) This measurement provides the number of QoS flows successfully modified. The measurement is split into subcounters per QoS level (5QI) and subcounters per network slice identifier (S-NSSAI).

b) CC.

c) On transmission by the gNB of a PDU SESSION RESOURCE MODIFY RESPONSE message (see 3GPP TS 38.413 [11]), each QoS flow successfully modified is added to the relevant subcounter per QoS level (5QI) and relevant subcounter per S-NSSAI.

d) Each measurement is an integer value.

e) QF.ModNbrSucc.5QI, where 5QI identifies the 5QI, and

QF.ModNbrSucc.SNSSAI, where SNSSAI identifies the S-NSSAI.

f) NRCellCU.

g) Valid for packet switched traffic.

h) 5GS.

5.1.1.13.x.3 Number of QoS Flows Failed to Modify

a) This measurement provides the number of QoS flows failed to modify. The measurement is split into subcounters per failure cause.

b) CC.

c) On transmission by the gNB of a PDU SESSION RESOURCE MODIFY RESPONSE message (see 3GPP TS 38.413 [11]), each QoS flow failed to modify is added to the relevant subcounter per cause.

d) Each measurement is an integer value.

e) QF.ModNbrFail.cause, where cause identifies the cause (see 3GPP TS 38.413 [11]).

f) NRCellCU.

g) Valid for packet switched traffic.

h) 5GS.

5.1.1.6.x Handovers Between 5GS and EPS Measured in NG-RAN

5.1.1.6.x.1 Number of Requested Preparations for Handovers from 5GS to EPS

a) This measurement provides the number of preparations requested by the source gNB for the outgoing handovers from 5GS to EPS.

b) CC

c) Transmission of HANDOVER REQUIRED message containing the “Handover Type” IE set to “5GStoEPS” (see 3GPP TS 38.413 [11]) by the gNB-CU to the AMF.

d) A single integer value.

e) MM.HoOut5gsToEpsPrepReq.

f) EutranCellRelation (contained by NRCellCU).

g) Valid for packet switched traffic.

h) 5GS.

5.1.1.6.x.2 Number of Successful Preparations for Handovers from 5GS to EPS

a) This measurement provides the number of successful preparations received by the source gNB for the outgoing handovers from 5GS to EPS.

b) CC

c) Receipt of HANDOVER COMMAND message by the gNB-CU from the AMF (see 3GPP TS 38.413 [11]), for informing that the resources have been successfully prepared at the target E-Utran Cell for the handover from 5GS and EPS.

d) A single integer value.

e) MM.HoOut5gsToEpsPrepSucc.

f) EutranCellRelation (contained by NRCellCU).

g) Valid for packet switched traffic.

h) 5GS.

5.1.1.6.x.3 Number of Failed Preparations for Handovers from 5GS to EPS

a) This measurement provides the number of failed preparations received by the source gNB for the outgoing handovers from 5GS to EPS. This measurement is split into subcounters per failure cause.

b) CC

c) Receipt of HANDOVER PREPARATION FAILURE message (see 3GPP TS 38.413 [11]) by the gNB-CU from the AMF, for informing that the preparation of resources have been failed at the target E-Utran Cell for the handover from 5GS and EPS. Each received HANDOVER PREPARATION FAILURE message increments the relevant subcounter per failure cause by 1.

d) Each subcounter is an integer value.

e) MM.HoOut5gsToEpsPrepFail.cause

Where cause identifies the failure cause of the handover preparations.

f) EutranCellRelation (contained by NRCellCU).

g) Valid for packet switched traffic.

h) 5GS.

5.1.1.6.x.4 Number of Requested Resource Allocations for Handovers from EPS to 5GS

a) This measurement provides the number of resource allocation requests received by the target gNB for handovers from EPS to 5GS.

b) CC

c) Receipt of HANDOVER REQUEST message containing the “Handover Type” IE set to “EPSto5GS” (see 3GPP TS 38.413 [11]) by the gNB-CU from the AMF.

d) A single integer value.

e) MM.HolncEpsTo5gsResAlloReq.

f) EutranCellRelation (contained by NRCellCU).

g) Valid for packet switched traffic.

h) 5GS.

5.1.1.6.x.5 Number of Successful Resource Allocations for Handovers from EPS to 5GS

a) This measurement provides the number of successful resource allocations at the target gNB for handovers from EPS to 5GS.

b) CC.

c) Transmission of HANDOVER REQUEST ACKNOWLEDGE message (see 3GPP TS 38.413 [11]) by the gNB-CU to the AMF, for informing that the resources for the handover from EPS to 5GS have been allocated.

d) A single integer value.

e) MM.HolncEpsTo5gsResAlloSucc.

f) EutranCellRelation (contained by NRCellCU).

g) Valid for packet switched traffic.

h) 5GS.

i) One usage of this performance measurements is for performance assurance.

5.1.1.6.x.6 Number of Failed Resource Allocations for Handovers from EPS to 5GS

a) This measurement provides the number of failed resource allocations at the target gNB for handovers from EPS to 5GS. This measurement is split into subcounters per failure cause.

b) CC

c) Transmission of HANDOVER FAILURE message (see 3GPP TS 38.413 [11]) by the gNB-CU to the AMF, for informing that the allocation of resources for the handover from EPS to 5GS has failed. Each transmitted HANDOVER FAILURE message increments the relevant subcounter per failure cause by 1.

d) Each subcounter is an integer value.

e) MM.HolncEpsTo5gsResAlloFail.cause

Where cause identifies the failure cause of the handover resource allocations.

f) EutranCellRelation (contained by NRCellCU).

g) Valid for packet switched traffic.

h) 5GS

5.1.1.6.x.7 Number of Requested Executions for Handovers from 5GS to EPS

a) This measurement provides the number of executions requested by the source gNB for handovers from 5GS to EPS.

b) CC.

c) Transmission of RRC ConnectionReconfiguration message to the UE triggering the handover from the source NR Cell to the target E-UTRAN cell for the handover from 5GS to EPS (see TS 38.331 [20]).

d) A single integer value.

e) MM.HoOutExe5gsToEpsReq.

f) EutranCellRelation (contained by NRCellCU).

g) Valid for packet switched traffic.

h) 5GS.

5.1.1.6.x.8 Number of Successful Executions for Handovers from 5GS to EPS

a) This measurement provides the number of successful executions at the source gNB for handovers from 5GS to EPS.

b) CC

c) Receipt of UE CONTEXT RELEASE COMMAND message by the gNB-CU from AMF (see 3GPP TS 38.413 [11]) following a successful handover from 5GS to EPS.

d) A single integer value.

e) MM.HoOutExe5gsToEpsSucc.

f) EutranCellRelation (contained by NRCellCU).

g) Valid for packet switched traffic.

h) 5GS.

5.1.1.6.x.9 Number of Failed Executions for Handovers from 5GS to EPS

a) This measurement provides the number of failed executions at the source gNB for handovers from 5GS to EPS. This measurement is split into subcounters per failure cause.

b) CC

c) Receipt of UE CONTEXT RELEASE COMMAND at the source gNB-CU from AMF (see 3GPP TS 38.413 [11]) indicating an unsuccessful handover from 5GS to EPS. Each received message increments the relevant subcounter per failure cause by 1.

d) Each subcounter is an integer value.

e) MM.HoOutExe5gsToEpsFail.cause.

Where cause identifies the failure cause in the UE CONTEXT RELEASE COMMAND message.

f) NRCellCU.

g) Valid for packet switched traffic.

h) 5GS.

5.2.5.x Handovers from 5GS to EPS

5.2.5.x.1 Number of Attempted Handovers from 5GS to EPS Via N26 Interface

a) This measurement provides the number of attempted handovers from 5GS to EPS via N26 interface.

b) CC.

c) Transmission by the AMF to the MME of a Forward Relocation Request message (see clause 4.11.1.2.1 of 3GPP TS 23.502 [7]) indicating the handover request from 5GS to EPS.

d) Each measurement is an integer value.

e) MM.HoOut5gsToEpsN26Att.

f) EP_N26 (contained by AMFFunction).

g) Valid for packet switched traffic.

h) 5GS.

5.2.5.x.2 Number of Successful Handovers from 5GS to EPS Via N26 Interface

a) This measurement provides the number of successful handovers from 5GS to EPS via N26 interface.

b) CC.

c) Transmission by the AMF to the MME of a Forward Relocation Complete Notification message (see 3GPP TS 29.274 [x]) indicating a successful handover from 5GS to EPS.

d) Each measurement is an integer value.

e) MM.HoOut5gsToEpsN26Succ.

f) EP_N26 (contained by AMFFunction).

g) Valid for packet switched traffic.

h) 5GS.

5.2.5.x.3 Number of Failed Handovers from 5GS to EPS Via N26 Interface

a) This measurement provides the number of failed handovers from 5GS to EPS via N26 interface. This measurement is split into subcounters per failure cause.

b) CC.

c) Receipt by the AMF from the MME of a Forward Relocation Response message (see 3GPP TS 29.274 [x]) indicating a failed handover from 5GS to EPS. Each received Forward Relocation Response message increments the relevant subcounter per failure cause by 1, and failure cases are specified in 3GPP TS 29.274 [x].

d) Each measurement is an integer value.

e) MM.HoOut5gsToEpsN26Fail.cause

where cause identifies the failure cause (see 3GPP TS 29.274 [x])

f) EP_N26 (contained by AMFFunction).

g) Valid for packet switched traffic.

h) 5GS.

5.2.5.y Handovers from EPS to 5GS

5.2.5.y.1 Number of Attempted Handovers from EPS to 5GS Via N26 Interface

a) This measurement provides the number of attempted handovers from EPS to 5GS via N26 interface.

b) CC.

c) Receipt by the AMF from the MME of a Forward Relocation Request message (see clause 4.11.1.2.1 of 3GPP TS 23.502 [7]) indicating the handover request from EPS to 5GS.

d) Each measurement is an integer value.

e) MM.HolncEpsTo5gsN26Att.

f) EP_N26 (contained by AMFFunction).

g) Valid for packet switched traffic.

h) 5GS.

5.2.5.y.2 Number of Successful Handovers from EPS to 5GS Via N26 Interface

a) This measurement provides the number of successful handovers from EPS to 5GS via N26 interface.

b) CC.

c) Receipt by the AMF from the MME of Forward Relocation Complete Notification message (see 3GPP TS 29.274 [x]) indicating a successful handover from EPS to 5GS.

d) Each measurement is an integer value.

e) MM.HolncEpsTo5gsN26Succ.

f) EP_N26 (contained by AMFFunction).

g) Valid for packet switched traffic.

h) 5GS.

5.2.5.y.3 Number of Failed Handovers from EPS to 5GS Via N26 Interface

a) This measurement provides the number of failed handovers from EPS to 5GS via N26 interface. This measurement is split into subcounters per failure cause.

b) CC.

c) Transmission by the AMF to the MME of a Forward Relocation Response message (see 3GPP TS 29.274 [x]) indicating a failed handover from EPS to 5GS. Each transmitted Forward Relocation Response message increments the relevant subcounter per failure cause by 1, and failure cases are specified in 3GPP TS 29.274 [x].

d) Each measurement is an integer value.

e) MM.HolncEpsTo5gsN26Fail.cause where cause identifies the failure cause (see 3GPP TS 29.274 [x])

f) EP_N26 (contained by AMFFunction).

g) Valid for packet switched traffic.

h) 5GS.

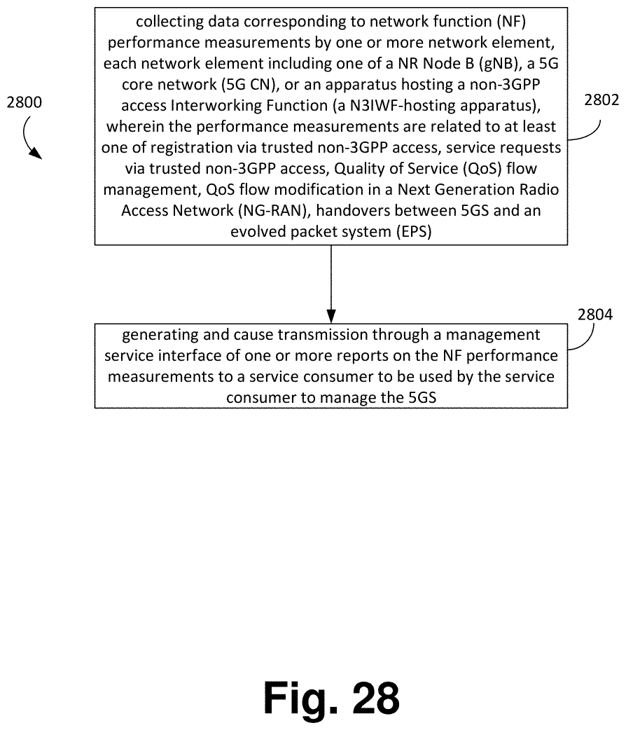

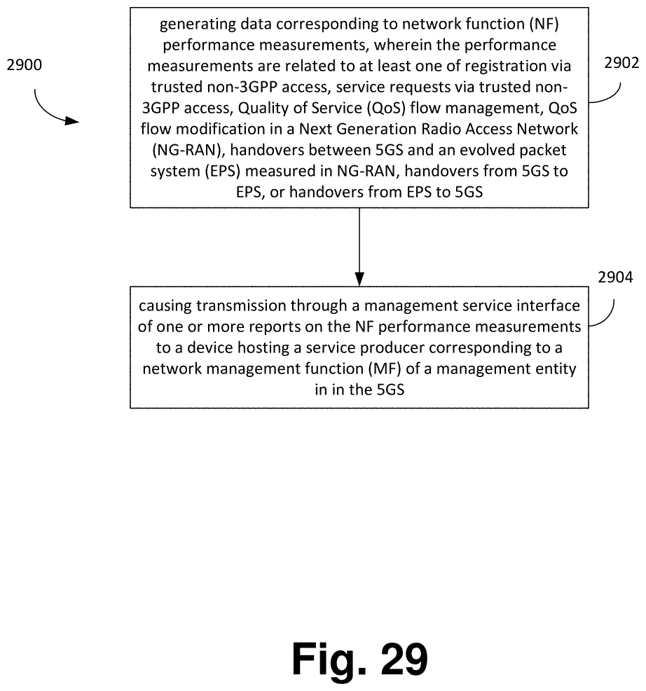

FIGS. 28 and 29 show respective flows for a first and second method according to a first and second embodiment.

FIG. 28 shows a flow 2800 for a method to be performed at a a device to host a service producer corresponding to a network management function (MnF) of a management entity in a Third Generation Partnership Project (3GPP) 5G system (5GS). At operation 2802, the flow includes collecting data corresponding to network function (NF) performance measurements by one or more network element or network function, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS. At operation 2804, the flow includes generating and cause transmission through a management service interface of one or more reports on the NF performance measurements to a service consumer to be used by the service consumer to manage the 5GS.

FIG. 29 shows a flow 2900 for a method to be performed at a network element or network function comprising one of a New Radio Node B (gNB), a 5G Core Network (5GC) function, or a an apparatus hosting a non-3GPP access Interworking Function (a N3IWF-hosting apparatus) in a Third Generation Partnership Project (3GPP) 5G system (5GS). At operation 2902, the flow includes generating data corresponding to network function (NF) performance measurements, wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS. At operation 2904, the flow includes causing transmission through a management interface of one or more reports on the NF performance measurements to a device hosting a service producer corresponding to a network management function (MnF) of a management entity in in the 5GS.

In some embodiments, the electronic device(s), network(s), system(s), chip(s) or component(s), or portions or implementations thereof, of FIGS. 1-23, or some other figure herein, may be configured to perform one or more processes, techniques, or methods as described herein, or portions thereof. One such process is depicted in FIG. 28 or 29.

For one or more embodiments, at least one of the components set forth in one or more of the preceding Figures may be configured to perform one or more operations, techniques, processes, and/or methods as set forth in the example section below. For example, the baseband circuitry as described above in connection with one or more of the preceding Figures may be configured to operate in accordance with one or more of the examples set forth below. For another example, circuitry associated with a UE, base station, network element, etc. as described above in connection with one or more of the preceding Figures may be configured to operate in accordance with one or more of the examples set forth below in the example section.

### EXAMPLES

Example 1 includes an apparatus of a device to host a service producer corresponding to a network management function (MnF) of a management entity in a Third Generation Partnership Project (3GPP) 5G system (5GS), the device comprising: a memory to store instructions; and one or more processors coupled to the memory to execute the instructions to: collect data corresponding to network function (NF) performance measurements by one or more network element or network function, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and generate and cause transmission through a management service interface of one or more reports on the NF performance measurements to a service consumer to be used by the service consumer to manage the 5GS.

Example 2 includes the subject matter of Example 1, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 3 includes the subject matter of Example 2, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 4 includes the subject matter of Example 3, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 5 includes the subject matter of Example 3, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 6 includes the subject matter of Example 3, and optionally, wherein the trigger message corresponding to the NF performance measurements related to registration via trusted non-3GPP access are to be communicated via a N2 interface.

Example 7 includes the subject matter of Example 3, and optionally, wherein the handovers are to be via a N26 interface.

Example 8 includes the subject matter of Example 1, and optionally, wherein the device corresponds to one of a gNB, a 5G CN network element or network function or a standalone management system distinct form a gNB or a CN.

Example 9 includes the subject matter of Example 8, and optionally, further including a transceiver coupled to the one or more processors.

Example 10 includes the subject matter of Example 9, and optionally, further including one or more antennas to transmit and receive messages from the one or more network element.

Example 11 includes one or more non-transitory computer-readable media comprising instructions to cause a device to host a service producer corresponding to a network management function (MnF) of a management entity in a Third Generation Partnership Project (3GPP) 5G system (5GS), upon execution of the instructions by one or more processors of the apparatus, to perform operations including: collecting data corresponding to network function (NF) performance measurements by one or more network element, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and generating and cause transmission through a management service interface of one or more reports on the NF performance measurements to a service consumer to be used by the service consumer to manage the 5GS.

Example 12 includes the subject matter of Example 11, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 13 includes the subject matter of Example 12, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 14 includes the subject matter of Example 13, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 15 includes the subject matter of Example 13, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 16 includes the subject matter of Example 13, and optionally, wherein the trigger message corresponding to the NF performance measurements related to registration via trusted non-3GPP access are to be communicated via a N2 interface.

Example 17 includes the subject matter of Example 13, and optionally, wherein the handovers are to be via a N26 interface.

Example 18 includes the subject matter of Example 11, and optionally, wherein the device corresponds to one of a gNB, a 5G CN network element or network function or a standalone management system distinct form a gNB or a CN.

Example 19 includes the subject matter of Example 18, and optionally, the operations further including transmitting and receiving messages from the one or more network element.

Example 20 includes a method to be performed at an a device to host a service producer corresponding to a network management function (MnF) of a management entity in a Third Generation Partnership Project (3GPP) 5G system (5GS), upon execution of the instructions by one or more processors of the apparatus, to perform operations including: collecting data corresponding to network function (NF) performance measurements by one or more network element or network function, each network element or network functioin including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and generating and cause transmission through a management service interface of one or more reports on the NF performance measurements to a service consumer to be used by the service consumer to manage the 5GS.

Example 21 includes the subject matter of Example 20, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 22 includes the subject matter of Example 21, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 23 includes the subject matter of Example 22, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 24 includes the subject matter of Example 22, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 25 includes the subject matter of Example 22, and optionally, wherein the trigger message corresponding to the NF performance measurements related to registration via trusted non-3GPP access are to be communicated via a N2 interface.

Example 26 includes the subject matter of Example 22, and optionally, wherein the handovers are to be via a N26 interface.

Example 27 includes the subject matter of Example 20, and optionally, wherein the device corresponds to one of a gNB, a 5G CN network element or network function or a standalone management system distinct form a gNB or a CN.

Example 28 includes the subject matter of Example 27, and optionally, the operations further including transmitting and receiving messages from the one or more network element.

Example 29 includes a device of a network element comprising one of a New Radio Node B (gNB), a 5G Core Network (5GC), or a an apparatus hosting a non-3GPP access Interworking Function (a N3IWF-hosting apparatus) in a Third Generation Partnership Project (3GPP) 5G system (5GS), the device comprising: a memory to store instructions; and one or more processors coupled to the memory to execute the instructions to: generate data corresponding to network function (NF) performance measurements, wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and cause transmission through a management service interface of one or more reports on the NF performance measurements to a device hosting a service producer corresponding to a network management function (MnF) of a management entity in in the 5GS.

Example 30 includes the subject matter of Example 29, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 31 includes the subject matter of Example 30, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 32 includes the subject matter of Example 31, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 33 includes the subject matter of Example 31, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 34 includes the subject matter of Example 31, and optionally, wherein the trigger message corresponding to the NF performance measurements related to registration via trusted non-3GPP access are to be communicated via a N2 interface.

Example 35 includes the subject matter of Example 31, and optionally, wherein the handovers are to be via a N26 interface.

Example 36 includes the subject matter of Example 29, and optionally, wherein the device corresponds to one of a gNB, a 5G CN network element or network function or a standalone management system distinct form a gNB or a CN.

Example 37 includes the subject matter of Example 36, and optionally, further including a transceiver coupled to the one or more processors.

Example 38 includes the subject matter of Example 37, and optionally, further including one or more antennas to transmit and receive messages from the service producer.

Example 39 includes one or more non-transitory computer-readable media comprising instructions to cause a network element comprising one of a New Radio Node B (gNB), a 5G Core Network (5GC), or a an apparatus hosting a non-3GPP access Interworking Function (a N3IWF-hosting apparatus) in a Third Generation Partnership Project (3GPP) 5G system (5GS), upon execution of the instructions by one or more processors of the apparatus, to perform operations including: generating data corresponding to network function (NF) performance measurements, wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and causing transmission through a management service interface of one or more reports on the NF performance measurements to a device hosting a service producer corresponding to a network management function (MnF) of a management entity in in the 5GS.

Example 40 includes the subject matter of Example 39, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 41 includes the subject matter of Example 40, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 42 includes the subject matter of Example 41, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 43 includes the subject matter of Example 41, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 44 includes the subject matter of Example 41, and optionally, wherein the trigger message corresponding to the NF performance measurements related to registration via trusted non-3GPP access are to be communicated via a N2 interface.

Example 45 includes the subject matter of Example 41, and optionally, wherein the handovers are to be via a N26 interface.

Example 46 includes the subject matter of Example 39, and optionally, wherein the device corresponds to one of a gNB, a 5G CN network element or network function or a standalone management system distinct form a gNB or a CN.

Example 47 includes the subject matter of Example 47, and optionally, the operations further including one or more antennas to transmit and receive messages from the service producer.

Example 48 includes a method to be performed at a network element comprising one of a New Radio Node B (gNB), a 5G Core Network (5GC) or a an apparatus hosting a non-3GPP access Interworking Function (a N3IWF-hosting apparatus) in a Third Generation Partnership Project (3GPP) 5G system (5GS), the method including: generating data corresponding to network function (NF) performance measurements, wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and causing transmission through a management service interface of one or more reports on the NF performance measurements to a device hosting a service producer corresponding to a network management function (MnF) of a management entity in in the 5GS.

Example 49 includes the subject matter of Example 48, and optionally, wherein at least one of: the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF; the NF performance measurements related to service requests via trusted non-3GPP access include performance measurements comprising at least one of a number of attempted service requests via trusted non-3GPP access or a number of successful service requests via trusted non-3GPP access; the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access; the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify; the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS; the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

Example 50 includes the subject matter of Example 49, and optionally, wherein at least one of: the NF performance measurements related to registration via trusted non-3GPP access are incremented based on: a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request; the NF performance measurements related to service requests via trusted non-3GPP access are incremented based on: a cumulative counter (CC) triggered on receipt of a trigger message by a Trusted Non-3GPP Access Network Gateway Function (TNGF) of a message indicating a Service Request by an AMF; or a cumulative counter (CC) triggered on transmission of a trigger message by a TNGF of a request containing a mobility management non-access stratum(MMS NAS) Service Accept; the NF performance measurements related to Quality of Service (QoS) flow management are incremented based on: a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message; the NF performance measurements related to QoS flow modification in a Next Generation Radio Access Network (NG-RAN) are incremented based on: a cumulative counter (CC) triggered on receipt of a trigger message by a gNB including a PDU SESSION RESOURCE MODIFY REQUEST message; or a cumulative counter (CC) triggered on transmission of a trigger message by gNB including PDU SESSION RESOURCE MODIFY RESPONSE message; the NF performance measurements related to handovers between 5GS and an evolved packet system (EPS) measured in NG-RAN are incremented based on: a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message; the NF performance measurements related to handovers from 5GS to EPS are incremented based on: a cumulative counter (CC) triggered on receipt of a trigger message by an AMF including a Forward Relocation Response message; or a cumulative counter (CC) triggered on transmission of a trigger message by an AMF including a Forward Relocation Request message, or a Forward Relocation Complete notification message; the NF performance measurements related to handovers from EPS to 5GS are incremented based on: a cumulative counter (CC) triggered on receipt of a trigger message by an AMF including a Forward Relocation Request message or a Forward Relocation Complete Notification message; or a cumulative counter (CC) triggered on transmission of a trigger message by an AMF including Forward Relocation Response message.

Example 51 includes the subject matter of Example 41, and optionally, wherein at least one of: the NF performance measurements related to registration via trusted non-3GPP access are incremented based on a subcounter incremented per network slice identifier (S-NSSAI); or the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

Example 52 includes the subject matter of Example 50, and optionally, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

Example 53 includes the subject matter of Example 50, and optionally, wherein the trigger message corresponding to the NF performance measurements related to registration via trusted non-3GPP access are to be communicated via a N2 interface.

Example 54 includes the subject matter of Example 50, and optionally, wherein the handovers are to be via a N26 interface.

Example 55 includes the subject matter of Example 48, and optionally, wherein the device corresponds to one of a gNB, a 5G CN network element or network function or a standalone management system distinct form a gNB or a CN.

Example 56 includes the subject matter of Example 56, and optionally, the operations further including one or more antennas to transmit and receive messages from the service producer.

Example A01 includes a service producer supported by one or more processors configured to: obtain raw performance measurements from NG-RAN; and generate performance measurements for NG-RAN based on the raw performance measurements.

Example A02 includes the service producer of example A01 and/or some other example(s) herein, wherein the service producer is located in NG-RAN or a management function.

Example A03 includes the service producer of examples A01 and A02 and/or some other example(s) herein, wherein the performance measurement is related to QoS flow modification.

Example A04 includes the service producer of example A03 and/or some other example(s) herein, wherein the performance measurement is number of QoS flows attempted to modify, number of QoS flows successfully modified or number of QoS flows failed to modify.

Example A05 includes the service producer of example A04 and/or some other example(s) herein, wherein: the performance measurement of number of QoS flows attempted to modify is a CC (Cumulative Counter) which is triggered on receipt by the gNB of a PDU SESSION RESOURCE MODIFY REQUEST message (see 3GPP TS 38.413 [11]) and each QoS flow requested to modify in the message increments the counter or subcounter by 1; the performance measurement of number of QoS flows successfully modified is a CC (Cumulative Counter) which is triggered on transmission by the gNB of a PDU SESSION RESOURCE MODIFY RESPONSE message (see 3GPP TS 38.413 [11]) that contains the QoS flows successfully modified, and each QoS flow successfully modified in the message increments the counter or subcounter by 1; and the performance measurement of number of QoS flows failed to modify is a CC (Cumulative Counter) which is triggered on transmission by the gNB of a PDU SESSION RESOURCE MODIFY RESPONSE message (see 3GPP TS 38.413 [11]) that contains the QoS flows failed to modify and each QoS flow failed to modify in the message increments the counter or subcounter by 1.

Example A06 includes the service producer of examples A01 and A02 and/or some other example(s) herein, wherein the performance measurement is related to handover between 5GS and EPS.

Example A07 includes the service producer of example A06 and/or some other example(s) herein, wherein the performance measurement is number of requested preparations for handovers from 5GS to EPS, number of successful preparations for handovers from 5GS to EPS, number of failed preparations for handovers from 5GS to EPS, number of requested resource allocations for handovers from EPS to 5GS, number of successful resource allocations for handovers from EPS to 5GS, number of failed resource allocations for handovers from EPS to 5GS, number of requested executions for handovers from 5GS to EPS, number of successful executions for handovers from 5GS to EPS, number of failed executions for handovers from 5GS to EPS.

Example A08 includes the service producer of example A07 and/or some other example(s) herein, wherein: the performance measurement of number of requested preparations for handovers from 5GS to EPS is a CC (Cumulative Counter) which is triggered on transmission of HANDOVER REQUIRED message containing the “Handover Type” IE set to “5GStoEPS” (see 3GPP TS 38.413 [11]) by the gNB-CU to the AMF; the performance measurement of number of successful preparations for handovers from 5GS to EPS is a CC (Cumulative Counter) which is triggered on receipt of HANDOVER COMMAND message by the gNB-CU from the AMF (see 3GPP TS 38.413 [11]), for informing that the resources have been successfully prepared at the target E-Utran Cell for the handover from 5GS and EPS; the performance measurement of number of failed preparations for handovers from 5GS to EPS is a CC (Cumulative Counter) which is triggered on receipt of HANDOVER PREPARATION FAILURE message (see 3GPP TS 38.413 [11]) by the gNB-CU from the AMF, for informing that the preparation of resources have been failed at the target E-Utran Cell for the handover from 5GS and EPS; the performance measurement of number of requested resource allocations for handovers from EPS to 5GS is a CC (Cumulative Counter) which is triggered on receipt of HANDOVER REQUEST message containing the “Handover Type” IE set to “EPSto5GS” (see 3GPP TS 38.413 [11]) by the gNB-CU from the AMF; the performance measurement of number of successful resource allocations for handovers from EPS to 5GS is a CC (Cumulative Counter) which is triggered on transmission of HANDOVER REQUEST ACKNOWLEDGE message (see 3GPP TS 38.413 [11]) by the gNB-CU to the AMF, for informing that the resources for the handover from EPS to 5GS have been allocated; the performance measurement of number of failed resource allocations for handovers from EPS to 5GS is a CC (Cumulative Counter) which is triggered on transmission of HANDOVER FAILURE message (see 3GPP TS 38.413 [11]) by the gNB-CU to the AMF, for informing that the allocation of resources for the handover from EPS to 5GS has failed; the performance measurement of number of requested executions for handovers from 5GS to EPS is a CC (Cumulative Counter) which is triggered on transmission of RRC ConnectionReconfiguration message to the UE triggering the handover from the source NR Cell to the target E-UTRAN cell for the handover from 5GS to EPS (see 3GPP TS 38.331 [20]); the performance measurement of number of successful executions for handovers from 5GS to EPS is a CC (Cumulative Counter) which is triggered on receipt of UE CONTEXT RELEASE COMMAND message by the gNB-CU from AMF (see 3GPP TS 38.413 [11]) following a successful handover from 5GS to EPS; and the performance measurement of number of failed executions for handovers from 5GS to EPS is a CC (Cumulative Counter) which is triggered on receipt of UE CONTEXT RELEASE COMMAND at the source gNB-CU from AMF (see 3GPP TS 38.413 [11]) indicating an unsuccessful handover from 5GS to EPS.

Example A09 includes a service producer supported by one or more processors configured to: obtain raw performance measurements from AMF; and generate performance measurements for AMF based on the raw performance measurements.

Example A10 includes the service producer of example A09 and/or some other example(s) herein, wherein the service producer is located in AMF or a management function.

Example A11 includes the service producer of examples A09 and A10 and/or some other example(s) herein, wherein the performance measurement is related to trusted non-3GPP access.

Example A12 includes the service producer of example A11 and/or some other example(s) herein, wherein the performance measurement is number of initial registration requests via trusted non-3GPP access, number of successful initial registrations via trusted non-3GPP access, number of mobility registration update requests via trusted non-3GPP access, number of successful mobility registration updates via trusted non-3GPP access, number of periodic registration update requests via trusted non-3GPP access, number of successful periodic registration updates via trusted non-3GPP access, number of emergency registration requests via trusted non-3GPP access, number of successful emergency registrations via trusted non-3GPP access, number of attempted service requests via trusted non-3GPP Access, or number of successful service requests via trusted non-3GPP Access.

Example A13 includes the service producer of example A12 and/or some other example(s) herein, wherein: the performance measurement of number of initial registration requests via trusted non-3GPP access is a CC (Cumulative Counter) which is triggered on receipt by the AMF from TNGF of an N2 message that contains Registration Request with the registration type indicating an initial registration (see clause 4.12.2.2 of 3GPP TS 23.502); the performance measurement of number of successful initial registrations via trusted non-3GPP access is a CC (Cumulative Counter) which is triggered on transmission by the AMF to TNGF of an N2 message that contains Registration Accept corresponding to an initial registration request (see clause 4.12.2.2 of 3GPP TS 23.502); the performance measurement of number of mobility registration update requests via trusted non-3GPP access is a CC (Cumulative Counter) which is triggered on receipt by the AMF from TNGF of an N2 message that contains Registration Request with the registration type indicating a Mobility Registration Update (see clause 4.12.2.2 of 3GPP TS 23.502); the performance measurement of number of successful mobility registration updates via trusted non-3GPP access is a CC (Cumulative Counter) which is triggered on transmission by the AMF to TNGF of an N2 message that contains Registration Accept corresponding to a mobility registration update request (see clause 4.12.2.2 of 3GPP TS 23.502); the performance measurement of number of periodic registration update requests via trusted non-3GPP access is a CC (Cumulative Counter) which is triggered on receipt by the AMF from TNGF of an N2 message that contains Registration Request with the registration type indicating a Periodic Registration Update (see clause 4.12.2.2 of 3GPP TS 23.502); the performance measurement of number of successful periodic registration updates via trusted non-3GPP access is a CC (Cumulative Counter) which is triggered on transmission by the AMF to TNGF of an N2 message that contains Registration Accept corresponding to a periodic registration update request (see clause 4.12.2.2 of 3GPP TS 23.502); the performance measurement of number of emergency registration requests via trusted non-3GPP access is a CC (Cumulative Counter) which is triggered on receipt by the AMF from TNGF of an N2 message that contains Registration Request with the registration type indicating an Emergency Registration (see clause 4.2.2.2.2 of 3GPP TS 23.502); the performance measurement of number of successful emergency registrations via trusted non-3GPP access is a CC (Cumulative Counter) which is triggered on transmission by the AMF to TNGF of an N2 message that contains Registration Accept corresponding to an emergency registration request (see clause 4.12.2.2 of 3GPP TS 23.502); the performance measurement of number of attempted service requests via trusted non-3GPP Access is a CC (Cumulative Counter) which is triggered on receipt of an N2 Message indicating the Service Request by the AMF from TNGF (see 3GPP TS 23.502); and the performance measurement of number of successful service requests via trusted non-3GPP Access is a CC (Cumulative Counter) which is triggered on transmission of N2 request that contains “MM NAS Service Accept” by the AMF to TNGF (see 3GPP TS 23.502).

Example A14 includes the service producer of examples A09 and A10 and/or some other example(s) herein, wherein the performance measurement is related to handover between 5GS and EPS via N26 interface.

Example A15 includes the service producer of example A14 and/or some other example(s) herein, wherein the performance measurement is number of attempted handovers from 5GS to EPS via N26 interface, number of successful handovers from 5GS to EPS via N26 interface, number of failed handovers from 5GS to EPS via N26 interface, number of attempted handovers from EPS to 5GS via N26 interface, number of successful handovers from EPS to 5GS via N26 interface, or number of failed handovers from EPS to 5GS via N26 interface.

Example A16 includes the service producer of example A15 and/or some other example(s) herein, wherein: the performance measurement of number of attempted handovers from 5GS to EPS via N26 interface is a CC (Cumulative Counter) which is triggered on transmission by the AMF to the MME of a Forward Relocation Request message (see clause 4.11.1.2.1 of 3GPP TS 23.502) indicating the handover request from 5GS to EPS; the performance measurement of number of successful handovers from 5GS to EPS via N26 interface is a CC (Cumulative Counter) which is triggered on transmission by the AMF to the MME of a Forward Relocation Complete Notification message (see 3GPP TS 29.274 [x]) indicating a successful handover from 5GS to EPS; the performance measurement of number of failed handovers from 5GS to EPS via N26 interface is a CC (Cumulative Counter) which is triggered on receipt by the AMF from the MME of a Forward Relocation Response message (see 3GPP TS 29.274 [x]) indicating a failed handover from 5GS to EPS; the performance measurement of number of attempted handovers from EPS to 5GS via N26 interface is a CC (Cumulative Counter) which is triggered on receipt by the AMF from the MME of a Forward Relocation Request message (see clause 4.11.1.2.1 of 3GPP TS 23.502) indicating the handover request from EPS to 5GS; the performance measurement of number of successful handovers from EPS to 5GS via N26 interface is a CC (Cumulative Counter) which is triggered on receipt by the AMF from the MME of Forward Relocation Complete Notification message (see 3GPP TS 29.274 [x]) indicating a successful handover from EPS to 5GS; the performance measurement of number of failed handovers from EPS to 5GS via N26 interface is a CC (Cumulative Counter) which is triggered on transmission by the AMF to the MME of a Forward Relocation Response message (see 3GPP TS 29.274 [x]) indicating a failed handover from EPS to 5GS.

Example A17 includes a service producer supported by one or more processors configured to: obtain raw performance measurements from N3IWF; and generate performance measurements for N3IWF based on the raw performance measurements.

Example A18 includes the service producer of example A17 and/or some other example(s) herein, wherein the service producer is located in N3IWFor a management function.

Example A19 includes the service producer of examples A17 and A18 and/or some other example(s) herein, wherein the performance measurement is related to QoS flow management.

Example A20 includes the service producer of example A19 and/or some other example(s) herein, wherein the performance measurement is number of QoS flows attempted to setup via untrusted non-3GPP access, number of QoS flow successfully setup via untrusted non-3GPP access, number of QoS flow failed to setup via untrusted non-3GPP access, number of QoS flow attempted to modify via untrusted non-3GPP access, number of QoS flow successfully modified via untrusted non-3GPP access or number of QoS flow failed to modify via untrusted non-3GPP access.

Example A21 includes the service producer of example A20 and/or some other example(s) herein, wherein: the performance measurement of number of QoS flows attempted to setup via untrusted non-3GPP access is a CC (Cumulative Counter) which is triggered on receipt by the N3IWF of a PDU SESSION RESOURCE SETUP REQUEST message, an INITIAL CONTEXT SETUP REQUEST message, or a PDU SESSION RESOURCE MODIFY REQUEST message (see 3GPP TS 29.413 [22]), and each QoS flow requested to setup in the message increments the counter or subcounter by 1; the performance measurement of number of QoS flow successfully setup via untrusted non-3GPP access is a CC (Cumulative Counter) which is triggered on transmission by the N3IWF of a PDU SESSION RESOURCE SETUP RESPONSE message, an INITIAL CONTEXT SETUP RESPONSE message, or a PDU SESSION RESOURCE MODIFY RESPONSE message (see 3GPP TS 29.413 [22]), and each QoS flow successfully setup in the message increments the counter or subcounter by 1; the performance measurement of number of QoS flow failed to setup via untrusted non-3GPP access is a CC (Cumulative Counter) which is triggered on transmission by the N3IWF of a PDU SESSION RESOURCE SETUP RESPONSE message, or an INITIAL CONTEXT SETUP RESPONSE message, or a PDU SESSION RESOURCE MODIFY RESPONSE message (see 3GPP TS 29.413 [22]), and each QoS flow failed to modify in the message increments the counter or subcounter by 1; the performance measurement of number of QoS flow attempted to modify via untrusted non-3GPP access is a CC (Cumulative Counter) which is triggered on receipt by the N3IWF of a PDU SESSION RESOURCE MODIFY REQUEST message (see 3GPP TS 38.413 [11]), and each QoS flow requested to modify in the message increments the counter or subcounter by 1; the performance measurement of number of QoS flow successfully modified via untrusted non-3GPP access is a CC (Cumulative Counter) which is triggered on transmission by the N3IWF of a PDU SESSION RESOURCE MODIFY RESPONSE message (see 3GPP TS 38.413 [11]), and each QoS flow requested successfully modified in the message increments the counter or subcounter by 1; and the performance measurement of number of QoS flow failed to modify via untrusted non-3GPP access is a CC (Cumulative Counter) which is triggered on transmission by the N3IWF of a PDU SESSION RESOURCE MODIFY RESPONSE message (see 3GPP TS 38.413 [11]), and each QoS flow failed to modify in the message increments the counter or subcounter by 1.

Example A22 includes the service producer of examples A01 to A21 and/or some other example(s) herein, wherein the measurement is split into subcounters per 5QI, subcounters per S-NSSAI and/or subcounters per failure cause.

Example B01 includes a method to be performed by a service producer, the method comprising: obtaining or causing to obtain raw performance measurements from one or more network functions (NFs); and generating or causing to generate NF performance measurements based on the raw performance measurements.

Example B02 includes the method of example B01 and/or some other example(s) herein, wherein the one or more NFs are next generation radio access networks (NG-RANs), and the service producer is located in one of the one or more NG-RANs, another NG-RAN, or a management function.

Example B03 includes the method of example B02 and/or some other example(s) herein, wherein at least some of the performance measurements are related to QoS flow modification.

Example B04 includes the method of example B03 and/or some other example(s) herein, wherein the performance measurements related to QoS flow modification include a number of QoS flows attempted to be modified, a number of QoS flows successfully modified, and/or a number of QoS flows failed to be modified.

Example B05 includes the method of example B04 and/or some other example(s) herein, wherein the number of QoS flows attempted to be modified is based on a Cumulative Counter (CC) that is triggered on receipt by respective NG-RANs of a PDU SESSION RESOURCE MODIFY REQUEST message and each QoS flow requested to be modified in the PDU SESSION RESOURCE MODIFY REQUEST message increments the CC or a subcounter by 1.

Example B06 includes the method of examples B04-B05 and/or some other example(s) herein, wherein the number of QoS flows successfully to be modified is based on a CC that is triggered on transmission by respective NG-RANs of a PDU SESSION RESOURCE MODIFY RESPONSE message that contains the QoS flows successfully modified, and each QoS flow successfully modified in the PDU SESSION RESOURCE MODIFY RESPONSE message increments the CC or a subcounter by 1.

Example B07 includes the method of examples B04-B06 and/or some other example(s) herein, wherein the number of QoS flows failed to be modified is based on a CC that is triggered on transmission by respective NG-RANs of a PDU SESSION RESOURCE MODIFY RESPONSE message that contains the QoS flows failed to be modified and each QoS flow failed to be modified in the PDU SESSION RESOURCE MODIFY RESPONSE message increments the CC or a subcounter by 1.

Example B08 includes the method of examples B02-B07 and/or some other example(s) herein, wherein at least some of the performance measurements are related to handovers between 5GS and EPS.

Example B09 includes the method of example B08 and/or some other example(s) herein, wherein the performance measurements related to handovers includes a number of requested preparations for handovers from 5GS to EPS, a number of successful preparations for handovers from 5GS to EPS, a number of failed preparations for handovers from 5GS to EPS, a number of requested resource allocations for handovers from EPS to 5GS, a number of successful resource allocations for handovers from EPS to 5GS, a number of failed resource allocations for handovers from EPS to 5GS, a number of requested executions for handovers from 5GS to EPS, a number of successful executions for handovers from 5GS to EPS, and/or a number of failed executions for handovers from 5GS to EPS.

Example B10 includes the method of example B09 and/or some other example(s) herein, wherein: the number of requested preparations for handovers from 5GS to EPS is based on a CC that is triggered on transmission of a HANDOVER REQUIRED message containing a Handover Type IE set to “5GStoEPS” from a gNB-CU of one of the NG-RANs to an AMF.

Example B11 includes the method of examples B09-B10 and/or some other example(s) herein, wherein: the number of successful preparations for handovers from 5GS to EPS is based on a CC that is triggered on receipt of a HANDOVER COMMAND message by a gNB-CU of one of the NG-RANs from an AMF, the HANDOVER COMMAND message for indicating that resources have been successfully prepared at a target E-Utran Cell for the handover from 5GS and EPS.

Example B12 includes the method of examples B09-B11 and/or some other example(s) herein, wherein: the number of failed preparations for handovers from 5GS to EPS is based on a CC that is triggered on receipt of a HANDOVER PREPARATION FAILURE message by a gNB-CU of one of the NG-RANs from an AMF, the HANDOVER PREPARATION FAILURE message for indicating that the preparation of resources have been failed at a target E-Utran Cell for the handover from 5GS and EPS;

Example B13 includes the method of examples B09-B12 and/or some other example(s) herein, wherein: the number of requested resource allocations for handovers from EPS to 5GS is based on a CC that is triggered on receipt of a HANDOVER REQUEST message containing a “Handover Type” IE set to “EPSto5GS” by a gNB-CU of one of the NG-RANs from the AMF.

Example B14 includes the method of examples B09-B13 and/or some other example(s) herein, wherein: the number of successful resource allocations for handovers from EPS to 5GS is based on a CC that is triggered on transmission of a HANDOVER REQUEST ACKNOWLEDGE message by a gNB-CU of one of the NG-RANs to an AMF, the HANDOVER REQUEST ACKNOWLEDGE message for indicating that the resources for the handover from EPS to 5GS have been allocated.

Example B15 includes the method of examples B09-B14 and/or some other example(s) herein, wherein: the number of failed resource allocations for handovers from EPS to 5GS is based on a CC that is triggered on transmission of HANDOVER FAILURE message by a gNB-CU of one of the NG-RANs to an AMF, for indicating that the allocation of resources for the handover from EPS to 5GS has failed.

Example B16 includes the method of examples B09-B15 and/or some other example(s) herein, wherein: the number of requested executions for handovers from 5GS to EPS is based on a CC that is triggered on transmission of RRC ConnectionReconfiguration message to the UE triggering the handover from a source NR Cell to a target E-UTRAN cell for the handover from 5GS to EPS.

Example B17 includes the method of examples B09-B16 and/or some other example(s) herein, wherein: the number of successful executions for handovers from 5GS to EPS is based on a CC that is triggered on receipt of UE CONTEXT RELEASE COMMAND message by a gNB-CU of one of the NG-RANs from an AMF following a successful handover from 5GS to EPS.

Example B18 includes the method of examples B09-B17 and/or some other example(s) herein, wherein: the number of failed executions for handovers from 5GS to EPS is based on a CC that is triggered on receipt of a UE CONTEXT RELEASE COMMAND at a source gNB-CU of one of the NG-RANs from an AMF indicating an unsuccessful handover from 5GS to EPS.

Example B19 includes the method of example B01 and/or some other example(s) herein, wherein the one or more NFs are Access and Mobility Management Functions (AMFs), and the service producer is located in one of the one or more AMFs, another AMF, or a management function.

Example B20 includes the method of example B19 and/or some other example(s) herein, wherein at least some of the performance measurements are related to trusted non-3GPP access.

Example B21 includes the method of example B20 and/or some other example(s) herein, wherein the performance measurements related to trusted non-3GPP access include one or more of a number of initial registration requests via trusted non-3GPP access, a number of successful initial registrations via trusted non-3GPP access, a number of mobility registration update requests via trusted non-3GPP access, a number of successful mobility registration updates via trusted non-3GPP access, a number of periodic registration update requests via trusted non-3GPP access, number of successful periodic registration updates via trusted non-3GPP access, a number of emergency registration requests via trusted non-3GPP access, a number of successful emergency registrations via trusted non-3GPP access, a number of attempted service requests via trusted non-3GPP Access, or number of successful service requests via trusted non-3GPP Access.

Example B22 includes the method of example B21 and/or some other example(s) herein, wherein: the number of initial registration requests via trusted non-3GPP access is based on a CC that is triggered on receipt by the service producer AMF from a Trusted Non-3GPP Access Network Gateway Function (TNGF) of an N2 message that contains a Registration Request with a registration type indicating an initial registration.

Example B23 includes the method of examples B21-B22 and/or some other example(s) herein, wherein: the number of successful initial registrations via trusted non-3GPP access is based on a CC that is triggered on transmission by the service producer AMF to a TNGF of an N2 message that contains Registration Accept corresponding to an initial Registration Request.

Example B24 includes the method of examples B21-B23 and/or some other example(s) herein, wherein: the number of mobility registration update requests via trusted non-3GPP access is based on a CC that is triggered on receipt by the service producer AMF from a TNGF of an N2 message that contains a Registration Request with a registration type indicating a Mobility Registration Update.

Example B25 includes the method of examples B21-B24 and/or some other example(s) herein, wherein: the number of successful mobility registration updates via trusted non-3GPP access is based on a CC that is triggered on transmission by the service producer AMF to a TNGF of an N2 message that contains a Registration Accept corresponding to a mobility registration update request.

Example B26 includes the method of examples B21-B25 and/or some other example(s) herein, wherein: the number of periodic registration update requests via trusted non-3GPP access is based on a CC that is triggered on receipt by the service producer AMF from a TNGF of an N2 message that contains a Registration Request with the registration type indicating a Periodic Registration Update.

Example B27 includes the method of examples B21-B26 and/or some other example(s) herein, wherein: the number of successful periodic registration updates via trusted non-3GPP access is based on a CC that is triggered on transmission by the service producer AMF to a TNGF of an N2 message that contains a Registration Accept corresponding to a periodic registration update request.

Example B28 includes the method of examples B21-B27 and/or some other example(s) herein, wherein: the number of emergency registration requests via trusted non-3GPP access is based on a CC that is triggered on receipt by the service producer AMF from a TNGF of an N2 message that contains a Registration Request with the registration type indicating an Emergency Registration.

Example B29 includes the method of examples B21-B29 and/or some other example(s) herein, wherein: the number of successful emergency registrations via trusted non-3GPP access is based on a CC that is triggered on transmission by the service producer AMF to a TNGF of an N2 message that contains a Registration Accept corresponding to an emergency registration request.

Example B30 includes the method of examples B21-B29 and/or some other example(s) herein, wherein: the number of attempted service requests via trusted non-3GPP Access is based on a CC that is triggered on receipt of an N2 Message indicating a Service Request by the AMF from a TNGF.

Example B31 includes the method of examples B21-B30 and/or some other example(s) herein, wherein: the number of successful service requests via trusted non-3GPP Access is based on a CC that is triggered on transmission of N2 request that contains a “MM NAS Service Accept” by the service producer AMF to a TNGF.

Example B32 includes the method of examples B19-B31 and/or some other example(s) herein, wherein at least some of the performance measurements are related to handover between 5GS and EPS via an N26 interface.

Example B33 includes the method of example B32 and/or some other example(s) herein, wherein the performance measurements related to handover between 5GS and EPS via N26 interface includes one or more of a number of attempted handovers from 5GS to EPS via N26 interface, a number of successful handovers from 5GS to EPS via N26 interface, a number of failed handovers from 5GS to EPS via N26 interface, a number of attempted handovers from EPS to 5GS via N26 interface, a number of successful handovers from EPS to 5GS via N26 interface, or number of failed handovers from EPS to 5GS via N26 interface.

Example B34 includes the method of example B33 and/or some other example(s) herein, wherein the number of attempted handovers from 5GS to EPS via N26 interface is based on a CC that is triggered on transmission by the service producer AMF to an MME of a Forward Relocation Request message indicating the handover request from 5GS to EPS.

Example B35 includes the method of examples B33-B34 and/or some other example(s) herein, wherein the performance measurement of number of successful handovers from 5GS to EPS via N26 interface is based on a CC that is triggered on transmission by the service producer AMF to an MME of a Forward Relocation Complete Notification message indicating a successful handover from 5GS to EPS.

Example B36 includes the method of examples B33-B35 and/or some other example(s) herein, wherein the performance measurement of number of failed handovers from 5GS to EPS via N26 interface is based on a CC that is triggered on receipt by the service producer AMF from an MME of a Forward Relocation Response message indicating a failed handover from 5GS to EPS.

Example B37 includes the method of examples B33-B36 and/or some other example(s) herein, wherein the performance measurement of number of attempted handovers from EPS to 5GS via N26 interface is based on a CC that is triggered on receipt by the service producer AMF from an MME of a Forward Relocation Request message indicating the handover request from EPS to 5GS.

Example B38 includes the method of examples B33-B37 and/or some other example(s) herein, wherein the performance measurement of number of successful handovers from EPS to 5GS via N26 interface is based on a CC that is triggered on receipt by the service producer AMF from an MME of Forward Relocation Complete Notification message indicating a successful handover from EPS to 5GS.

Example B39 includes the method of examples B33-B38 and/or some other example(s) herein, wherein the performance measurement of number of failed handovers from EPS to 5GS via N26 interface is based on a CC that is triggered on transmission by the service producer AMF to an MME of a Forward Relocation Response message indicating a failed handover from EPS to 5GS.

Example B40 includes the method of example B01 and/or some other example(s) herein, wherein the one or more NFs are non-3GPP access Interworking Functions (N3IWFs), and the service producer is located in one of the one or more N3IWFs, another N3IWF, or a management function

Example B41 includes the method of example B40 and/or some other example(s) herein, wherein at least some of the performance measurements are related to QoS flow management.

Example B42 includes the method of example B41 and/or some other example(s) herein, wherein the performance measurements related to QoS flow management include one or more of a number of QoS flows attempted to setup via untrusted non-3GPP access, a number of QoS flow successfully setup via untrusted non-3GPP access, a number of QoS flow failed to setup via untrusted non-3GPP access, a number of QoS flow attempted to modify via untrusted non-3GPP access, a number of QoS flow successfully modified via untrusted non-3GPP access or number of QoS flow failed to modify via untrusted non-3GPP access.

Example B43 includes the method of example B42 and/or some other example(s) herein, wherein the number of QoS flows attempted to setup via untrusted non-3GPP access is based on a CC that is triggered on receipt, by the N3IWF, of a PDU SESSION RESOURCE SETUP REQUEST message, an INITIAL CONTEXT SETUP REQUEST message, or a PDU SESSION RESOURCE MODIFY REQUEST message, and wherein each QoS flow requested to be setup in the message increments the CC or a subcounter by 1.

Example B44 includes the method of examples B42-B43 and/or some other example(s) herein, wherein the number of QoS flow successfully setup via untrusted non-3GPP access is based on a CC that is triggered on transmission, by the N3IWF, of a PDU SESSION RESOURCE SETUP RESPONSE message, an INITIAL CONTEXT SETUP RESPONSE message, or a PDU SESSION RESOURCE MODIFY RESPONSE message, and wherein each QoS flow successfully setup in the message increments the CC or a subcounter by 1.

Example B45 includes the method of examples B42-B44 and/or some other example(s) herein, wherein the number of QoS flow failed to setup via untrusted non-3GPP access is based on a CC that is triggered on transmission by the N3IWF of a PDU SESSION RESOURCE SETUP RESPONSE message, or an INITIAL CONTEXT SETUP RESPONSE message, or a PDU SESSION RESOURCE MODIFY RESPONSE message, and wherein each QoS flow failed to modify in the message increments the CC or a subcounter by 1.

Example B46 includes the method of examples B42-B45 and/or some other example(s) herein, wherein the number of QoS flow attempted to modify via untrusted non-3GPP access is based on a CC that is triggered on receipt by the N3IWF of a PDU SESSION RESOURCE MODIFY REQUEST message, and wherein each QoS flow requested to modify in the message increments the CC or a subcounter by 1.

Example B47 includes the method of examples B42-B46 and/or some other example(s) herein, wherein the number of QoS flow successfully modified via untrusted non-3GPP access is based on a CC that is triggered on transmission by the N3IWF of a PDU SESSION RESOURCE MODIFY RESPONSE message, and wherein each QoS flow requested successfully modified in the message increments the CC or a subcounter by 1.

Example B48 includes the method of examples B42-B47 and/or some other example(s) herein, wherein the number of QoS flow failed to modify via untrusted non-3GPP access is based on a CC that is triggered on transmission by the N3IWF of a PDU SESSION RESOURCE MODIFY RESPONSE message, and wherein each QoS flow failed to modify in the message increments the CC or a subcounter by 1.

Example B49 includes the method of examples B01-B48 and/or some other example(s) herein, further comprising: splitting or causing to split the performance measurements into subcounters according to 5G QoS Indicators (5QIs) associated with individual performance measurements, Single Network Slice Selection Assistance Information (S-NSSAI) associated with individual performance measurements, and/or failure cause values associated with individual performance measurements.

Example B50 includes the method of examples B01-B49 and/or some other example(s) herein, further comprising: sending or causing to send the generated NF performance measurements to one or more service consumers.

Example Z01 includes an apparatus comprising means to perform one or more elements of a method described in or related to any of examples A01-A22, B01-B50, or any other method or process described herein.

Example Z02 includes one or more non-transitory computer-readable media comprising instructions to cause an electronic device, upon execution of the instructions by one or more processors of the electronic device, to perform one or more elements of a method described in or related to any of examples A01-A22, B01-B50, or any other method or process described herein.

Example Z03 includes an apparatus comprising logic, modules, or circuitry to perform one or more elements of a method described in or related to any of examples A01-A22, B01-B50, or any other method or process described herein.

Example Z04 includes a method, technique, or process as described in or related to any of examples A01-A22, B01-B50, or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of examples A01-A22, B01-B50, or portions thereof.

Example Z06 includes a signal as described in or related to any of examples A01-A22, B01-B50, or portions or parts thereof.

Example Z07 includes a datagram, packet, frame, segment, protocol data unit (PDU), or message as described in or related to any of examples A01-A22, B01-B50, or portions or parts thereof, or otherwise described in the present disclosure.

Example Z08 includes a signal encoded with data as described in or related to any of examples A01-A22, B01-B50, or portions or parts thereof, or otherwise described in the present disclosure.

Example Z09 includes a signal encoded with a datagram, packet, frame, segment, protocol data unit (PDU), or message as described in or related to any of examples A01-A22, B01-B50, or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of examples A01-A22, B01-B50, or portions thereof.

Example Z11 includes a computer program comprising instructions, wherein execution of the program by a processing element is to cause the processing element to carry out the method, techniques, or process as described in or related to any of examples A01-A22, B01-B50, or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

The term “circuitry” refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), complex PLD (CPLD), high-capacity PLD (HCPLD), System-on-Chip (SoC), System-in-Package (SiP), Multi-Chip Package (MCP), digital signal processor (DSP), etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including random access memory (RAM), magnetoresistive RAM (MRAM), phase change random access memory (PRAM), dynamic random access memory (DRAM) and/or synchronous dynamic random access memory (SDRAM), core memory, read only memory (ROM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

The terms “instantiate,” “instantiation,” and the like as used herein refers to the creation of an instance. An “instance” also refers to a concrete occurrence of an object, which may occur, for example, during execution of program code. A Network Instance refers to information identifying a domain and, for example, may be used by the UPF for traffic detection and routing. A Network Slice is a logical network that provides specific network capabilities and network characteristics. A Network Slice instance is a set of Network Function instances and the required resources (e.g. compute, storage and networking resources) which form a deployed Network Slice. An NF instance is an identifiable instance of the NF. A network slice subnet is a representation of the management aspects of a set of Managed Functions and the required resources (e.g., compute, storage and networking resources). A Network Slice Subnet Information Object Class describes the structure (e.g., contained components and connectivity between them) and configuration of a network slice subnet, as well as network capability. A network slice subnet instance is an instance of Network Slice Subnet representing the management aspects of a set of Managed Function instances and the used resources (e.g., compute, storage and networking resources). A Service Level Specification is a set of service level requirements associated with a Service Level Agreement to be satisfied by a network slice instance.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “information element” refers to a structural element containing one or more fields. The term “field” refers to individual contents of an information element, or a data element that contains content.

The term “admission control” refers to a validation process in communication systems where a check is performed before a connection is established to see if current resources are sufficient for the proposed connection.

The term “workload” refers to an amount of work performed by a computing system, device, entity, etc., during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by the processor circuitry during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, etc.), and/or the like. Various algorithms may be used to determine a workload and/or workload characteristics, which may be based on any of the aforementioned workload types.

The term “SMTC” refers to an SSB-based measurement timing configuration configured by SSB-MeasurementTimingConfiguration. The term “SSB” refers to an SS/PBCH block.

The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. When a UE in RRC_CONNECTED configured with CA/DC, the term “serving cell” refers to the set of cells comprising the Special Cell(s) and all secondary cells. The term “Special Cell” refers to the PCell of the MCG or the PSCell of the SCG for DC operation; otherwise, the term “Special Cell” refers to the PCell.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A device to host a service producer corresponding to a network management function (MnF) of a management entity in a Third Generation Partnership Project (3GPP) 5G system (5GS), the device comprising:
a memory to store instructions; and
one or more processors coupled to the memory to execute the instructions to:
collect data corresponding to network function (NF) performance measurements by one or more network element or network function, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and
generate and cause transmission through a management service interface of one or more reports on the NF performance measurements to a service consumer to be used by the service consumer to manage the 5GS.

2. The device of claim 1, wherein at least one of:
the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF;
the NF performance measurements related to service requests via trusted non-3GPP access include performance measurements comprising at least one of a number of attempted service requests via trusted non-3GPP access or a number of successful service requests via trusted non-3GPP access;
the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access;
the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify;
the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS;
the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or
the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

3. The device of claim 2, wherein at least one of:
the NF performance measurements related to registration via trusted non-3GPP access are incremented based on:
a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or
a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request;
the NF performance measurements related to service requests via trusted non-3GPP access are incremented based on:
a cumulative counter (CC) triggered on receipt of a trigger message by a Trusted Non-3GPP Access Network Gateway Function (TNGF) of a message indicating a Service Request by an AMF; or
a cumulative counter (CC) triggered on transmission of a trigger message by a TNGF of a request containing a mobility management non-access stratum(MMS NAS) Service Accept;
the NF performance measurements related to Quality of Service (QoS) flow management are incremented based on:
a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or
a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message;
the NF performance measurements related to QoS flow modification in a Next Generation Radio Access Network (NG-RAN) are incremented based on:
a cumulative counter (CC) triggered on receipt of a trigger message by a gNB including a PDU SESSION RESOURCE MODIFY REQUEST message; or
a cumulative counter (CC) triggered on transmission of a trigger message by gNB including PDU SESSION RESOURCE MODIFY RESPONSE message;
the NF performance measurements related to handovers between 5GS and an evolved packet system (EPS) measured in NG-RAN are incremented based on:
a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or
a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message;
the NF performance measurements related to handovers from 5GS to EPS are incremented based on:
a cumulative counter (CC) triggered on receipt of a trigger message by an AMF including a Forward Relocation Response message; or
a cumulative counter (CC) triggered on transmission of a trigger message by an AMF including a Forward Relocation Request message, or a Forward Relocation Complete notification message;
the NF performance measurements related to handovers from EPS to 5GS are incremented based on:
a cumulative counter (CC) triggered on receipt of a trigger message by an AMF including a Forward Relocation Request message or a Forward Relocation Complete Notification message; or
a cumulative counter (CC) triggered on transmission of a trigger message by an AMF including Forward Relocation Response message.

4. The device of claim 3, wherein at least one of:
the NF performance measurements related to registration via trusted non-3GPP access are incremented based on a subcounter incremented per network slice identifier (S-NSSAI); or
the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

5. The device of claim 3, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

6. The device of claim 3, wherein the trigger message corresponding to the NF performance measurements related to registration via trusted non-3GPP access are to be communicated via a N2 interface.

7. The device of claim 3, wherein the handovers are to be via a N26 interface.

8. The device of claim 1, wherein the device corresponds to one of a gNB, a 5G CN network element or network function or a standalone management system distinct form a gNB or a CN.

9. The device of claim 8, further including a transceiver coupled to the one or more processors.

10. The device of claim 9, further including one or more antennas to transmit and receive messages from the one or more network element.

11. One or more non-transitory computer-readable media comprising instructions to cause a device to host a service producer corresponding to a network management function (MnF) of a management entity in a Third Generation Partnership Project (3GPP) 5G system (5GS), upon execution of the instructions by one or more processors of the apparatus, to perform operations including:
collecting data corresponding to network function (NF) performance measurements by one or more network element or network function, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and
generating and cause transmission through a management service interface of one or more reports on the NF performance measurements to a service consumer to be used by the service consumer to manage the 5GS.

12. The computer-readable media of claim 11, wherein at least one of:
the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF;
the NF performance measurements related to service requests via trusted non-3GPP access include performance measurements comprising at least one of a number of attempted service requests via trusted non-3GPP access or a number of successful service requests via trusted non-3GPP access;
the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access;
the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify;
the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS;
the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or
the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

13. The computer-readable media of claim 12, wherein at least one of:
the NF performance measurements related to registration via trusted non-3GPP access are incremented based on:
a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or
a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request;
the NF performance measurements related to service requests via trusted non-3GPP access are incremented based on:
a cumulative counter (CC) triggered on receipt of a trigger message by a Trusted Non-3GPP Access Network Gateway Function (TNGF) of a message indicating a Service Request by an AMF; or
a cumulative counter (CC) triggered on transmission of a trigger message by a TNGF of a request containing a mobility management non-access stratum(MMS NAS) Service Accept;
the NF performance measurements related to Quality of Service (QoS) flow management are incremented based on:
a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or
a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message;
the NF performance measurements related to QoS flow modification in a Next Generation Radio Access Network (NG-RAN) are incremented based on:
a cumulative counter (CC) triggered on receipt of a trigger message by a gNB including a PDU SESSION RESOURCE MODIFY REQUEST message; or
a cumulative counter (CC) triggered on transmission of a trigger message by gNB including PDU SESSION RESOURCE MODIFY RESPONSE message;
the NF performance measurements related to handovers between 5GS and an evolved packet system (EPS) measured in NG-RAN are incremented based on:
a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or
a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message;
the NF performance measurements related to handovers from 5GS to EPS are incremented based on:
a cumulative counter (CC) triggered on receipt of a trigger message by an AMF including a Forward Relocation Response message; or
a cumulative counter (CC) triggered on transmission of a trigger message by an AMF including a Forward Relocation Request message, or a Forward Relocation Complete notification message;
the NF performance measurements related to handovers from EPS to 5GS are incremented based on:
a cumulative counter (CC) triggered on receipt of a trigger message by an AMF including a Forward Relocation Request message or a Forward Relocation Complete Notification message; or
a cumulative counter (CC) triggered on transmission of a trigger message by an AMF including Forward Relocation Response message.

14. The computer-readable media of claim 13, wherein at least one of:
the NF performance measurements related to registration via trusted non-3GPP access are incremented based on a subcounter incremented per network slice identifier (S-NSSAI); or
the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

15. The computer-readable media of claim 13, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

16. The computer-readable media of claim 13, wherein the trigger message corresponding to the NF performance measurements related to registration via trusted non-3GPP access are to be communicated via a N2 interface.

17. The computer-readable media of claim 13, wherein the handovers are to be via a N26 interface.

18. The computer-readable media of claim 11, wherein the device corresponds to one of a gNB, a 5G CN network element or network function or a standalone management system distinct form a gNB or a CN.

19. The computer-readable media of claim 18, the operations further including transmitting and receiving messages from the one or more network element.

20. A method to be performed at an a device to host a service producer corresponding to a network management function (MnF) of a management entity in a Third Generation Partnership Project (3GPP) 5G system (5GS), upon execution of the instructions by one or more processors of the apparatus, to perform operations including:
collecting data corresponding to network function (NF) performance measurements by one or more network element or network function, each network element or network function including one of a NR Node B (gNB), a 5G core network (5G CN) function, or an apparatus hosting a non-3GPP access Interworking Function (a N3IWF-hosting apparatus), wherein the performance measurements are related to at least one of registration via trusted non-3GPP access, service requests via trusted non-3GPP access, Quality of Service (QoS) flow management, QoS flow modification in a Next Generation Radio Access Network (NG-RAN), handovers between 5GS and an evolved packet system (EPS) measured in NG-RAN, handovers from 5GS to EPS, or handovers from EPS to 5GS; and
generating and cause transmission through a management service interface of one or more reports on the NF performance measurements to a service consumer to be used by the service consumer to manage the 5GS.

21. The method of claim 20, wherein at least one of:
the NF performance measurements related to registration via trusted non-3GPP access include performance measurements comprising at least one of a number of initial registration requests via trusted non-3GPP access received by an access and mobility management function (AMF), a number of successful initial registrations via trusted non 3 GPP access at an AMF, a number of mobility registration update requests via trusted non-3GPP access received by an AMF, a number of successful mobility registration updates via trusted non-3GPP access at an AMF, a number of periodic registration update requests via trusted non-3GPP access received by an AMF, a number of successful mobility registration updates via trusted non-3GPP access at an AMF, a number of emergency registration requests via trusted non-3GPP access received by an AMF, or a number of successful emergency registrations via trusted non-3GPP access at an AMF;
the NF performance measurements related to service requests via trusted non-3GPP access include performance measurements comprising at least one of a number of attempted service requests via trusted non-3GPP access or a number of successful service requests via trusted non-3GPP access;
the NF performance measurements related to Quality of Service (QoS) flow management include performance measurements comprising at least one of a number of QoS flows attempted to set up via untrusted non-3GPP access, a number of QoS flow successfully set up via untrusted non-3GPP access, a number of QoS flows failed to set up via untrusted non-3GPP access, a number of QoS flows attempted to modify via untrusted non-3GPP access, a number of QoS flow successfully modified by untrusted non-3GPP access, or number of QoS flows failed to modify via untrusted non-3GPP access;
the NF performance measurements related to QoS flow modification in a Next Generation Radio Access Network (NG-RAN) include performance measurements comprising at least one of A number of QoS flows attempted to modify, a number of QoS flows successfully modified, or a number of QoS flows failed to modify;
the NF performance measurements related to handovers between 5GS and an evolved packet system (EPS) measured in NG-RAN include performance measurements comprising at least one of a number of preparations requested by a source gNB for outgoing handovers from 5GS to EPS, a number of successful preparations received by a source gNB for outgoing handovers from 5GS to EPS, a number of failed preparations received by a source gNB for outgoing handovers from 5GS to EPS, a number of resource allocation requests received by a target gNB for handovers from EPS to 5GS, a number of successful resource allocations at a target gN before handovers from EPS to 5GS, a number of failed resource allocations at a target gNB before handovers from EPS to 5GS, a number of executions requested by a source gNB for handovers from 5GS to EPS, a number of successful executions at a source gNB for handovers from 5GS to EPS, or a number of failed executions at a source gNB for handovers from 5GS to EPS;
the NF performance measurements related to handovers from 5GS to EPS include performance measurements comprising at least one of a number of attempted handovers from 5GS to EPS, a number of successful handovers from 5GS to EPS, or a number of failed handovers from 5 GS to EPS; or
the NF performance measurements related to handovers from EPS to 5GS include performance measurements comprising at least one of a number of attempted handovers from EPS to 5GS, a number of successful handovers from EPS to 5GS, or a number of failed handovers from EPS to 5GS.

22. The method of claim 21, wherein at least one of:
the NF performance measurements related to registration via trusted non-3GPP access are incremented based on:
a cumulative counter (CC) triggered on receipt of a trigger message by an AMF including a Registration Request with a registration type indicating an initial registration, a Registration Request with a registration type indicating a mobility registration update, a Registration Request with a registration type indicating a periodic registration update, or a registration request with a registration type indicating an emergency registration; or
a cumulative counter (CC) triggered on transmission of a trigger message by an AMF including a Registration Accept corresponding to an initial registration request, a Registration Accept corresponding to a mobility registration update request, a Registration Accept corresponding to a periodic registration update requests, or a Registration Accept corresponding to an emergency registration request;
the NF performance measurements related to service requests via trusted non-3GPP access are incremented based on:
a cumulative counter (CC) triggered on receipt of a trigger message by a Trusted Non-3GPP Access Network Gateway Function (TNGF) of a message indicating a Service Request by an AMF; or
a cumulative counter (CC) triggered on transmission of a trigger message by a TNGF of a request containing a mobility management non-access stratum(MMS NAS) Service Accept;
the NF performance measurements related to Quality of Service (QoS) flow management are incremented based on:
a cumulative counter (CC) triggered on receipt of a trigger message by a N3IWF including of a protocol data unit (PDU) SESSION RESOURCE SETUP REQUEST message, an INITIAL CONTEXT SETUP REQUEST message, or a PDU SESSION RESOURCE MODIFY REQUESTS message; or
a cumulative counter (CC) triggered on transmission of a trigger message by a N3IWF including a PDU SESSION RESOURCE SETUP RESPONSE message an INITIAL CONTEXT SETUP RESPONSE message, or a PDU SESSION RESOURCE MODIFY RESPONSE message;
the NF performance measurements related to QoS flow modification in a Next Generation Radio Access Network (NG-RAN) are incremented based on:
a cumulative counter (CC) triggered on receipt of a trigger message by a gNB including a PDU SESSION RESOURCE MODIFY REQUEST message; or
a cumulative counter (CC) triggered on transmission of a trigger message by gNB including PDU SESSION RESOURCE MODIFY RESPONSE message;
the NF performance measurements related to handovers between 5GS and an evolved packet system (EPS) measured in NG-RAN are incremented based on:
a cumulative counter (CC) triggered on receipt of a trigger message by a gNB centralized unit (gNB-CU) including a HANDOVER COMMAND message, a HANDOVER PREPARATION FAILURE message, a HANDOVER REQUEST message, or a UE CONTEXT RELEASE COMMAND message; or
a cumulative counter (CC) triggered on transmission of a trigger message by gNB-CU including a HANDOVER REQUEST ACKNOWLEDGE message, a HANDOVER FAILURE message, or a radio resource control (RRC) ConnectionReconfiguration message;
the NF performance measurements related to handovers from 5GS to EPS are incremented based on:
a cumulative counter (CC) triggered on receipt of a trigger message by an AMF including a Forward Relocation Response message; or
a cumulative counter (CC) triggered on transmission of a trigger message by an AMF including a Forward Relocation Request message, or a Forward Relocation Complete notification message;
the NF performance measurements related to handovers from EPS to 5GS are incremented based on:
a cumulative counter (CC) triggered on receipt of a trigger message by an AMF including a Forward Relocation Request message or a Forward Relocation Complete Notification message; or
a cumulative counter (CC) triggered on transmission of a trigger message by an AMF including Forward Relocation Response message.

23. The method of claim 22, wherein at least one of:
the NF performance measurements related to registration via trusted non-3GPP access are incremented based on a subcounter incremented per network slice identifier (S-NSSAI); or
the NF performance measurements comprising the number of QoS flows attempted to setup via untrusted non-3GPP access, the number of QoS flows attempted to modify via untrusted non-3GPP access, the number of QoS flows attempted to modify, and the number of QoS flows successfully modified are further incremented based on a subcounter incremented per QoS level (5QI) and S-NSSAI.

24. The method of claim 22, wherein the NF performance measurements comprising the number of QoS flows failed to setup via untrusted non-3GPP access, the number of QoS flows failed to modify, the number of failed preparations for handovers from 5GS to EPS and the number of failed resource allocations for handovers from EPS to 5GS are further incremented based on a subcounter incremented per cause.

25. The method of claim 22, wherein the trigger message corresponding to the NF performance measurements related to registration via trusted non-3GPP access are to be communicated via a N2 interface.
